(19) United States
(12) Patent Application Publication
(10) Pub. No.: US 2023/0421324 A1
(43) Pub. Date: Dec. 28, 2023

(54) COMBINED REFERENCE SIGNAL CONFIGURATION

(71) Applicant: QUALCOMM Incorporated, San Diego, CA (US)

(72) Inventors: Iyab Issam SAKHNINI, San Diego, CA (US); Tao LUO, San Diego, CA (US); Yan ZHOU, San Diego, CA (US)

(21) Appl. No.: 17/849,150

(22) Filed: Jun. 24, 2022

(51) Int. Cl. H04L 5/00; H04W 72/04

(52) U.S. Cl. CPC H04L 5/0051; H04W 72/042; H04L 1/18

(57) ABSTRACT

Aspects relate to configuration of a combined reference signal configuration including two or more reference signal configurations. Each reference signal configuration may be associated with one or more beam identifiers (IDs) is a respective communication direction. In some examples, the communication direction may be a downlink communication direction, an uplink communication direction, or a sidelink communication direction. Based on the combined reference signal configuration, reference signals associated with the two or more reference signal configurations may be communicated between devices (e.g., between a user equipment (UE) and a network entity or between two UEs). In addition, a UE may transmit a measurement report based on one or more report settings configured for the combined reference signal configuration.

### INTRODUCTION

The technology discussed below relates generally to wireless communication networks, and more particularly, to configuring reference signals for beam management in wireless communication networks.

In wireless communication systems, such as those specified under standards for 5G New Radio (NR), a base station and user equipment (UE) may utilize beamforming to compensate for high path loss and short range. Beamforming is a signal processing technique used with an antenna array for directional signal transmission and/or reception. Each antenna in the antenna array transmits a signal that is combined with other signals of other antennas of the same array in such a way that signals at particular angles experience constructive interference while others experience destructive interference.

The base station and the UE can select one or more beam pair links (BPLs) for communication therebetween on the downlink and/or the uplink Each BPL includes corresponding transmit and receive beams on the base station and UE. For example, on the uplink, a BPL includes a transmit beam on the UE and a receive beam on the base station. The base station and UE may select one or more beams forming BPLs for communication of uplink and downlink signals therebetween using a downlink beam management scheme and/or an uplink beam management scheme.

### BRIEF SUMMARY

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) configured for wireless communication is disclosed. The UE includes a memory, and a processor coupled to the memory. The processor is configured to receive a combined reference signal configuration including two or more reference signal configurations. Each reference signal configuration of the two or more reference signal configurations is associated with one or more beam identifiers (IDs) in a respective communication direction. The processor is further configured to communicate reference signals associated with the two or more reference signal configurations based on the combined reference signal configuration.

Another example provides A method for wireless communication at a user equipment (UE). The method includes receiving a combined reference signal configuration including two or more reference signal configurations. Each reference signal configuration of the two or more reference signal configurations is associated with one or more beam identifiers (IDs) in a respective communication direction. The method further includes communicating reference signals associated with the two or more reference signal configurations based on the combined reference signal configuration.

Another example provides a user equipment (UE) configured for wireless communication. The UE includes means for receiving a combined reference signal configuration including two or more reference signal configurations. Each reference signal configuration of the two or more reference signal configurations is associated with one or more beam identifiers (IDs) in a respective communication direction. The UE further includes means for communicating reference signals associated with the two or more reference signal configurations based on the combined reference signal configuration.

Another example provides a non-transitory computer-readable medium having stored therein instructions executable by one or more processors of a user equipment (UE) to receive a combined reference signal configuration including two or more reference signal configurations. Each reference signal configuration of the two or more reference signal configurations is associated with one or more beam identifiers (IDs) in a respective communication direction. The non-transitory computer-readable medium further includes instructions executable by the one or more processors of the UE to communicate reference signals associated with the two or more reference signal configurations based on the combined reference signal configuration.

Another example provides a network entity configured for wireless communication. The network entity includes a memory and a processor coupled to the processor. The processor is configured to provide a combined reference signal configuration including two or more reference signal configurations. Each reference signal configuration of the two or more reference signal configurations is associated with one or more beam identifiers (IDs) in a respective communication direction. The processor is further configured to communicate reference signals associated with the two or more reference signal configurations based on the combined reference signal configuration.

Another example provides a method for wireless communication at a network entity. The method includes providing a combined reference signal configuration including two or more reference signal configurations. Each reference signal configuration of the two or more reference signal configurations is associated with one or more beam identifiers (IDs) in a respective communication direction. The method further includes communicating reference signals associated with the two or more reference signal configurations based on the combined reference signal configuration.

Another example provides a network entity configured for wireless communication. The network entity includes means for providing a combined reference signal configuration including two or more reference signal configurations. Each reference signal configuration of the two or more reference signal configurations is associated with one or more beam identifiers (IDs) in a respective communication direction. The network entity further includes means for communicating reference signals associated with the two or more reference signal configurations based on the combined reference signal configuration.

Another example provides a non-transitory computer-readable medium having stored therein instructions executable by one or more processors of a network entity to provide a combined reference signal configuration including two or more reference signal configurations. Each reference signal configuration of the two or more reference signal configurations is associated with one or more beam identifiers (IDs) in a respective communication direction. The non-transitory computer-readable medium further includes instructions executable by the one or more processors of the network entity to communicate reference signals associated with the two or more reference signal configurations based on the combined reference signal configuration.

Another example provides a user equipment (UE) configured for wireless communication is disclosed. The UE includes a memory, and a processor coupled to the memory. The processor can be configured to receive at least one report setting associated with a combined reference signal configuration including two or more reference signal configurations. Each reference signal configuration of the two or more reference signal configurations is associated with one or more beam identifiers (IDs) in a respective communication direction. The processor is further configured to transmit a measurement report based on the at least one report setting, the measurement report comprising beam measurements, each of the beam measurements corresponding to one of a plurality of beams utilized for communication of reference signals based on the combined reference signal configuration.

Another example provides a method for wireless communication at a user equipment (UE). The method includes receiving at least one report setting associated with a combined reference signal configuration including two or more reference signal configurations. Each reference signal configuration of the two or more reference signal configurations is associated with one or more beam identifiers (IDs) in a respective communication direction. The method further includes transmitting a measurement report based on the at least one report setting, the measurement report comprising beam measurements, each of the beam measurements corresponding to one of a plurality of beams utilized for communication of reference signals based on the combined reference signal configuration.

Another example provides a user equipment (UE) configured for wireless communication. The UE includes means for receiving at least one report setting associated with a combined reference signal configuration including two or more reference signal configurations. Each reference signal configuration of the two or more reference signal configurations is associated with one or more beam identifiers (IDs) in a respective communication direction. The UE further includes means for transmitting a measurement report based on the at least one report setting, the measurement report comprising beam measurements, each of the beam measurements corresponding to one of a plurality of beams utilized for communication of reference signals based on the combined reference signal configuration.

Another example provides a non-transitory computer-readable medium having stored therein instructions executable by one or more processors of a user equipment (UE) to receive at least one report setting associated with a combined reference signal configuration including two or more reference signal configurations. Each reference signal configuration of the two or more reference signal configurations is associated with one or more beam identifiers (IDs) in a respective communication direction. The non-transitory computer-readable medium further includes instructions executable by the one or more processors of the UE to transmit a measurement report based on the at least one report setting, the measurement report comprising beam measurements, each of the beam measurements corresponding to one of a plurality of beams utilized for communication of reference signals based on the combined reference signal configuration.

These and other aspects will become more fully understood upon a review of the detailed description, which follows. Other aspects, features, and examples will become apparent to those of ordinary skill in the art, upon reviewing the following description of specific, exemplary aspects of in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects, such exemplary aspects can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a wireless communication network employing sidelink communication according to some aspects.

FIG. 3 is a diagram illustrating an example of a frame structure for use in a wireless communication network according to some aspects.

FIG. 4 is a block diagram illustrating a wireless communication system supporting beamforming and/or multiple-input multiple-output (MIMO) communication according to some aspects.

FIGS. 5A-5C are diagrams illustrating examples of downlink beam management procedures according to some aspects.

FIG. 6 is a diagram illustrating an example of a downlink reference signal configuration according to some aspects.

FIGS. 7A and 7B are diagrams illustrating examples of uplink beam management procedures according to some aspects.

FIGS. 8A, 8B, and 8C are diagrams illustrating exemplary uplink reference signal configurations according to some aspects.

FIG. 9 is a signaling diagram illustrating an example of beam refinement using a combined reference signal configuration according to some aspects.

FIG. 10 is a signaling diagram illustrating an example of sidelink beam refinement using a combined reference signal configuration according to some aspects.

FIG. 11 is a diagram illustrating an exemplary combined reference signal configuration according to some aspects.

FIGS. 12A and 12B are diagrams illustrating examples of beam refinement procedures in accordance with a combined reference signal configuration according to some aspects.

FIG. 13 is a diagram illustrating another example of beam refinement procedures in accordance with a combined reference signal configuration according to some aspects.

FIG. 14 is a diagram illustrating another example of beam refinement procedures in accordance with a combined reference signal configuration according to some aspects.

FIG. 15 is a diagram illustrating exemplary signaling for a combined reference signal configuration according to some aspects.

FIG. 16 is a signaling diagram illustrating an example of a beam management procedure using a combined reference signal configuration according to some aspects.

FIG. 17A illustrates an example of a combined reference signal configuration according to some aspects.

FIG. 17B illustrates an example of a combined reference signal configuration linked with a single report setting according to some aspects.

FIGS. 17C and 17D illustrate examples of measurements reports generated based on the combined reference signal configuration shown in FIG. 17A and the single report setting shown in FIG. 17B for the combined reference signal configuration according to some aspects.

FIG. 18 is a diagram illustrating another example of a measurement report generated based on the combined reference signal configuration shown in FIG. 17A and the single report setting shown in FIG. 17B for the combined reference signal configuration according to some aspects.

FIG. 19A illustrates an example of a combined reference signal configuration linked with multiple report settings according to some aspects.

FIG. 19B is a diagram illustrating another example of a measurement report generated based on the combined reference signal configuration and the multiple report settings shown in FIG. 19A for the combined reference signal configuration according to some aspects.

FIG. 20 is a diagram illustrating another example of a measurement report generated based on the combined reference signal configuration and the multiple report settings shown in FIG. 19A for the combined reference signal configuration according to some aspects.

FIGS. 21A and 21B are diagrams illustrating examples of measurement report timing for a combined reference signal configuration according to some aspects.

FIG. 22 is a block diagram illustrating an example of a hardware implementation for a UE employing a processing system according to some aspects.

FIG. 23 is a flow chart of an exemplary process for implementing a combined reference signal configuration at a UE according to some aspects.

FIG. 24 is a flow chart of another exemplary process for implementing a combined reference signal configuration at a UE according to some aspects.

FIG. 25 is a flow chart of another exemplary process for implementing a combined reference signal configuration at a UE according to some aspects.

FIG. 26 is a flow chart of another exemplary process for implementing a combined reference signal configuration at a UE according to some aspects.

FIG. 27 is a flow chart of an exemplary process for generating and transmitting a measurement report based on a combined reference signal configuration according to some aspects.

FIG. 28 is a block diagram illustrating an example of a hardware implementation for a network entity employing a processing system according to some aspects.

FIG. 29 is a flow chart of an exemplary process for implementing a combined reference signal configuration at a network entity according to some aspects.

FIG. 30 is a flow chart of another exemplary process for implementing a combined reference signal configuration at a network entity according to some aspects.

FIG. 31 is a flow chart of another exemplary process for implementing a combined reference signal configuration at a network entity according to some aspects.

FIG. 32 is a diagram providing a high-level illustration of one example of a configuration of a disaggregated base station according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and features are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, aspects and/or uses may come about via integrated chip devices and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described aspects may occur. Implementations may range in spectrum from chip-level or modular components to non-modular, non-chip-level implementations and further to aggregate, distributed, or OEM devices or systems incorporating one or more aspects of the described aspects. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, disaggregated arrangements (e.g., base station and/or UE), end-user devices, etc. of varying sizes, shapes and constitution.

Beam management schemes may be divided into uplink beam management schemes and downlink beam management schemes. In an example of a downlink beam management scheme, downlink beams (e.g., a downlink BPL) may be selected based on downlink beamformed reference signals, such as channel state information reference signals (CSI-RSs), transmitted from the base station to the UE. In an example of an uplink beam management scheme, uplink beams (e.g., an uplink BPL) may be selected based on beamformed uplink reference signals, such as sounding reference signals (SRSs). When the channel is reciprocal, the base station may further derive the downlink beams (e.g., a downlink BPL) to communicate with the UE based on the received SRSs.

Each of the uplink and downlink beam management schemes may be implemented using a reference signal configuration. The reference signal configuration is a configuration of one or more reference signal resources for communicating reference signals. Each reference signal resource may be indexed by a respective reference signal resource ID. The reference signal resource ID may identify both a beam and time—frequency resources on which the reference signal may be communicated. Examples of reference signals may include channel state information reference signals (CSI-RSs) and sounding reference signals (SRSs) on the uplink CSI-RSs are reference signals that are used in the downlink direction in 5G NR during mobility and downlink beam management and to measure the characteristics of a radio channel. For example, UEs may use CSI-RSs to measure the quality of the downlink radio channel and report the channel quality on the uplink SRSs are reference signals transmitted by the UE in the uplink direction for use by a network entity (e.g., a base station) during uplink beam management and to estimate the uplink channel quality.

In an example of a downlink beam management scheme, CSI-RS resources may be configured to enable a network entity to transmit CSI-RSs in a beam-sweeping manner for downlink transmit beam refinement at the network entity (e.g., selection of a beam used by the network entity for transmission of downlink signals to a UE). In an example of an uplink beam management scheme, SRS resources may be configured to enable a UE to transmit SRSs in a beam-sweeping manner for uplink transmit beam refinement at the UE (e.g., selection of a beam used by the UE for transmission of uplink signals from the UE to the network entity).

Moreover, additional reference signal configurations may further be developed to facilitate beam refinement at the network entity or UE. For example, a CSI-RS resource may be configured with repetition (e.g., repetition of the same beam over time) to enable the UE to sweep receive beams for downlink reception beam refinement at the UE (e.g., selection of a beam used by the UE for reception of signals from the network entity). In an example of CSI-RS repetition, a CSI-RS may be transmitted on the same downlink beam and within the same frequency resource, but on different time resources (e.g., within different symbols, slots, and/or subframes). As another example, an SRS resource may be configured with repetition to enable the network entity to sweep receive beams for uplink reception beam refinement at the network entity (e.g., selection of a beam used by the network entity for reception of signals from the UE). In an example of SRS repetition, an SRS may be transmitted on the same uplink beam and within the same frequency resource, but on different time resources (e.g., within different symbols, slots, and/or subframes).

One or more of the beam refinement procedures (e.g., network entity receive beam refinement, network entity transmit beam refinement, UE receive beam refinement, UE transmit beam refinement) may be needed at a certain time. In some examples, each beam refinement procedure utilizes a separate reference signal configuration and/or is triggered using separate signaling, which may increase the signaling overhead and extend the time over which the beam refinement procedures are conducted. In addition, each of the beam refinement procedures may involve different delays to apply or activate the beam refinement procedures. Furthermore, separate execution of beam refinement procedures may increase the UE power consumption.

Therefore, in various aspects of the disclosure, two or more of the reference signal configurations may be combined to enable two or more of the beam refinement procedures to be performed within the same time period. In some examples, more than one beam refinement procedure may need to be conducted at a certain time. Thus, a combined reference signal configuration including two or more reference signal configurations may be utilized to enable two or more beam refinement procedures to be performed within the same time period. By combining reference signal configurations for various beam refinement procedures into a combined reference signal configuration, the signaling overhead may be reduced. For example, signaling a single combined reference signal configuration results in reduced signaling as compared to separately signaling two or more individual reference signal configurations. In addition, the time period over which multiple beam refinement procedures are conducted may be reduced, which may further reduce UE power consumption. For example, the combined reference signal configuration may result in the performance of multiple beam refinement procedures substantially simultaneously instead of sequentially. The power consumption for simultaneous performance of multiple beam refinement procedures may be less than the power consumption for sequential performance of multiple beam refinement procedures.

In some examples, the combined reference signal configuration includes two or more reference signal configurations, each associated with one or more beam identifiers (IDs) in a respective communication direction (e.g., uplink or downlink) Here, a CSI-RS beam ID may be indexed by a CSI-RS resource indicator (CRI), whereas an SRS beam ID may be indexed by an SRS resource indicator (SRI). For example, the combined reference signal configuration may indicate two or more of a downlink repetition pattern of a downlink beam ID (e.g., associated with a CSI-RS resource), an uplink repetition pattern of an uplink beam ID (e.g., associated with an SRS resource), a plurality of downlink beam IDs (e.g., each associated with a respective CSI-RS resource) without repetition, or a plurality of uplink beam IDs (e.g., each associated with a respective SRS resource) without repetition. In addition, the combined reference signal configuration may be periodic, semi-persistent, or aperiodic. In some examples, a combined reference signal configuration may further be used in sidelink communication networks to enable multiple beam refinement procedures to be performed at a transmitting sidelink device (e.g., a transmitting UE) and a receiving sidelink device (e.g., a receiving UE) within the same time period.

In some examples, the combined reference signal configuration may include common parameters linked between the two or more reference signal configurations. For example, a common bandwidth may be shared across the reference signal configurations. As another example, a common spatial relation filter may be shared across reference signal configurations in different communication directions (e.g., downlink and uplink or different sidelink directions) or a common quasi-co-location (QCL) relation may be shared across reference signal configurations in the same communication direction (e.g., downlink, uplink, or sidelink).

In examples in which the combined reference signal configuration includes reference signal configurations of the same communication direction and each with repetition, the order of repetitions between the reference signal configurations may be configured. For example, the order of repetitions may indicate that a first reference signal configuration associated with a first beam occurs prior to a second reference signal configuration associated with a second beam such that the combination of the first and second reference signal configurations effectively produces a third reference signal configuration without repetition (e.g., a third reference signal configuration associated with both the first beam and the second beam). As another example, the order of repetitions may indicate that the first reference signal configuration and the second reference signal configuration are interleaved in time.

In examples in which the combined reference signal configuration includes reference signal configurations of the same communication direction with different repetition settings (e.g., a first reference signal configuration with repetition and a second reference signal configuration without repetition) or reference signal configurations of different communication directions (e.g., uplink and downlink or different sidelink directions), the combined reference signal configuration may indicate a time gap between the first and second reference signal configurations.

In examples in which the combined reference signal configuration is aperiodic, the combined reference signal configuration may be triggered using control information. In this example, there may be a timing delay between the control information and the first reference signal resource associated with the combined reference signal configuration.

In some examples, the combined reference signal configuration may be associated with at least one report setting to facilitate transmission of a measurement report from the UE based on the combined reference signal configuration. The measurement report may include, for example, beam measurements corresponding to the UE-received reference signals indicated in the combined reference signal configuration. In some examples, the combined reference signal configuration may be associated with more than one report setting and the beam measurements may be divided in the measurement report according to the corresponding report setting. In addition, a report setting indicator for each of the beam measurements may be included in the measurement report. In some examples, the measurement report may include an average beam measurement or a maximum beam measurement for a set of reference signal resources associated with a same beam. In some examples, the reference signals received based on the combined reference signal configuration are grouped based on, for example, a network entity or a QCL source associated with each of the reference signals. In this example, the beam measurements may include a maximum beam measurement and differential values for remaining beam measurement for each group of reference signals. In some examples, the measurement report may be transmitted at a time based on the communication direction (e.g., uplink or downlink or a sidelink direction) of the last communicated reference signal.

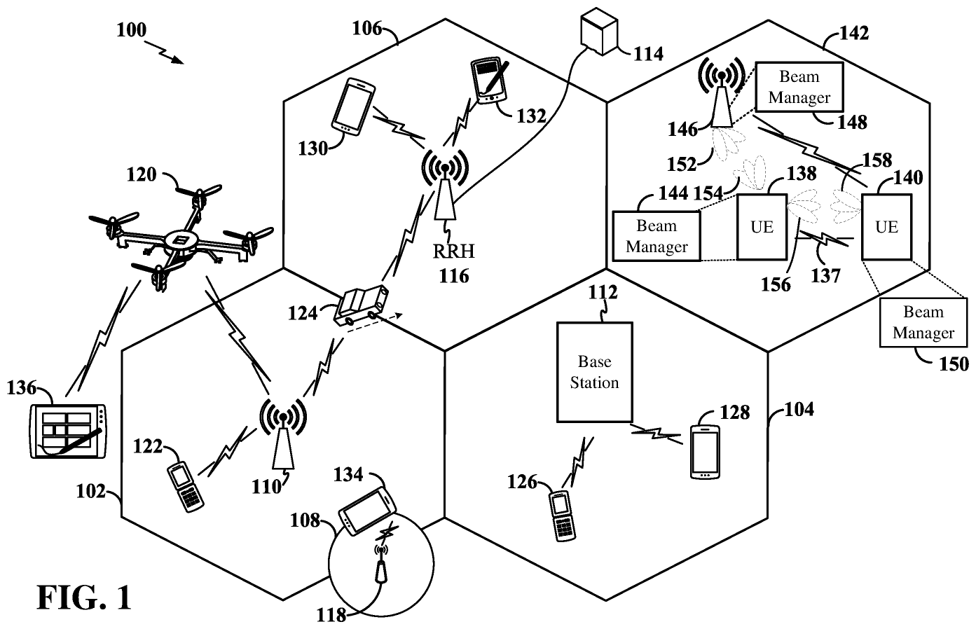

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, cell 108, and cell 142, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, base stations 110, 112, and 146 are shown in cells 102, 104, and 142; and another base station 114 is shown controlling a remote radio head (RRH) 116 in cell 106. That is, a base station can have an integrated antenna or can be connected to an antenna or RRH by feeder cables. In the illustrated example, the cells 102, 104, 106, and 142 may be referred to as macrocells, as the base stations 110, 112, 114, and 146 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118, and 146 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 via RRH 116; UEs 138 and 140 may be in communication with base station 146; and UE 136 may be in communication with mobile base station 120. Here, each base station 110, 112, 114, 118, 120, and 146 may be configured to provide an access point to a core network (not shown) for all the UEs in the respective cells. In another example, a mobile network node (e.g., UAV 120) may be configured to function as a UE. For example, the UAV 120 may operate within cell 102 by communicating with base station 110.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or data (e.g., user data traffic or other type of traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a base station 112) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 126), which may be scheduled entities, may utilize resources allocated by the scheduling entity 112.

Base stations are not the only entities that may function as scheduling entities. That is, in some examples, a UE may function as a scheduling entity, scheduling resources for one or more scheduled entities (e.g., one or more other UEs). For example, two or more UEs (e.g., UEs 138 and 140) may communicate with each other using peer to peer (P2P) or sidelink signals 137 without relaying that communication through a base station (e.g., base station 146). In some examples, the UEs 138 and 140 may each function as a scheduling entity or transmitting sidelink device and/or a scheduled entity or a receiving sidelink device to communicate sidelink signals 137 therebetween without relying on scheduling or control information from a base station (e.g., base station 146). In other examples, the base station 146 may allocate resources to the UEs 138 and 140 for sidelink communication. For example, the UEs 138 and 140 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the base station 112 via D2D links (e.g., sidelink 137). For example, one or more UEs (e.g., UE 138) within the coverage area of the base station 146 may operate as a relaying UE to extend the coverage of the base station 146, improve the transmission reliability to one or more UEs (e.g., UE 140), and/or to allow the base station to recover from a failed UE link due to, for example, blockage or fading.

In some examples, beamformed signals may be utilized between the UE 138 and the base station 146 communicating, for example, over a mmWave carrier, such as FR2, FR4-a, FR4-1, FR4, or FR5. To facilitate beamformed communication, the base station 146 and UE 138 may select one or more beam pair links (BPL) between the UE 138 and the base station 146 using one or more beam refinement procedures. Each BPL may include a network-side beam 152 at the base station 146 and a UE-side beam 154 at the UE. To facilitate a particular beam refinement procedure, the base station 146 and/or UE 138 may communicate reference signals (e.g., CSI-RS or SRS) therebetween based on a reference signal configuration indicating the reference signal resources associated with the beam refinement procedure. In some examples, the base station 146 may select the BPLs based on a measurement report transmitted from the UE 138 to the base station 146. In addition, the UEs 138 and 140 may further communicate over the sidelink 137 using beamformed signals. In this example, the UEs 138 and 140 may also select one or more BPLs for sidelink communication based on one or more sidelink beam refinement procedures. For example, a sidelink BPL may be formed of one of UE sidelink beams 156 at UE 138 and one of UE sidelink beams 158 at UE 140.

In some examples, more than one beam refinement procedure may need to be conducted at a certain time. Therefore, in various aspects of the disclosure, a combined reference signal configuration including two or more reference signal configurations may be utilized to enable two or more beam refinement procedures to be performed within the same time period. Each of the reference signal configurations may be associated with one or more beam identifiers (IDs) in a respective communication direction to enable a beam refinement procedure. For example, the combined reference signal configuration may include a first reference signal configuration including beam IDs of a plurality of network-side beams 152 for network-side transmit (Tx) beam refinement and a second reference signal configuration including beam IDs of a plurality of UE-side beams 154 for network-side receive (Rx) beam refinement. As another example, the combined reference signal configuration may include a third reference signal configuration including a first beam ID of a first network-side beam 152 with repetition for UE-side receive (Rx) beam refinement to form a BPL with the first network-side beam 152 and a fourth reference signal configuration including a second beam ID of a second network-side beam 152 with repetition for UE-side Rx beam refinement to form a BPL with the second network-side beam 152. As yet another example, the combined reference signal configuration may include a fifth reference signal configuration including beam IDs of a plurality of network-side beams 152 for network-side Tx beam refinement and a sixth reference signal configuration including a third beam ID of a third network-side beam 152 with repetition for UE-side Rx beam refinement.

To facilitate the combined reference signal configuration, the base station 146 and each of the UEs 138 and 140 may each include a respective beam manager 144, 148, and 150. With respect to cellular communication between the base station 146 and the UE 138, the beam manager 148 of the base station 146 may be configured to generate or output and transmit or provide the combined reference signal configuration to the UE 138. In addition, each of the beam managers 144 and 148 may be configured to enable communication of reference signals (e.g., CSI-RS or SRS) between the base station 146 and the UE 138 in accordance with the combined reference signal configuration to enable selection of BPLs. With respect to sidelink communication between the UEs 138 and 140, each beam manager 144 and 150 may be configured to generate, output, provide, transmit, receive, obtain, and/or utilize the combined reference signal configuration to enable communication of sidelink reference signals for selection of the BPLs on the sidelink 137. In addition, the beam managers 144 and 150 may further be configured to utilize one or more report settings (e.g., configured by the beam manager 148 or by one of the UE beam managers 144 or 150 for sidelink communication) associated with the combined reference signal configuration to generate a measurement report based on the combined reference signal configuration.

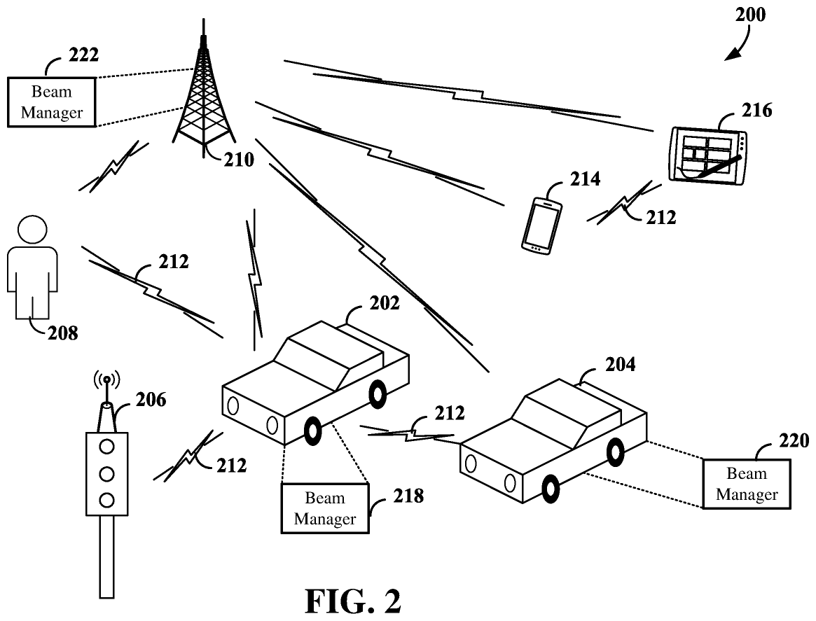

FIG. 2 illustrates an example of a wireless communication network 200 configured to support sidelink communication. In some examples, sidelink communication may include V2X communication. V2X communication involves the wireless exchange of information directly between not only vehicles (e.g., vehicles 202 and 204) themselves, but also directly between vehicles 202/204 and infrastructure (e.g., roadside units (RSUs) 206), such as streetlights, buildings, traffic cameras, tollbooths or other stationary objects, vehicles 202/204 and pedestrians 208, and vehicles 202/204 and wireless communication networks (e.g., base station 210). In some examples, V2X communication may be implemented in accordance with the New Radio (NR) cellular V2X standard defined by 3GPP, Release 16, or other suitable standard.

V2X communication enables vehicles 202 and 204 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 202 and 204 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 208 may be utilized to trigger a warning sound, vibration, flashing light, etc., in case of imminent danger.

The sidelink communication between vehicle-UEs (V-UEs) 202 and 204 or between a V-UE 202 or 204 and either an RSU 206 or a pedestrian-UE (P-UE) 208 may occur over a sidelink 212 utilizing a proximity service (ProSe) PC5 interface. In various aspects of the disclosure, the PC5 interface may further be utilized to support D2D sidelink 212 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 214 and 216.

ProSe communication may support different operational scenarios, such as in-coverage, out-of-coverage, and partial coverage. Out-of-coverage refers to a scenario in which UEs (e.g., V-UEs 202 and 204 and P-UE 208) are outside of the coverage area of a base station (e.g., base station 210), but each are still configured for ProSe communication. Partial coverage refers to a scenario in which some of the UEs (e.g., V-UE 204) are outside of the coverage area of the base station 210, while other UEs (e.g., V-UE 202 and P-UE 208) are in communication with the base station 210. In-coverage refers to a scenario in which UEs (e.g., UEs 214 and 216) are in communication with the base station 210 (e.g., gNB) via a Uu (e.g., cellular interface) connection to receive ProSe service authorization and provisioning information to support ProSe operations.

To facilitate D2D sidelink communication between, for example, UEs 214 and 216 over the sidelink 212, the UEs 214 and 216 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 212. For example, the discovery signal may be utilized by the UE 216 to measure the signal strength and channel status of a potential sidelink (e.g., sidelink 212) with another UE (e.g., UE 214). The UE 216 may utilize the measurement results to select a UE (e.g., UE 214) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a base station (e.g., base station 210).

In addition, there may be two main resource allocation modes of operation for sidelink (e.g., PC5) communications. In a first mode, Mode 1, a base station (e.g., gNB) 210 may allocate resources to sidelink devices (e.g., V2X devices or other sidelink devices) for sidelink communication between the sidelink devices in various manners. For example, the base station 210 may allocate sidelink resources dynamically (e.g., a dynamic grant) to sidelink devices, in response to requests for sidelink resources from the sidelink devices. For example, the base station 210 may schedule the sidelink communication via DCI 2_0. In some examples, the base station 210 may schedule the PSCCH/PSSCH within uplink resources indicated in DCI 2_0. The base station 210 may further activate preconfigured sidelink grants (e.g., configured grants) for sidelink communication among the sidelink devices. In some examples, the base station 210 may activate a configured grant (CG) via RRC signaling. In Mode 1, sidelink feedback may be reported back to the base station 210 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, beamformed signals may be utilized between UEs (e.g., UE 202 and 204). To facilitate beamformed communication, the UEs 202 and 204 may select one or more beam pair links (BPL) therebetween using one or more sidelink beam refinement procedures. To facilitate a particular beam refinement procedure (e.g., UE 202 transmit beam, UE 202 receive beam, UE 204 transmit beam, or UE 204 receive beam), the UEs 202 and 204 may communicate sidelink reference signals (e.g., sidelink CSI-RSs or sidelink SRSs) therebetween based on a reference signal configuration indicating the reference signal resources associated with the beam refinement procedure.

In some examples, more than one beam refinement procedure may need to be conducted at a certain time. Therefore, in various aspects of the disclosure, a combined reference signal configuration including two or more reference signal configurations may be utilized to enable two or more beam refinement procedures to be performed within the same time period. To facilitate the combined reference signal configuration, the UEs 202 and 204 may each include a respective beam manager 218 and 220. Each beam manager 218 and 220 may be configured to generate, output, transmit, provide, receive, obtain and/or utilize the combined reference signal configuration to enable communication of sidelink reference signals for selection of the BPLs on the sidelink 212. In addition, the base station 210 may further include a beam manager 222 to configure and utilize a combined reference signal configuration for beam refinement procedures on the Uu link between the base station 210 and a UE (e.g., UE 202).

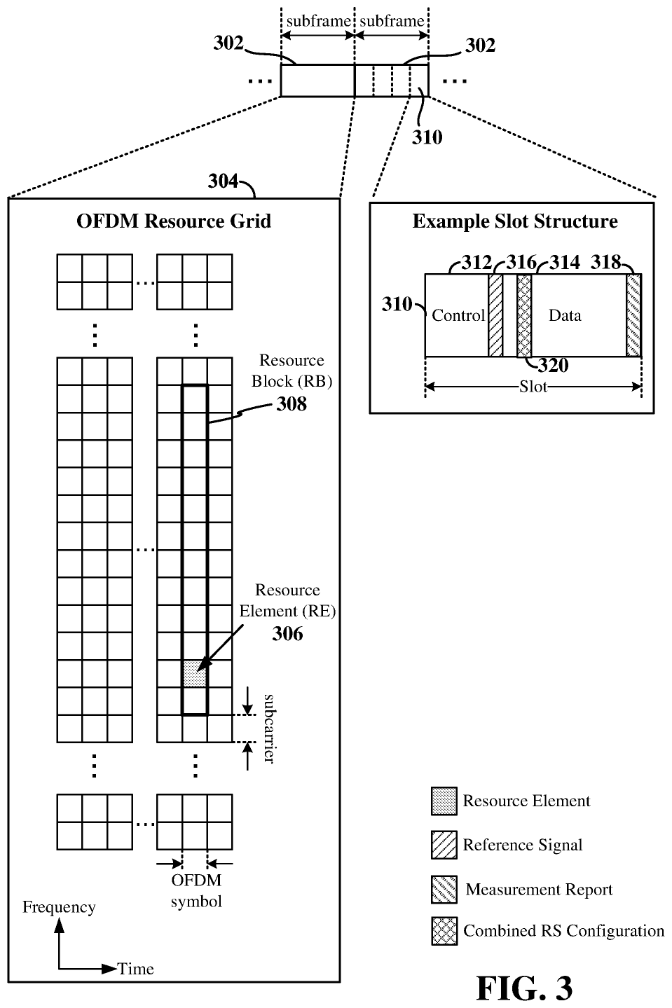

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time—frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time—frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 13 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D3D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 13 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). For example, a reference signal 316, which may be an SSB or CSI-RS, is shown carried within slot 310. SSBs may be broadcast at regular intervals based on a periodicity (e.g., 5, 10, 30, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. For example, the reference signal 316 shown in slot 310 may also correspond to an uplink reference signal, such as an SRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI. For example, slot 310 is shown carrying a measurement report 318.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB3 and above.

In an example of sidelink communication over a sidelink carrier via a PC5 interface, the control region 312 of the slot 310 may include a physical sidelink control channel (PSCCH) including sidelink control information (SCI) transmitted by an initiating (transmitting) sidelink device (e.g., Tx V3X device or other Tx UE) towards a set of one or more other receiving sidelink devices (e.g., Rx V3X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, sidelink MAC-CEs may be transmitted in the data region 314 of the slot 310. In addition, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310. For example, the reference signal 316 carried within slot 310 may be a sidelink CSI-RS or sidelink SRS.

To facilitate communication of reference signals 316 to perform two or more beam refinements within the same time period, a combined reference signal configuration 320 may further be transmitted within slot 310. The combined reference signal configuration 320 may include two or more reference signal configurations, each associated with a particular beam refinement procedure. In particular, each reference signal configuration may be associated with one or more beam identifiers (IDs) in a respective communication direction to enable a beam refinement procedure.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

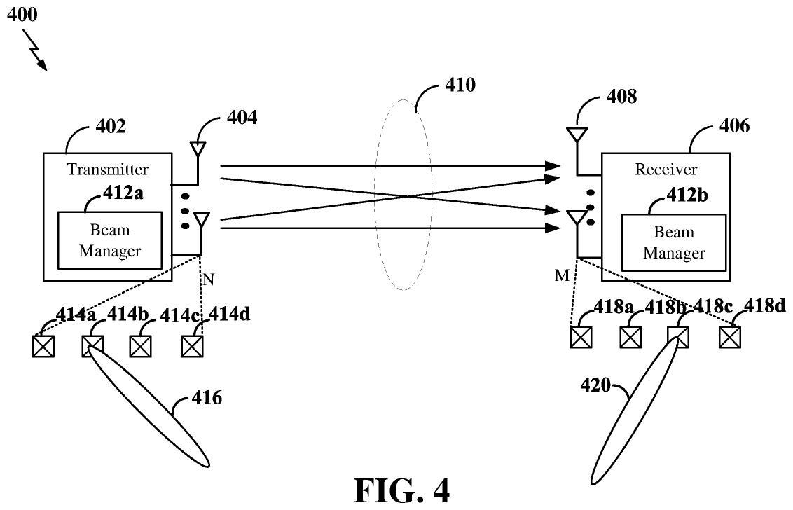

In some aspects of the disclosure, the scheduling entity and/or scheduled entity may be configured for beamforming and/or multiple-input multiple-output (MIMO) technology. FIG. 4 illustrates an example of a wireless communication system 400 supporting beamforming and/or MIMO. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. Each of the transmitter 402 and the receiver 406 may be implemented, for example, within a scheduling entity (e.g., a base station), a scheduled entity (e.g., a UE), or any other suitable device. In some examples, the transmitter and receiver are each wireless communication devices (e.g., UEs or V2X devices) communicating over a sidelink channel.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 400 is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In one example, as shown in FIG. 4, a rank-2 spatial multiplexing transmission on a 2×2 MIMO antenna configuration will transmit one data stream from each transmit antenna 404. Each data stream reaches each receive antenna 408 along a different signal path 410. The receiver 406 may then reconstruct the data streams using the received signals from each receive antenna 408.

Beamforming is a signal processing technique that may be used at the transmitter 402 or receiver 406 to shape or steer an antenna beam (e.g., a transmit beam or receive beam) along a spatial path between the transmitter 402 and the receiver 406. Beamforming may be achieved by combining the signals communicated via antennas 404 or 408 (e.g., antenna elements of an antenna array module) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406.

In 5G New Radio (NR) systems, particularly for FR2 or higher (millimeter wave) systems, beamformed signals may be utilized for most downlink channels, including the physical downlink control channel (PDCCH) and physical downlink shared channel (PDSCH). In addition, broadcast control information, such as the synchronization signal block (SSB), slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink channels, including the physical uplink control channel (PUCCH) and physical uplink shared channel (PUSCH). In addition, beamformed signals may further be utilized in D2D systems, such as NR SL or V2X, utilizing FR2 or other higher mmWave frequency band.

The transmit and receive antennas 404 and 408 may each correspond to respective transmit and receive antenna ports (e.g., antenna 404 may correspond to one of antenna port 414a, 414b, 414c, or 414c and antenna 408 may correspond to one of antenna ports 418a, 418b, 418c, or 418d). Here, the term antenna port at the transmitter 402 refers to a logical port over which a signal (e.g., a data stream or layer) may be transmitted via, for example, a transmit beam 416. In addition, the term antenna port at the receiver 406 refer to a logical port over which the signal may be received via, for example, a receive beam 420. In an example, each of the transmitter 402 and receiver 406 may include one or more antenna arrays (or antenna panels), each including a plurality of antenna elements. The antenna elements of an antenna panel may be mapped to antenna ports on the antenna panel by antenna element combiners.

In various aspects of the disclosure, each of the transmitter 402 and receiver 406 may include a respective beam manager 412a and 412b configured to facilitate two or more beam refinement procedures within the same time period using a combined reference signal configuration. The combined reference signal configuration may include two or more reference signal configurations, each associated with one or more beam identifiers (IDs) in a respective communication direction to enable a beam refinement procedure. In addition, the beam managers 412a and 412b may further be configured to configure and/or utilize one or more report settings associated with the combined reference signal configuration to generate a measurement report based on the combined reference signal configuration. In some examples, the combined reference signal configuration may be a sidelink combined reference signal configuration. In some examples, the combined reference signal configuration may include two or more reference signal configurations for downlink beam refinement, two or more reference signal configurations for uplink beam refinement, or a combination of reference signal configurations for uplink and downlink beam refinement.

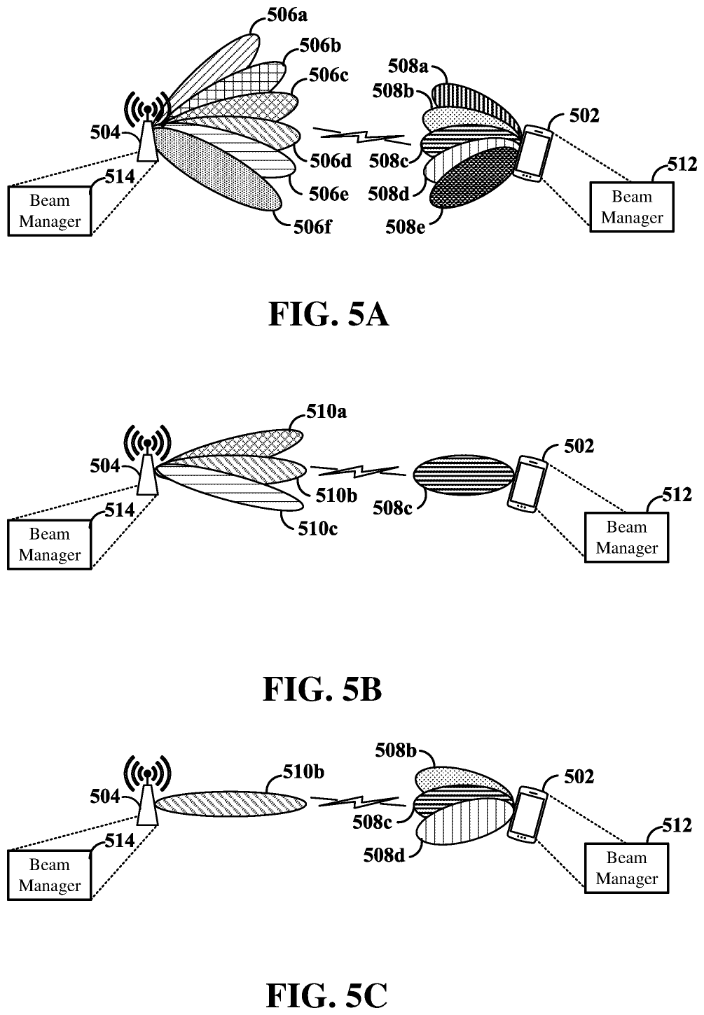

FIGS. 5A-5C are diagrams illustrating examples of downlink beam management procedures, including downlink beam refinement procedures, between a network entity 504 and a UE 502 according to some aspects. The network entity 504 may be any of the base stations (e.g., gNBs) or scheduling entities illustrated in FIGS. 1 and/or 3, and the UE 502 may be any of the UEs or scheduled entities illustrated in FIGS. 1 and/or 3. In some examples, the network entity 504 may be implemented as an aggregated base station or a disaggregated base station. In a disaggregated base station architecture, the network entity 504 may include one or more of a central unit (CU), a distributed unit (DU), or a radio unit (RU).

The network entity 504 may generally have the capability to communicate with the UE 502 using one or more transmit beams, and the UE 502 may further have the capability to communicate with the network entity 504 using one or more receive beams. As used herein, the term transmit beam refers to a beam on the network entity 504 that may be utilized for downlink or uplink communication with the UE 502. In addition, the term receive beam refers to a beam on the UE 502 that may be utilized for downlink or uplink communication with the network entity 504.

In the example shown in FIG. 5A, the network entity 504 is configured to generate a plurality of transmit beams 506a-506f, each associated with a different spatial direction. Each of the transmit beams 506a-506f may be referenced by a respective beam ID (e.g., an SSB resource indicator (SRI)). In addition, the UE 502 is configured to generate a plurality of receive beams 508a-508e, each associated with a different spatial direction. Each of the receive beams 508a-508e may further be referenced by a respective beam ID (e.g., via a QCL relation to an SSB resource indicator (SRI), CSI-RS resource indicator (CRI), or SRS resource indicator (SRI)). In some examples, the transmit beams 506a-506h on the network entity 504 and the receive beams 508a-508e on the UE 502 may be spatially directional mmWave beams, such as FR2, 1-R4-a, FR4-1, FR4, or FR5 beams. It should be noted that while some beams are illustrated as adjacent to one another, such an arrangement may be different in different aspects. For example, transmit beams 506a-506f transmitted during a same symbol may not be adjacent to one another. In some examples, the network entity 504 and UE 502 may each transmit more or less beams distributed in all directions (e.g., 360 degrees) and in three-dimensions. In addition, the transmit beams 506a-506f may include beams of varying beam width. For example, the network entity 504 may transmit certain signals (e.g., SSBs) on wider beams and other signals (e.g., CSI-RSs) on narrower beams.

The network entity 504 and UE 502 may select one or more transmit beams 506a-506f on the network entity 504 and one or more receive beams 508a-508e on the UE 502 for communication of uplink and downlink signals therebetween using a beam management procedure. In one example, as shown in FIG. 5A, during initial cell acquisition, the UE 502 may perform a P1 beam management procedure to scan the plurality of transmit beams 506a-506f transmitted in a wide range beam sweep on the plurality of receive beams 508a-508e to select a beam pair link (e.g., one of the transmit beams 506a-506f and one of the receive beams 508a-508e) for a physical random access channel (PRACH) procedure for initial access to the cell. For example, periodic SSB beam sweeping may be implemented on the network entity 504 at certain intervals (e.g., based on the SSB periodicity). Thus, the network entity 504 may be configured to sweep or transmit an SSB on each of a plurality of wider transmit beams 506a-506f. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam. The selected transmit beam and receive beam form a beam pair link (BPL) for the PRACH procedure. Here, the selected transmit beam may be associated with a particular RACH occasion that may be utilized by the UE 502 to transmit a PRACH preamble. In this way, the network entity 504 is informed of the selected transmit beam.

After completing the PRACH procedure, as shown in FIG. 5B, the network entity 504 and UE 502 may perform a P2 beam management procedure for beam refinement. For example, the network entity 504 may be configured to sweep or transmit a CSI-RS on each of a plurality of narrower transmit beams 510a-510c in a narrow range beam sweep for beam refinement. For example, each of the CSI-RS beams may have a narrower beam width than the SSB beams, and thus the transmit beams 510a-510c transmitted during the P2 procedure may each be a sub-beam of an SSB transmit beam selected during the P1 procedure (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control—control element (MAC-CE) signaling by the gNB), or aperiodically (e.g., as triggered by the gNB via downlink control information (DCI)). The UE 502 is configured to scan the plurality of CSI-RS transmit beams 510a-510c on one or more of the plurality of receive beams. In the example shown in FIG. 5B, the UE 502 scans the CSI-RS transmit beams 510a-510c on a single receive beam 508c selected during the P1 procedure. The UE 502 then performs beam measurements (e.g., RSRP, SINR, etc.) of the transmit beams 510a-510c on the receive beam 508c to determine the respective beam quality of each of the transmit beams 510a-510c.

The UE 502 can then generate and transmit a Layer 1 (L1) measurement report (e.g., L1-RSRP or L1-SINR report), including the respective beam ID (e.g., CSI-RS resource indicator (CRI)) and beam measurement (e.g., RSRP) of one or more of the CSI-RS transmit beams 510a-510c to the network entity 504. The network entity 504 may then select one or more CSI-RS transmit beams on which to communicate with the UE 502. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 502 may further refine the receive beam for each selected serving CSI-RS transmit beam to form a respective refined BPL for each selected serving CSI-RS transmit beam. For example, as shown in FIG. 5C, the UE 502 may perform a P3 beam management procedure to refine the UE-beam of a BPL. In an example, the network entity 504 may repeat transmission of a selected transmit beam 510b selected during the P2 procedure to the UE 502. The UE 502 can scan the transmit beam 510b using different receive beams 508b-508d to obtain new beam measurements for the selected CSI-RS transmit beam 510b and select the best receive beam to refine the BPL for transmit beam 510b. In some examples, the selected receive beam to pair with a particular CSI-RS transmit beam 510b may be the receive beam on which the highest RSRP for the particular CSI-RS transmit beam is measured.

In some examples, in addition to configuring the UE 502 to perform P2 beam refinement (e.g., CSI-RS beam measurements), the network entity 504 may configure the UE 502 to perform a P1 beam management procedure (e.g., SSB beam measurements) outside of a RACH procedure and to provide an L1 measurement report containing beam measurements of one or more SSB transmit beams 506a-506f as measured on one or more of the receive beams 508a-508e. In this example, the L1 measurement report may include multiple RSRPs for each transmit beam, with each RSRP corresponding to a particular receive beam to facilitate selection of BPL(s). For example, the network entity 504 may configure the UE 502 to perform SSB beam measurements and/or CSI-RS beam measurements for various purposes, such as beam failure detection (BRD), beam failure recovery (BFR), cell reselection, beam tracking (e.g., for a mobile UE 502 and/or network entity 504), or other beam optimization purpose.

In one example, a single CSI-RS transmit beam (e.g., beam 510b) on the network entity 504 and a single receive beam (e.g., beam 508c) on the UE may form a single BPL used for communication between the network entity 504 and the UE 502. In another example, multiple CSI-RS transmit beams (e.g., beams 510a, 510b, and 510c) on the network entity 504 and a single receive beam (e.g., beam 508c) on the UE 502 may form respective BPLs used for communication between the network entity 504 and the UE 502. In another example, multiple CSI-RS transmit beams (e.g., beams 510a, 510b, and 510c) on the network entity 504 and multiple receive beams (e.g., beams 508c and 508d) on the UE 502 may form multiple BPLs used for communication between the network entity 504 and the UE 502. In this example, a first BPL may include transmit beam 510b and receive beam 508c, a second BPL may include transmit beam 510a and receive beam 508c, and a third BPL may include transmit beam 510c and receive beam 508d.

In various aspects of the disclosure, the UE 502 and network entity 504 may each include a respective beam manager 512 and 514, configured to facilitate more than one beam refinement procedure in the same time period. For example, the beam manager 514 may be configured to generate a combined reference signal configuration including two or more reference signal configurations and to transmit the combined reference signal configuration to the UE 502. In some examples, the combined reference signal configuration may include a respective reference signal configuration for two or more P2 beam refinement procedures, two or more P3 beam refinement procedures, or a combination of P2 and P3 beam refinement procedures. Thus, each reference signal configuration may be associated with beam IDs of one or more network entity transmit beams 510a-510c. The beam IDs are indicated, for example, via the reference signal resources (e.g., CSI-RS resources) included in the reference signal configurations, as discussed in more detail below.

For example, a combined reference signal configuration may include a first reference signal configuration including the beam IDs of transmit beams 510a-510c for a P2 procedure and a second reference signal configuration including the beam ID of transmit beam 510b for a P3 procedure. As another example, the combined reference signal configuration may include a third reference signal configuration including the beam ID of transmit beam 510b for a P3 procedure and a fourth reference signal configuration including the beam ID of transmit beam 510c for another P3 procedure. The beam managers 512 and 514 may then utilize the combined reference signal configuration to communicate reference signals therebetween to conduct multiple beam refinement procedures at the same time.

For each combined reference signal configuration, the beam manager 514 may further configure one or more report settings indicating the format of a corresponding measurement report (e.g., an L1 measurement report) that may be generated by the beam manager 512 based on the combined reference signal configuration. For example, the beam manager 514 may generate and configure more than one report setting (e.g., one for each of the reference signal configurations) and the beam manager 512 may then divide the beam measurements into the different report settings and include a report setting indicator for each of the beam measurements in the beam report. As another example, the one or more report settings may indicate that the beam manager 512 should include a respective beam measurement (absolute value) for each of the reference signal resources included in the combined reference signal configuration, an average or maximum beam measurement for a set of the reference signal resources associated with a same beam, or an absolute value and respective differential values for each of the beam measurements associated with a group of reference signals.

In addition to L1 measurement reports, the UE 502 can further utilize the beam reference signals to estimate the channel quality of the channel between the network entity 504 and the UE 502. For example, the UE 502 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The scheduling entity may use the CSI report to select a rank for the scheduled entity, along with a precoding matrix and a MCS to use for future downlink transmissions to the scheduled entity. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

To distinguish between the different types of reports (including CSI reports and L1 measurement reports) and different types of measurements, the network entity 504 may configure the UE 502 with one or more report settings. Each report setting may be associated with a reference signal configuration indicating a configuration of one or more reference signals (e.g., CSI-RSs) for use in generating the CSI report. In some examples, a report setting may be associated with a combined reference signal configuration.

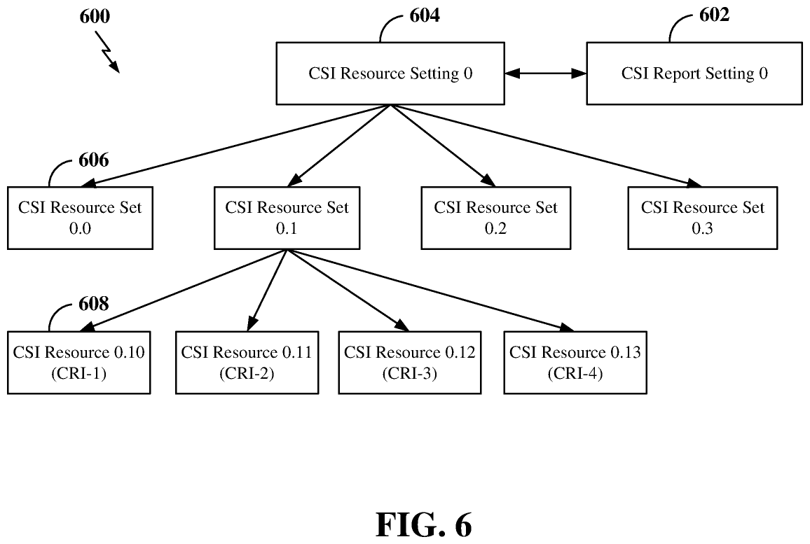

FIG. 6 illustrates an exemplary downlink reference signal configuration 600 to support different report/measurement configurations according to some aspects. The downlink reference signal configuration 600 shown in FIG. 6 may correspond to a single individual reference signal configuration that may be combined with one or more other reference signal configurations to produce a combined reference signal configuration. The downlink reference signal configuration 600 includes a CSI resource setting 604, one or more CSI resource sets 606 per CSI resource setting 604, and one or more CSI resources 608 per CSI resource set 606. Thus, each CSI resource setting 604 includes one or more CSI resource sets 606, and each CSI resource set 606 includes one or more CSI resources 608. In the example shown in FIG. 6, a single CSI resource setting (e.g., CSI resource setting 0) is illustrated. However, it should be understood that any suitable number of CSI resource settings 604 may be supported.

Each CSI resource setting 604 corresponding to a reference signal configuration may be associated with a CSI report setting 602 (e.g., CSI report setting 0 is associated with CSI resource setting 0). The CSI report setting 602 may include a reportQuantity that indicates, for example, the specific CSI values and granularity thereof (e.g., wideband/sub-band CQI, PMI, RI, LI, etc.), or L1 parameters (e.g., L1-RSRP, L1-SINR) to include in a CSI report. The CSI report setting 602 may further indicate a periodicity of the CSI report. For example, the CSI report setting 602 may indicate that the report should be generated periodically, aperiodically, or semi-persistently. For aperiodic CSI report settings 602, the CSI report may be sent on the PUSCH and may or may not be multiplexed with uplink data. For periodic CSI report settings 602, the CSI report may be sent on the PUCCH (e.g., a short PUCCH or a long PUCCH). For semi-persistent CSI report settings 602, the CSI report may be sent on the PUCCH or the PUSCH. For example, semi-persistent CSI reports sent on the PUCCH may be activated or deactivated using a medium access control (MAC) control element (MAC-CE). Semi-persistent CSI reports sent on the PUSCH may be triggered using downlink control information (DCI) scrambled with a semi-persistent CSI (SP-CP) radio network temporary identifier (SP-CP-RNTI). The DCI triggering the semi-persistent CSI reporting may further allocate semi-persistent resources and an MCS for the CSI report. Semi-persistent CSI report settings 602 may further support Type II codebooks and a minimum periodicity of 5 ms. In some examples, periodic and semi-persistent CSI report settings 602 may support the following periodicities: {5, 10, 20, 40, 80, 160, and 320} slots. CSI report settings 602 may further include a respective priority and other suitable parameters.

As indicated above, each CSI report setting 602 may be linked to a corresponding CSI resource setting 604 indicating the CSI resources 608 applicable to the CSI report setting 602. Each CSI resource setting 604 may be associated with a particular time domain behavior of reference signals. For example, each CSI resource setting 604 may include periodic, semi-persistent, or aperiodic CSI resources 608. For periodic and semi-persistent CSI resource settings 604, the number of configured CSI resource sets 606 may be limited to one. In general, the CSI resource settings 604 that may be linked to a particular CSI report setting 602 may be limited by the time domain behavior of the CSI resource setting 604 and the CSI report setting 602. For example, an aperiodic CSI report setting 602 may be linked to periodic, semi-persistent, or aperiodic CSI resource settings 604. However, a semi-persistent CSI report setting 602 may be linked to only periodic or semi-persistent CSI resource settings 604. In addition, a periodic CSI report setting 602 may be linked to only a periodic CSI resource setting 604.

Each CSI resource set 606 may be associated with a CSI resource type. For example, CSI resource types may include non-zero-power (NZP) CSI-RS resources, SSB resources, or channel state information interference measurement (CSI-IM) resources. Thus, each CSI resource set 606 includes a list of CSI resources 608 of a particular CSI resource type. In addition, each CSI resource set 606 may further be associated with one or more of a set of frequency resources (e.g., a bandwidth and/or OFDM symbol(s) within a slot), a particular set of ports, a power, or other suitable parameters. In addition, for NZP CSI-RS resources, the CSI resource set 606 may be configured with a repetition parameter indicating whether or not repetition is enabled for the CSI-RS resource (e.g., the repetition parameter may be set to ON or OFF).

For L1-RSRP measurement reports, a CSI resource setting may be configured with up to 16 CSI resource sets with up to 64 CSI resources within each set and the maximum total number of CSI resources being 128. For L1-SINR measurement reports, a CSI resource setting may be configured with up to 64 CSI-RS resources or up to 64 SSB resources.

Each CSI resource 608 indicates the particular beam, ports, frequency resource, and OFDM symbol on which the reference signal may be measured by the wireless communication device. For example, each CSI resource 608 may indicate an RE on which a CSI-RS pilot or SSB transmitted from a particular set of ports on a particular beam may be measured. In the example shown in FIG. 6, CSI resource set 0.1 includes four CSI resources (CSI resource 0.10, CSI resource 0.11, CSI resource 0.12, and CSI resource Each CSI resource 608 may further be indexed by a respective reference signal resource ID. The reference signal resource ID may identify not only the particular beam and ports, but also the resources on which the reference signal may be measured. For example, the reference signal resource ID may include a CSI-RS resource indicator (CRI) or a SSB resource indicator (SSBRI). In the example shown in FIG. 6, each CSI resource 608 is indexed by a respective CRI (e.g., CRI-1, CRI-2, CRI-3, and CRI-4). As each CRI identifies a respective beam, each CRI corresponds to a beam identifier (ID).

The network entity may configure the UE with one or more CSI report settings 602 and CSI resource settings 604 via, for example, radio resource control (RRC) signaling. For example, the network entity may configure the UE with a list of periodic CSI report settings, each linked to an associated CSI resource setting indicating the CSI resource set(s) that the UE may utilize to generate periodic CSI reports. As another example, the network entity may configure the UE with a list of aperiodic CSI report settings in a CSI-AperiodicTriggerStateList. Each trigger state (e.g., codepoint) in the CSI-AperiodicTriggerStateList may include a list of aperiodic CSI report settings indicating the associated CSI resource sets for channel (and optionally interference) measurement. As another example, the network entity may configure the UE with a list of semi-persistent CSI report settings in a CSI-SemiPersistentOnPUSCH-TriggerStateList. Each trigger state in the CSI-SemiPersistentOnPUSCH-TriggerStateList may include one CSI report setting indicating the associated CSI resource set. The network entity may then trigger one or more of the aperiodic or semi-persistent trigger states (e.g., codepoints) for a CSI report sent on the PUSCH using, for example, DCI. As indicated above, a MAC-CE may be used to activate or deactivate a semi-persistent CSI report setting for a CSI report sent on the PUCCH.

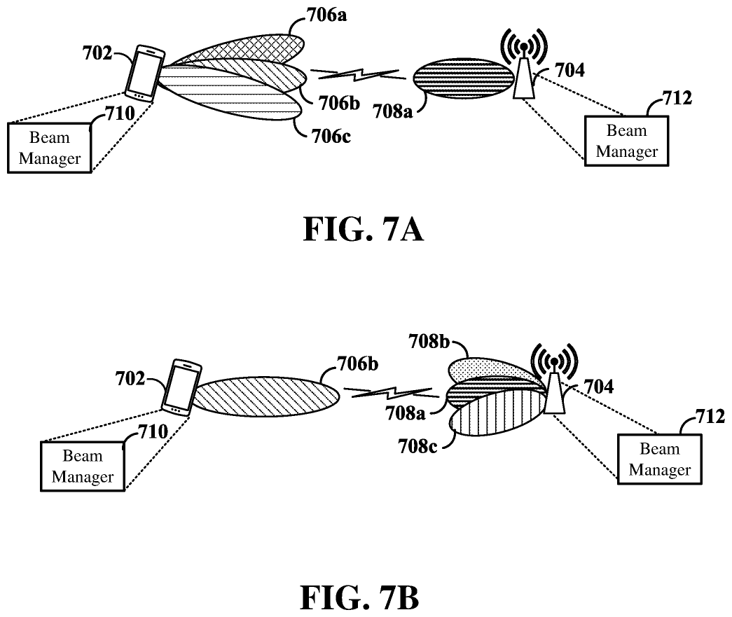

In various aspects, a combined reference signal configuration may further include one or more uplink reference signal configurations to enable one or more uplink beam refinement procedures. FIGS. 7A and 7B are diagrams illustrating examples of uplink beam management procedures for uplink beam refinement between a network entity 704 and a UE 702 according to some aspects. The UE 702 may correspond, for example, to any of the UEs or other scheduled entities shown in FIGS. 1, 2, 5, and/or 6. The network entity 704 may correspond, for example, to any of the base stations (e.g., gNBs) or other scheduling entities shown in any of FIGS. 1, 3, 5, and/or 6. The network entity 704 may be implemented as an aggregated base station or a disaggregated base station. In a disaggregated base station architecture, the network entity 704 may include one or more of a central unit (CU), a distributed unit (DU), or a radio unit (RU).

In an example of an uplink beam management scheme, as shown in FIG. 7A, the UE 702 may be configured to sweep or transmit on each of a plurality of uplink transmit beams 706a-706c. For example, the UE 702 may transmit an SRS on each beam in the different beam directions. In addition, the network entity 704 may be configured to receive the uplink beam reference signals on an uplink receive beam 708a. The network entity 704 then performs beam measurements (e.g., RSRP, SINR, RSRQ, etc.) on the beam reference signals on each of the uplink transmit beams 706a-706c to determine the respective beam quality of each of the uplink transmit beams 706a-706c.

The uplink beam management procedure shown in FIG. 7A may be performed, for example, to assist the UE 702 with uplink beam refinement. For example, the network entity 704 may then select one or more uplink transmit beams (e.g., uplink transmit beam 706b) on which the UE 702 may transmit uplink control information and/or user data traffic to the network entity 704. In some examples, the selected uplink transmit beam(s) have the highest gain. The network entity 704 may then notify the UE 702 of the selected uplink transmit beams. For example, the network entity 704 may provide the SRS resource identifier (SRI) identifying the SRS transmitted on the selected uplink transmit beam 706b. In some examples, the network entity 704 may apply the selected uplink transmit beam 706b (and corresponding uplink receive beam 708a) to an uplink signal (e.g., PUCCH, PUSCH, etc.) and transmit the respective SRI associated with the selected uplink transmit beam 706b applied to each uplink signal to the UE 702.

In the uplink beam management procedure shown in FIG. 7B, the UE 702 may repeat transmission of a selected uplink transmit beam 706b to the network entity 704. The uplink transmit beam 706b may be selected, for example, during a P3 procedure (as shown in FIG. 5C above) or during the uplink beam management procedure shown in FIG. 7A. The network entity 704 can scan the uplink transmit beam 706b using different uplink receive beams 708a-708c to obtain beam measurements for the uplink transmit beam 706b and select the best uplink receive beam (e.g., uplink receive beam 708a) to refine the BPL for uplink transmit beam 706b. In some examples, the selected uplink receive beam to pair with a particular uplink transmit beam 706b may be the uplink receive beam on which the highest RSRP for the particular uplink transmit beam 706b is measured. Thus, the network entity 704 may form a respective uplink beam pair link (BPL) for the uplink transmit beam 706b. When the channel is reciprocal, the above-described uplink beam management schemes may also be used to select one or more downlink BPLs for downlink communication from the network entity 704 to the UE 702. For example, the uplink BPLs may also be utilized as downlink BPLs.

In some aspects, the UE 702 and network entity 704 may each include a respective beam manager 710 and 712, configured to facilitate more than one beam refinement procedure in the same time period. For example, the beam manager 712 may be configured to generate a combined reference signal configuration including two or more reference signal configurations and to transmit the combined reference signal configuration to the UE 702. In some examples, the combined reference signal configuration may include a respective reference signal configuration for two or more uplink beam refinement procedures. Thus, each reference signal configuration may be associated with beam IDs of one or more UE transmit beams 7060a-706c. The beam IDs are indicated, for example, via the reference signal resources (e.g., SRS resources) included in the reference signal configurations, as discussed in more detail below.

For example, a combined reference signal configuration may include a first reference signal configuration including the beam IDs of UE transmit beams 706a-706c for UE uplink transmit beam refinement and a second reference signal configuration including the beam ID of transmit beam 706b for network entity uplink receive beam refinement. The beam managers 710 and 712 may then utilize the combined reference signal configuration to communicate reference signals therebetween to conduct multiple beam refinement procedures at the same time.

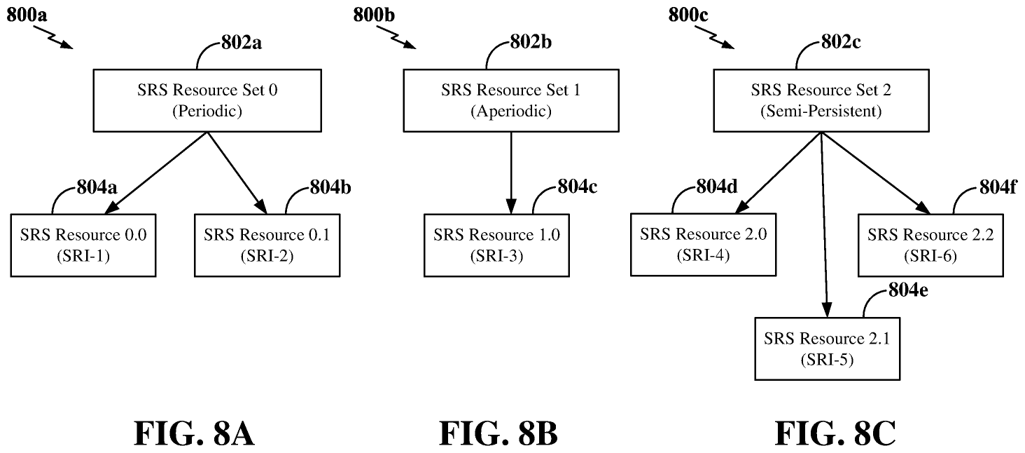

FIGS. 8A, 8B, and 8C are diagrams illustrating exemplary uplink reference signal configurations according to some aspects. The uplink reference signal configurations shown in each of FIGS. 8A-8C may correspond to a single individual reference signal configuration that may be combined with one or more other reference signal configurations to produce a combined reference signal configuration. FIGS. 8A-8C illustrate exemplary SRS configurations 800a-800c for SRS resource sets 802a-802c, each including SRS resources 804a-804f according to some aspects. An SRS resource set may include one or more SRS resources. For example, SRS resource set 802a (SRS Resource Set 0) includes SRS resources 804a and 804b (SRS Resource 0.0 and SRS Resource 0.1), SRS resource set 802b (SRS Resource Set 1) includes SRS resource 804c (SRS Resource 1.0), and SRS resource set 802c (SRS Resource Set 2) includes SRS resource sets 804d, 804e, and 804f (SRS Resource 2.0, SRS Resource 2.1, and SRS Resource 2.2).

As indicated in FIGS. 8A-8C, multiple SRS resource sets 802a-802c may be configured for a UE. In addition, each SRS resource set 802a-802c may be configured to be periodic, aperiodic, or semi-persistent, such that each of the SRS resources within the corresponding SRS resource set are periodic, aperiodic, or semi-persistent, respectively. For example, the SRS resources 804a and 804b within SRS resource set 802a may be periodic SRS resources, the SRS resource 804c within SRS resource set 802b may be aperiodic SRS resources, and the SRS resources 804d-804f within SRS resource set 802c may be semi-persistent SRS resources.

Each SRS resource 804a-804f includes a set of SRS resource parameters configuring the SRS resource. For example, the SRS resource parameters may include a set of port(s), a number of consecutive symbols (Nsymb), time domain allocation (Ioffset), repetition, transmission comb structure (kTC), bandwidth (mSRS), and other suitable parameters. Each SRS may further be quasi co-located (QCL'ed) with another reference signal, such as an SSB, CSI-RS, or another SRS. Thus, based on the QCL association (e.g., with an SSB beam, CSI-RS beam, or SRS beam), the SRS resource may be transmitted with the same spatial domain filter (e.g., beam) utilized for reception/transmission of the indicated reference signal (e.g., SSB beam, CSI-RS beam, or SRS beam). Each SRS resource 804a-804f may further be indexed by a respective reference signal resource (ID). The reference signal resource ID may identify not only the particular beam and ports, but also the resources on which the reference signal may be measured. For example, the reference signal resource ID may include an SRS resource indicator (SRI). In the example shown in FIGS. 8A-8C, each SRS resource 804a-804f is indexed by a respective SRI (e.g., SRI-1, SRI-2, SRI-3, SRI-4, SRI-5, and SRI-6). As each SRI identifies a respective beam, each SRI corresponds to a beam identifier (ID).

The respective sets of SRS resource parameters for each of the SRS resources in a particular SRS resource set collectively form the SRS resource set parameters for the SRS resource set. In addition, the SRS resource set itself may further include additional SRS resource set parameters. For example, the SRS resource set parameters for the aperiodic SRS resource set 802b may further include an aperiodic trigger state (e.g., codepoint) for the aperiodic SRS resource set 802b (e.g., up to three trigger states may be possible, each mapping to an aperiodic SRS resource set), a slot offset between the slot including the DCI triggering the aperiodic SRS resource and transmission of the SRS (e.g., SRS is transmitted k slot(s) after the slot carrying the DCI containing the trigger state), and a CRI associated with the aperiodic SRS resource set 802b for precoder estimation of the aperiodic SRSs. As another example, the SRS configuration for a periodic SRS resource set 802a or semi-persistent SRS resource set 802c may indicate the periodicity of the SRS resources (e.g., the periodicity of transmission of SRSs). The respective SRS resource set parameters then collectively form the SRS configuration 800a-800c of the corresponding SRS resource set 802a-802c.

A network entity may semi-statically configure a UE with one or more SRS resource sets 802a-802c via, for example, radio resource control (RRC) signaling. In some examples, the network entity may transmit an RRC message including an RRC configuration (e.g., RRC configuration information element (IE)) indicating the SRS configuration of a particular SRS resource set.

For example, the network entity may semi-statically configure the UE with one or more periodic SRS resource sets 802a that the UE may utilize to generate and transmit periodic SRSs to the network entity. As another example, the network entity may semi-statically configure the UE with one or more aperiodic SRS resource sets 802b and corresponding trigger states. The network entity may then trigger an aperiodic SRS resource set 802b using DCI. As another example, the network entity may semi-statically configure the UE with one or more semi-persistent SRS resource sets 802c. The network entity may then activate or deactivate a semi-persistent SRS resource set 802c using a medium access control (MAC) control element (MAC-CE).

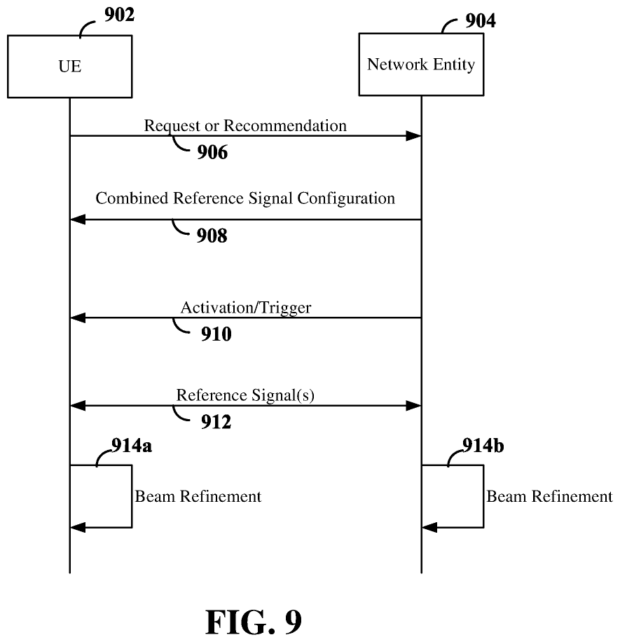

FIG. 9 is a signaling diagram illustrating an example of beam refinement using a combined reference signal configuration between a UE 902 and a network entity 904 according to some aspects. The UE 902 may correspond to any of the UEs or scheduled entities shown in FIGS. 1, 3, 5, 7A and/or 7B. In addition, the network entity 904 may correspond, for example, to any of the base stations (e.g., gNBs) or other scheduling entities shown in any of FIGS. 1, 3, 5, 7A and/or 7B. The network entity 904 may be implemented as an aggregated base station or a disaggregated base station. In a disaggregated base station architecture, the network entity 1004 may include one or more of a central unit (CU), a distributed unit (DU), or a radio unit (RU).

At 906, the UE 902 may optionally transmit a request for a combined reference signal configuration to the network entity 904. For example, the UE 902 may transmit a UE capabilities message to the network entity 904 that indicates that the UE supports the combined reference signal configuration. As another example, the UE 902 may transmit an explicit request for the combined reference signal configuration.

At 908, the network entity 904 may transmit a combined reference signal configuration including two or more reference signal configurations to the UE 902. In some examples, the two or more reference signal configurations may include uplink reference signal configurations, downlink reference signal configurations, or a combination of uplink and downlink reference signal configurations. In some examples, each of the two or more reference signal configurations may indicate one or more beam IDs with or without repetition. For example, a first reference signal configuration may indicate a first repetition pattern of a first beam ID in a first communication direction (e.g., downlink or uplink), while a second reference signal configuration may indicate a second repetition pattern of a second beam ID in the first communication direction or a second communication direction different than the first communication direction. As another example, a third reference signal configuration may indicate a first plurality of beam IDs without repetition in the first communication direction, while a fourth reference signal configuration may indicate a second plurality of beam IDs without repetition in the first communication direction or the second communication direction. The combined reference signal configuration may include, for example, two or more of the first, second, third, and fourth reference signal configurations.

In some examples, the combined reference signal configuration may be a periodic configuration, a semi-persistent configuration, or an aperiodic configuration. In some examples, the network entity 904 may transmit an RRC message including an RRC configuration (e.g., RRC configuration information element (IE)) indicating the combined reference signal configuration.

In some examples, the combined reference signal configuration may include one or more common parameters linked between the two or more reference signal configurations. The common parameters may include, for example, a bandwidth, QCL relationship, or spatial relation filter. For example, the two or more reference signal configurations may include the same bandwidth and/or spatial relation filter for a downlink CSI-RS resource and an uplink SRS resource. As another example, the two or more reference signal configurations may include the same bandwidth and/or QCL relationship for downlink CSI-RS resources within different reference signal configurations of the combined reference signal configuration.

At 910, the network entity 904 may optionally transmit an activation/trigger for the combined reference signal configuration. For example, the network entity 904 may transmit control information (e.g., DCI) triggering an aperiodic combined reference signal configuration or a MAC-CE activating a semi-persistent combined reference signal configuration.

At 912, the UE 902 and the network entity 904 may communicate reference signals associated with the two or more reference signal configurations based on the combined reference signal configuration. For example, the UE 902 and network entity 904 may communicate one or more CSI-RSs and/or one or more SRSs in accordance with the combined reference signal configuration. Here, each CSI-RS is communicated on a CSI-RS resource (e.g., beam, frequency resource, and OFDM symbol) and each SRS is communicated on an SRS resource (e.g., beam, frequency resource, and OFDM symbol).

At 914a and 914b, one or more of the UE 902 and network entity 904 may perform a beam refinement procedure based on the communicated reference signals. For example, the network entity 904 may perform a P2 beam refinement procedure or uplink receive beam refinement procedure. As another example, the UE 902 may perform a P3 beam refinement procedure or an uplink transmit beam refinement procedure.

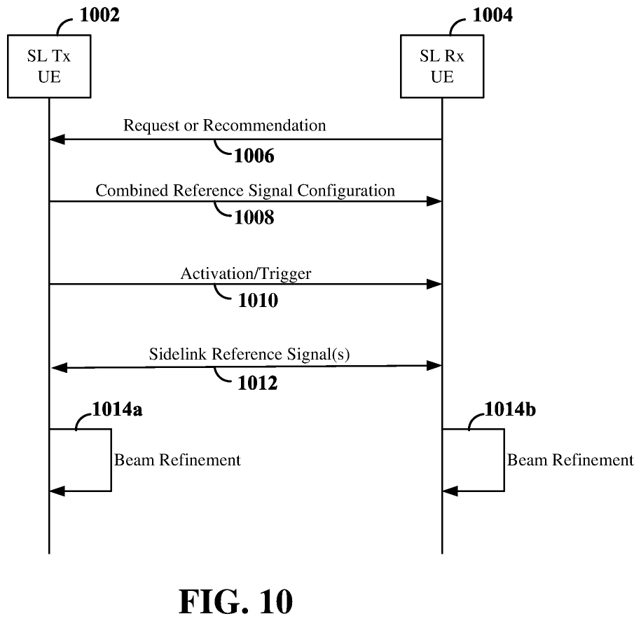

FIG. 10 is a signaling diagram illustrating an example of beam refinement using a combined reference signal configuration between sidelink devices (e.g., UE 1002 and UE 1004) according to some aspects. The UEs 1002 and 1004 may correspond to any of the UEs or scheduled entities shown in FIGS. 1, 3, 5, 7A and/or 7B. In the example shown in FIG. 10, UE 1002 may be a transmitting sidelink wireless communication device (SL Tx UE) 1002 and UE 1004 may be a receiving wireless communication device (SL Rx UE) 1004. In the example shown in FIG. 10, the SL Tx UE 1002 and SL Rx UE 1004 may be configured for sidelink communication utilizing, for example, Mode 1 or Mode 2.

At 1006, the SL Rx UE 1004 may optionally transmit a request for a combined reference signal configuration to the SL Tx UE 1004. At 1008, the SL Tx UE 1002 may transmit a combined reference signal configuration including two or more reference signal configurations for sidelink beam refinement. In some examples, the SL Tx UE 1002 may generate the combined reference signal configuration. In other examples, a network entity may generate the combined reference signal configuration and transmit the combined reference signal configuration to the SL Tx UE 1002. In still other examples, the network entity may transmit the combined reference signal configuration to both the SL Tx UE 1002 and the SL Rx UE 1004.

In some examples, the two or more reference signal configurations may include sidelink reference signal configurations in a single communication direction or in a combination of communication directions (e.g., from the SL Tx UE 1002 to the SL Rx UE 1004 and/or from the SL Rx UE 1004 to the SL Tx UE 1002). In some examples, each of the two or more reference signal configurations may indicate one or more beam IDs with or without repetition. For example, a first reference signal configuration may indicate a first repetition pattern of a first beam ID in a first communication direction, while a second reference signal configuration may indicate a second repetition pattern of a second beam ID in the first communication direction or a second communication direction different than the first communication direction. As another example, a third reference signal configuration may indicate a first plurality of beam IDs without repetition in the first communication direction, while a fourth reference signal configuration may indicate a second plurality of beam IDs without repetition in the first communication direction or the second communication direction. The combined reference signal configuration may include, for example, two or more of the first, second, third, and fourth reference signal configurations.

In some examples, the combined reference signal configuration may be a periodic configuration, a semi-persistent configuration, or an aperiodic configuration. In some examples, the SL Tx UE 1002 (or the network entity) may transmit an RRC message including an RRC configuration (e.g., RRC configuration information element (IE)) indicating the combined reference signal configuration. In some examples, the combined reference signal configuration may include one or more common parameters linked between the two or more reference signal configurations.

At 1010, the SL Tx UE 1002 may optionally transmit an activation/trigger for the combined reference signal configuration. For example, the SL Tx UE 1002 may transmit control information (e.g., SCI) triggering an aperiodic combined reference signal configuration or a sidelink MAC-CE activating a semi-persistent combined reference signal configuration.

At 1012, the SL Tx UE 1002 and SL Rx UE 1004 may communicate a plurality of sidelink reference signals (e.g., sidelink CSI-RSs and/or SL SRSs) on a plurality of sidelink beams. For example, each of the sidelink CSI-RSs may be configured by a CSI-RS resource indicating a respective time—frequency resource of the corresponding CSI-RS and a spatial direction of the corresponding sidelink transmit beam. Each sidelink CSI-RS resource may be identified, for example, by a CSI-RS resource indicator (CRI).

At 1014a and 1014b, one or more of the SL Tx UE 1002 and SL Rx UE 1004 may perform a beam refinement procedure based on the communicated sidelink reference signals. For example, the SL Tx UE 1002 may perform a transmit beam refinement procedure or receive beam refinement procedure. As another example, the SL Rx UE 1004 may perform a transmit beam refinement procedure or a receive beam refinement procedure.

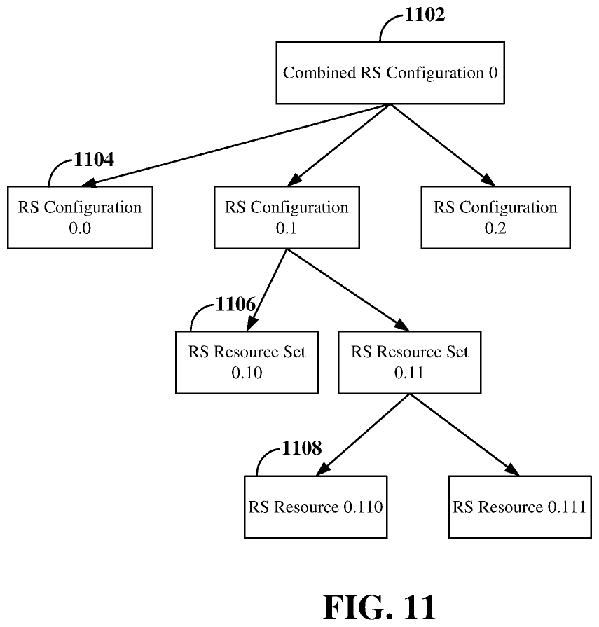

FIG. 11 illustrates an exemplary combined reference signal configuration 1102 (e.g., Combined RS Configuration 0) according to some aspects. The combined reference signal configuration 1102 includes two or more reference signal configurations 1104 (RS Configuration 0.0, RS Configuration 0.1, RS Configuration 0.2). Each reference signal configuration 1104 may correspond to a downlink reference signal configuration (e.g., a CSI resource setting) or an uplink reference signal configuration (e.g., an SRS configuration), or in examples in which the combined reference signal configuration is configured for sidelink communication, two or more sidelink reference signal configurations.

Each reference signal configuration 1104 (e.g., RS Configuration 0.1) includes one or more reference signal resource sets 1106 (e.g., RS Resource Set 0.10, RS Resource Set 0.11). In addition, each reference signal resource set 1106 includes one or more reference signal resources 1108 (e.g., RS Resource 0.110 and RS Resource 0.111). In the example shown in FIG. 11, a single combined reference signal configuration 1102 is illustrated. However, it should be understood that any suitable number of combined reference signal configurations 1102 may be supported. Each combined reference signal configuration may be associated with a particular time domain behavior of reference signals. For example, each combined reference signal configuration 1102 may include periodic, semi-persistent, or aperiodic reference signal resources 1108.

Each reference signal resource 1108 indicates the particular beam, frequency resource, and OFDM symbol on which the reference signal may be measured. Each reference signal resource 1108 may further be indexed by a respective reference signal resource identifier (ID). The reference signal resource ID may identify not only the particular beam, but also the resources on which the reference signal may be measured. For example, the reference signal resource ID may include a CSI-RS resource indicator (CRI), a SRI, a sidelink CRI, or sidelink SRI.

The network entity (or sidelink Tx UE) may configure the UE (or sidelink Rx UE) with one or more combined reference signal configurations 1102 via, for example, radio resource control (RRC) signaling. In some examples, the network entity (or sidelink Tx UE) may configure the UE with a plurality of reference signal configurations 1104. The network entity may then map two or more of the reference signal configuration 1104 to a codepoint via RRC, MAC-CE or DCI (or SCI) to form the combined reference signal configuration 1102. The network entity (or sidelink Tx UE) may then trigger the combined reference signal configuration 1102 by transmitting the codepoint to the UE (or the sidelink Rx UE) via, for example, DCI (or SCI).

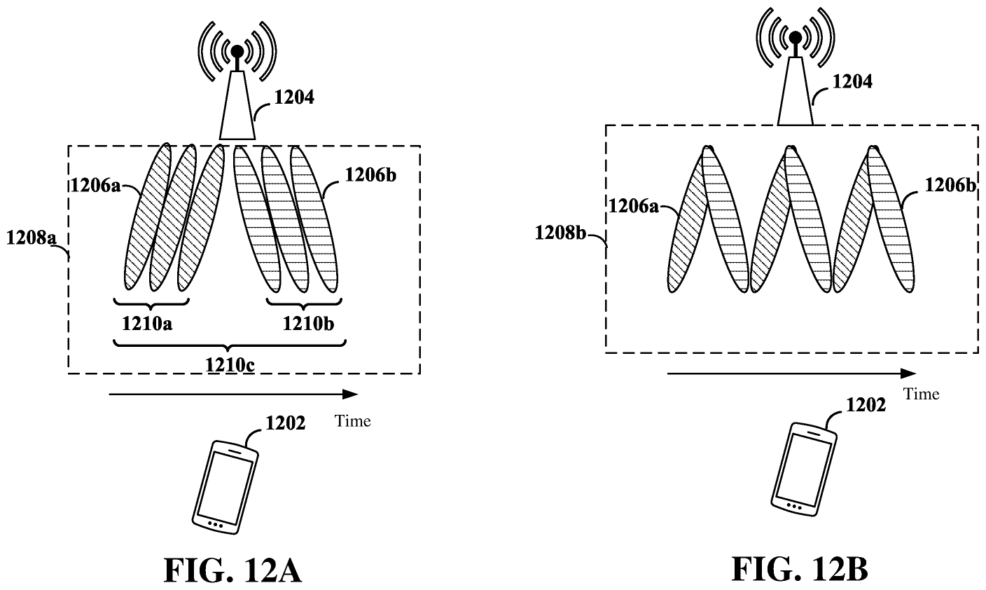

FIGS. 12A and 12B illustrate examples of beam refinement procedures between a UE 1202 and a network entity 1204 in accordance with a combined reference signal configuration according to some aspects. The UE 1202 may correspond to any of the UEs or scheduled entities shown in FIGS. 1, 3, 5, 7A, 7B, and/or 9. In addition, the network entity 1204 may correspond, for example, to any of the base stations (e.g., gNBs) or other scheduling entities shown in any of FIGS. 1, 3, 5, 7A, 7B and/or 9. The network entity 1204 may be implemented as an aggregated base station or a disaggregated base station. In a disaggregated base station architecture, the network entity 1204 may include one or more of a central unit (CU), a distributed unit (DU), or a radio unit (RU).

In the examples shown in FIGS. 12A and 12B, the UE 1202 and network entity 1204 are configured to perform a P3 (UE Rx) beam refinement procedure and a P2 (network entity Tx) beam refinement procedure. To facilitate the multiple beam refinement procedures, the network entity 1204 may configure the UE 1202 with a combined reference signal configuration 1208a or 1208b. Each of the combined reference signal configurations 1208a and 1208b include a first reference signal configuration 1210a associated with a first beam ID (e.g., identifying beam 1206a) and a first repetition pattern (e.g., repetition of the same beam 1206a) and a second reference signal configuration 1210b associated with a second beam ID (e.g., identifying beam 1206b) and a second repetition pattern (e.g., repetition of the same beam 1206b). Each of the beams 1206a and 1206b may be associated, for example, with a respective CSI-RS resource and identified by a corresponding CRI. In addition, each of the first and second reference signal configurations 1210a and 1210b are associated with a same communication direction (e.g., downlink) Thus, the UE 1202 may perform a first P3 beam refinement procedure based on the first reference signal configuration 1210a and a second P3 beam refinement procedure based on the second reference signal configuration 1210b.

In addition, the combination of the first reference signal configuration 1210a and the second reference signal configuration 1210b produces a third reference signal configuration 1210c that is associated with both the first beam ID (e.g., beam 1206a) and the second beam ID (e.g., beam 1206b). The network entity 1204 may perform a P2 beam refinement procedure based on the third reference signal configuration 1210c. As a result, a report setting may be configured for the combined reference signal configuration 1208a or 1208b to enable the UE 1202 to report beam measurements for the P2 beam refinement procedure.

The combined reference signal configurations 1208a and 1208b may further indicate an order of repetitions of each of the first and second reference signal configurations 1210a and 1210b. In some examples, as shown in FIG. 12A, the order of repetitions of the combined reference signal configuration 1208a may be sequential in time, where the first repetition pattern of the reference signal configuration 1210a occurs prior in time to the second repetition pattern of the second reference signal configuration 1210b. In other examples, as shown in FIG. 12B, the order of repetitions of the combined reference signal configuration 1208b may indicate that the first repetition pattern of first reference signal configuration 1210a and the second repetition pattern of the second reference signal configuration 1210b are interleaved in time.

It should be understood that the combined reference signal configurations 1208a and 1208b shown in FIGS. 12A and 12B may further be applicable to sidelink reference signal configurations, where the beam refinement procedures occur between two UEs instead of a UE and a network entity.

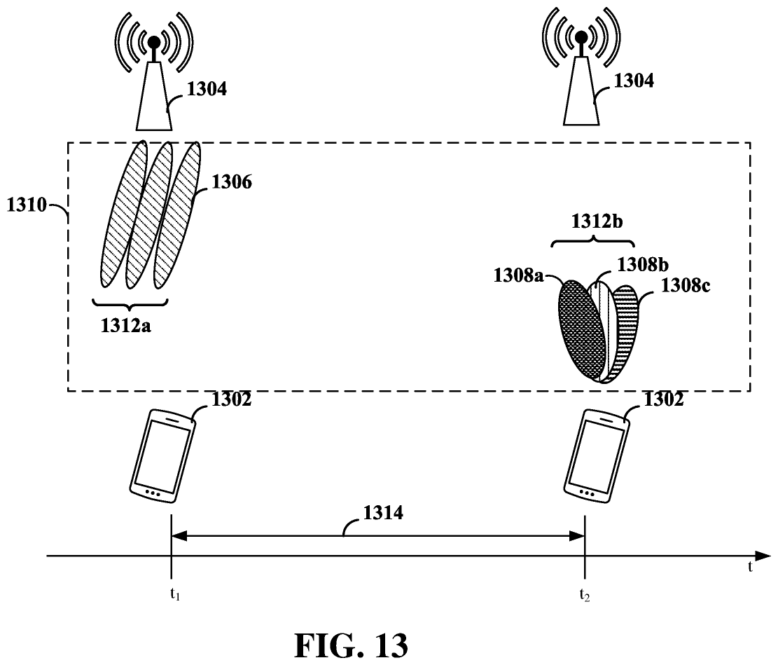

FIG. 13 illustrates another example of beam refinement procedures between a UE 1302 and a network entity 1304 in accordance with a combined reference signal configuration according to some aspects. The UE 1302 may correspond to any of the UEs or scheduled entities shown in FIGS. 1, 3, 5, 7A, 7B, 9, 12A, and/or 12B. In addition, the network entity 1304 may correspond, for example, to any of the base stations (e.g., gNBs) or other scheduling entities shown in any of FIGS. 1, 3, 5, 7A, 7B, 9, 12A, and/or 12B. The network entity 1304 may be implemented as an aggregated base station or a disaggregated base station. In a disaggregated base station architecture, the network entity 1304 may include one or more of a central unit (CU), a distributed unit (DU), or a radio unit (RU).

In the example shown in FIG. 13, the UE 1302 and network entity 1304 are configured to perform a P3 (UE Rx) beam refinement procedure and a UE Tx beam refinement procedure during the same time period, as indicated by a combined reference signal configuration configured by the network entity 1304. To facilitate the multiple beam refinement procedures, the network entity 1304 may configure the UE 1302 with a combined reference signal configuration 1310. The combined reference signal configuration 1310 includes a first reference signal configuration 1312a associated with a first beam ID (e.g., identifying beam 1306) with repetition and a second reference signal configuration 1312b associated with a plurality of second beam IDs (e.g., identifying beams 1308a, 1308b, and 1308c) without repetition. Beam 1306 may be associated, for example, with a CSI-RS resource and may be identified by a corresponding CRI. Beams 1308a, 1308b, and 1308c may each be associated with a respective SRS resource and identified by a respective corresponding SRI. In addition, the first and second reference signal configurations 1312a and 1312b are associated with different communication directions (e.g., downlink and uplink). Thus, the UE 1302 may perform a P3 (UE Rx) beam refinement procedure based on the first reference signal configuration 1312a and a UE Tx beam refinement procedure based on the second reference signal configuration 1312b.

In addition, the combined reference signal configuration 1310 may indicate a time gap 1314 between the first reference signal configuration 1312a and the second reference signal configuration 1312b to allow time for UE downlink/uplink switching. Thus, the combined reference signal configuration 1310 may indicate that the last reference signal (last beam 1306) of the first reference signal configuration 1312a is transmitted at time t₁ and the first reference signal (beam 1308a) of the second reference signal configuration 1312b is transmitted at time t₂. The time gap 1314 may be configured based on, for example, the direction switch (e.g., uplink to downlink or downlink to uplink). In addition, the time gap 1314 may be configured based on the subcarrier spacing and/or the UE capability (e.g., the switching time may be specified in the UE capability).

It should be understood that the combined reference signal configuration 1310 shown in FIG. 13 may further be applicable to sidelink reference signal configurations, where the beam refinement procedures are between two UEs instead of a UE and a network entity.

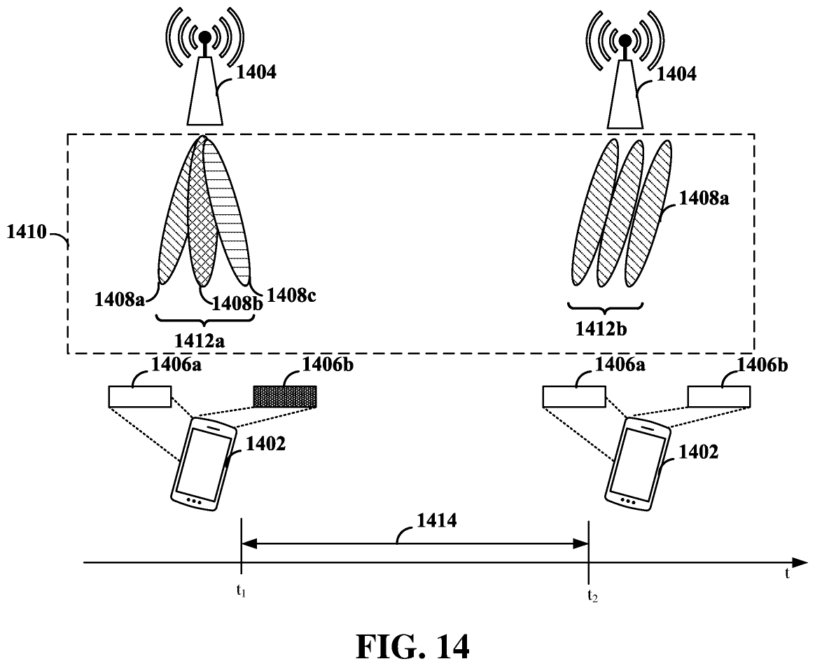

FIG. 14 illustrates another example of beam refinement procedures between a UE 1402 and a network entity 1404 in accordance with a combined reference signal configuration according to some aspects. The UE 1402 may correspond to any of the UEs or scheduled entities shown in FIGS. 1, 3, 5, 7A, 7B, 9, 12A, 12B, and/or 13. In addition, the network entity 1404 may correspond, for example, to any of the base stations (e.g., gNBs) or other scheduling entities shown in any of FIGS. 1, 3, 5, 7A, 7B, 9, 12A, 12B, and/or 13. The network entity 1404 may be implemented as an aggregated base station or a disaggregated base station. In a disaggregated base station architecture, the network entity 1404 may include one or more of a central unit (CU), a distributed unit (DU), or a radio unit (RU).

In the example shown in FIG. 14, the UE 1402 and network entity 1404 are configured to perform a P2 (network entity Tx) beam refinement procedure and a P3 (UE Rx) beam refinement procedure. To facilitate the multiple beam refinement procedures, the network entity 1404 may configure the UE 1402 with a combined reference signal configuration 1410. The combined reference signal configuration 1410 includes a first reference signal configuration 1412a associated with a plurality of beam IDs (e.g., beams 1408a, 1408b, and 1408c) without repetition and a second reference signal configuration 1412b associated with a particular beam ID (e.g., beam 1408a) with repetition. Beams 1408a, 1408b, and 1408c may each be associated, for example, with a respective CSI-RS resource and may be identified by a respective corresponding CRI. In addition, the first and second reference signal configurations 1412a and 1412b are associated with the same communication direction (e.g., downlink) Thus, the network entity 1404 may perform a P2 (network entity Tx) beam refinement procedure based on the first reference signal configuration 1412a, and the UE 1402 may perform a P3 (UE Rx) beam refinement procedure based on the second reference signal configuration 1412b. As a result, a report setting may be configured for the combined reference signal configuration 1410 to enable the UE 1402 to report beam measurements for the P2 beam refinement procedure.

In the example shown in FIG. 14, the UE 1402 may include two or more antenna panels 1406a and 1406b. A single antenna panel 1406a may be enabled for the P2 beam refinement procedure for beam measurement of the plurality of network entity transmit beams 1408a-1408c on a single UE Rx receive beam, whereas multiple antenna panels 1406a and 1406b may be enabled for the P3 beam refinement procedure to select an appropriate UE Rx beam to form a BPL with network entity transmit beam 1408a. In this example, the combined reference signal configuration 1410 may indicate a time gap 1414 between the first reference signal configuration 1412a and the second reference signal configuration 1412b to allow time for the UE 1402 to enable additional antenna panels (e.g., antenna panel 1406b). Thus, the combined reference signal configuration 1410 may indicate that the last reference signal (last beam 1408c) of the first reference signal configuration 1412a is transmitted at time t₁ and the first reference signal (beam 1408a) of the second reference signal configuration 1412b is transmitted at time t₂. The time gap 1414 may be configured based on, for example, the direction switch (e.g., uplink to downlink or downlink to uplink). In addition, the time gap 1414 may be configured based on the subcarrier spacing and/or the UE capability (e.g., the antenna panel enable time may be specified in the UE capability).

It should be understood that the combined reference signal configuration 1410 shown in FIG. 14 may further be applicable to sidelink reference signal configurations, where the beam refinement procedures are between two UEs instead of a UE and a network entity.

In some examples, the combined reference signal configurations shown in FIGS. 12A-14 may be stand-alone configurations that are configured to include multiple individual reference signal configurations. In other examples, the combined reference signal configurations may be formed by mapping two or more individual reference signal configurations that have been pre-configured to a combined reference signal configuration.

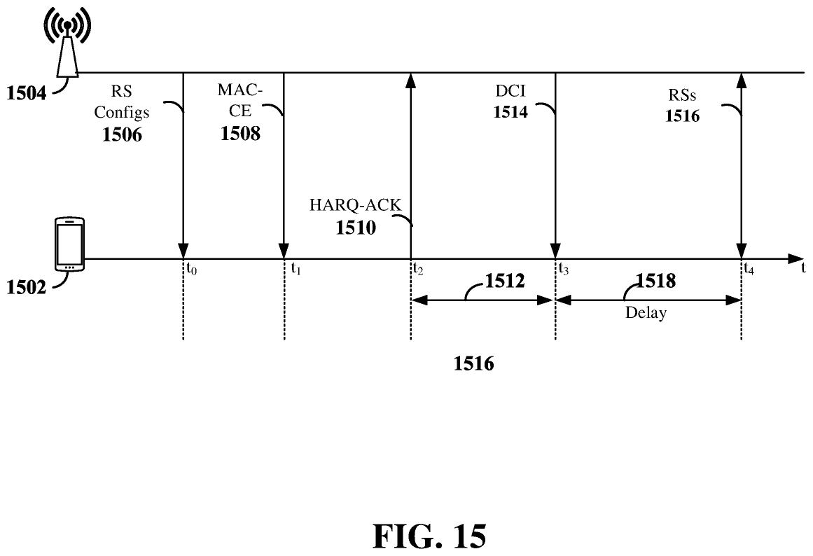

FIG. 15 is a diagram illustrating exemplary signaling between a UE 1502 and a network entity 1504 for a combined reference signal configuration according to some aspects. The UE 1502 may correspond to any of the UEs or scheduled entities shown in FIGS. 1, 3, 5, 7A, 7B, 9, 12A, 12B, 13 and/or 14. In addition, the network entity 1504 may correspond, for example, to any of the base stations (e.g., gNBs) or other scheduling entities shown in any of FIGS. 1, 3, 5, 7A, 7B, 9, 12A, 12B, 13, and/or 14. The network entity 1404 may be implemented as an aggregated base station or a disaggregated base station. In a disaggregated base station architecture, the network entity 1404 may include one or more of a central unit (CU), a distributed unit (DU), or a radio unit (RU).

At an initial time to, the network entity 1504 may generate two or more reference signal configurations 1506 and transmit the two or more reference signal configurations 1506 to the UE 1502. For example, the network entity 1504 may transmit an RRC message including the two or more reference signal configurations to the UE 1502.

At time t₁, the network entity 1504 may transmit a message 1508 that maps the two or more reference signal configurations (or a subset of the two or more reference signal configurations) to a codepoint identifying a combined reference signal configuration. For example, the network entity 1504 may transmit an RRC message, a MAC-CE, or DCI that maps the two or more reference signal configurations to the codepoint.

In the example shown in FIG. 15, the network entity 1504 transmits the message within a MAC-CE. Therefore, at time t₂, the UE 1502 may transmit acknowledgement information (HARQ ACK) 1510 to the network entity 1504 acknowledging receipt of the message. For a MAC-CE message 1508, the codepoint mapping may be used after a period of time 1512 of at least 3 ms from the UE 1502 transmitting the HARQ-ACK 1510 has passed. Thus, at time t₃, the network entity 1504 may transmit control information 1514 (e.g., DCI) triggering the combined reference signal configuration. For example, the DCI 1514 may include the codepoint identifying the combined reference signal configuration that each of the two or more individual reference signal configurations are mapped to.

At time t₄, the network entity 1504 and UE 1502 may communicate reference signals 1516 in accordance with the combined reference signal configuration. The reference signals 1516 may be communicated, for example, after a delay 1518 from the DCI 1514 (e.g., measured from time t₃ to t₄). The delay 1518 may be based on an initial communication direction of a first reference signal associated with the combined reference signal configuration. For example, the delay 1518 between the DCI 1514 and the first reference signal 1516 may be based on beam switch timing if the first reference signal is a downlink reference signal (e.g., a CSI-RS). As another example, the delay 1518 between the DCI 1514 and the first reference signal 1516 may be based on downlink/uplink switch timing if the first reference signal is an uplink reference signal (e.g., an SRS).

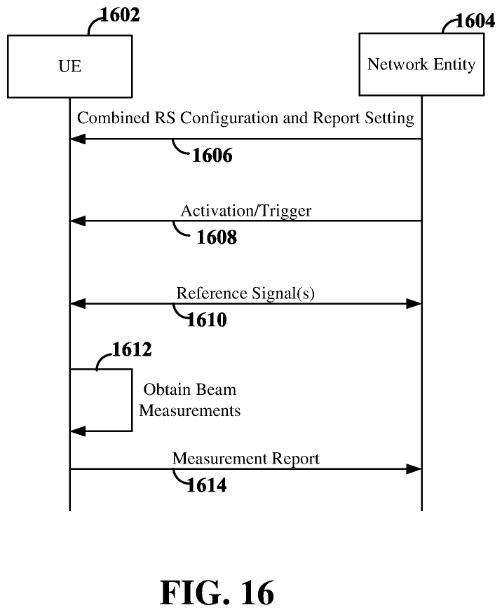

FIG. 16 is a signaling diagram illustrating an example of a beam management procedure using a combined reference signal configuration between a UE 1602 and a network entity 1604 according to some aspects. The UE 1602 may correspond to any of the UEs or scheduled entities shown in FIGS. 1, 3, 5, 7A, 7B, 9, 12A, 12B, and/or 13-15. In addition, the network entity 1604 may correspond, for example, to any of the base stations (e.g., gNBs) or other scheduling entities shown in any of FIGS. 1, 3, 5, 7A, 7B, 9, 12A, 12B, and/or 13-15. The network entity 1604 may be implemented as an aggregated base station or a disaggregated base station. In a disaggregated base station architecture, the network entity 1604 may include one or more of a central unit (CU), a distributed unit (DU), or a radio unit (RU).

At 1606, the network entity 1604 may transmit a combined reference signal configuration including two or more reference signal configurations to the UE 1602. In some examples, the network entity 1604 may transmit the combined reference signal configuration to the UE 1602 in response to a request from the UE 1602. In some examples, the two or more reference signal configurations may include downlink reference signal configurations, or a combination of uplink and downlink reference signal configurations.

In some examples, each of the two or more reference signal configurations may indicate one or more beam IDs with or without repetition. In some examples, the combined reference signal configuration may be a periodic configuration, a semi-persistent configuration, or an aperiodic configuration. In some examples, the network entity 1604 may transmit an RRC message including an RRC configuration (e.g., RRC configuration information element (IE)) indicating the combined reference signal configuration.

The network entity 1604 may further transmit at least one report setting associated with the combined reference signal configuration. For example, the network entity 1604 may transmit a single report setting linked to the combined reference signal configuration. In other examples, the network entity 1604 may transmit a separate report setting for each of the reference signal configurations of the combined reference signal configuration.

At 1608, the network entity 1604 may optionally transmit an activation/trigger for the combined reference signal configuration. For example, the network entity 1604 may transmit control information (e.g., DCI) triggering an aperiodic combined reference signal configuration or a MAC-CE activating a semi-persistent combined reference signal configuration.

At 1610, the UE 1602 and the network entity 1604 may communicate reference signals associated with the two or more reference signal configurations based on the combined reference signal configuration. For example, the network entity 1604 may transmit one or more CSI-RSs. As another example, the network entity 1604 may transmit one or more CSI-RSs and the UE 1602 may transmit one or more SRSs in accordance with the combined reference signal configuration. Each CSI-RS is communicated on a CSI-RS resource (e.g., beam, frequency resource, and OFDM symbol) and each SRS is communicated on an SRS resource (e.g., beam, frequency resource, and OFDM symbol).

At 1612, the UE 1602 may obtain one or more beam measurements, each corresponding to a downlink beam (e.g., CSI-RS beam) utilized for communication of the downlink reference signals (e.g., CSI-RSs). For example, the UE 1602 may measure a respective RSRP or determine a respective SINR of each of the received downlink reference signals on each of the downlink beams.

At 1614, the UE 1602 may generate and transmit to the network entity 1604 a measurement report (e.g., an L1 measurement report) including the beam measurements. The measurement report may have a format based on the at least one report setting. In examples in which there is more than one report setting associated with the combined reference signal configuration, the beam measurements in the measurement report may be divided by report setting. In addition, the measurement report may further include a report setting indicator indicating a corresponding report setting for each of the beam measurements.

In some examples, the absolute value of each of the beam measurements is included in the measurement report. In other examples, the absolute value of the beam measurements for one of downlink reference signals with repetition or downlink reference signals without repetition may be included in the measurement report. In other examples, an average or highest beam measurement of the same downlink beam may be included in the measurement report. In other examples, an absolute value of a highest beam measurement for a group of downlink reference signals may be included in the measurement report, along with a respective differential value from the highest absolute value of each of the remaining downlink reference signals in the reference signal group. For example, the group of reference signals may be associated with a same network entity (e.g., network entity 1604) or a same QCL source (e.g., a same SSB beam).

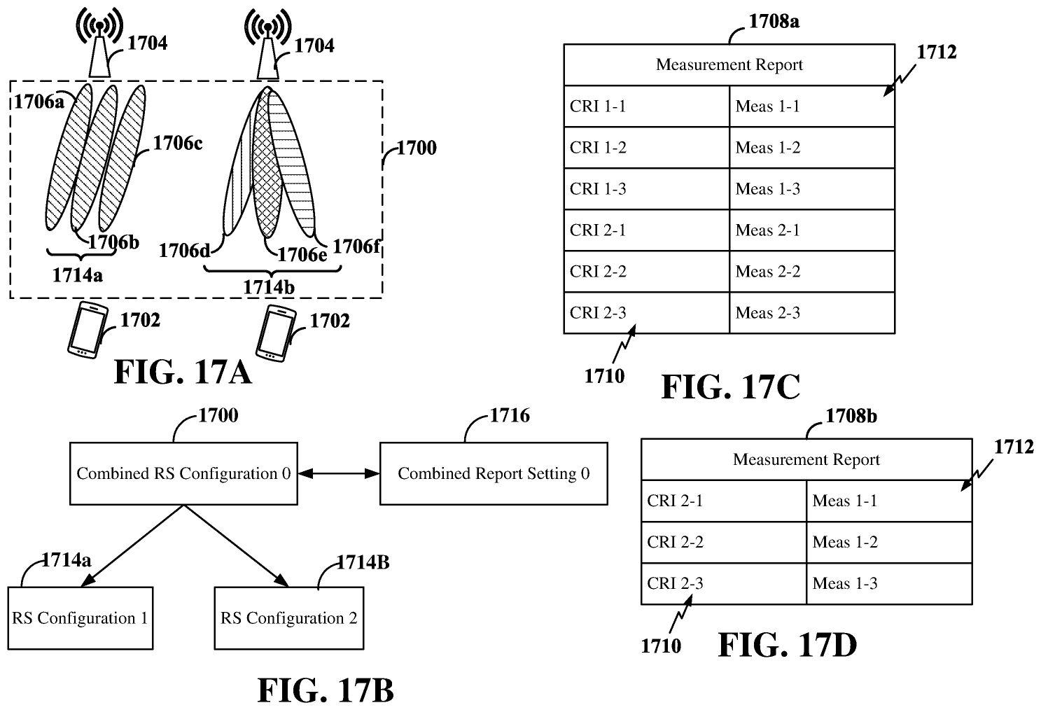

FIG. 17A illustrates an example of a combined reference signal configuration 1700 utilized by a UE 1702 and a network entity 1704 according to some aspects. The UE 1702 may correspond to any of the UEs or scheduled entities shown in FIGS. 1, 3, 5, 7A, 7B, 9, 12A, 12B, and/or 13-16. In addition, the network entity 1704 may correspond, for example, to any of the base stations (e.g., gNBs) or other scheduling entities shown in any of FIGS. 1, 3, 5, 7A, 7B, 9, 12A, 12B, and/or 13-16. The network entity 1704 may be implemented as an aggregated base station or a disaggregated base station. In a disaggregated base station architecture, the network entity 1704 may include one or more of a central unit (CU), a distributed unit (DU), or a radio unit (RU).

The combined reference signal configuration 1700 includes a first reference signal configuration 1714a associated with a particular beam ID with repetition (e.g., beams 1706a-1706c) and a second reference signal configuration 1714b associated with a plurality of beam IDs without repetition (e.g., beams 1706d, 1706e, and 1706f). Thus, beams 1706a-1706f are the same beam transmitted at different times (with repetition). Each of the received beams 1708a-1708f may be associated with a respective CSI-RS resource and may be identified by a respective corresponding CRI. In addition, the first and second reference signal configurations 1714a and 1714b are associated with the same communication direction (e.g., downlink).

The combined reference signal configuration 1700 may be associated with one or more report settings, and the UE 1702 may be configured to generate and transmit a measurement report in accordance with the one or more report settings. FIG. 17B illustrates an example of a combined reference signal configuration 1700 (e.g., Combined RS Configuration 0) linked with a single report setting 1716 (Combined Report Setting 0) according to some aspects. The combined reference signal configuration 1700 corresponds to the combined reference signal configuration shown in FIG. 17A and includes the reference signal configurations 1714a and 1714b (RS Configuration 1 and RS Configuration 2) shown in FIG. 17A.

The report setting 1716 may include a reportQuantity that indicates, for example, the specific L1 parameters (e.g., L1-RSRP, L1-SINR) to include in a measurement report. The report setting 1716 may further indicate a periodicity of the measurement report. For example, the report setting 1716 may indicate that the measurement report should be generated periodically, aperiodically, or semi-persistently based on the time domain behavior of the combined reference signal configuration 1700. For example, an aperiodic report setting 1716 may be linked to periodic, semi-persistent, or aperiodic combined reference signal configuration 1700. However, a semi-persistent report setting 1716 may be linked to only periodic or semi-persistent combined reference signal configuration 1700. In addition, a periodic report setting 1716 may be linked to only a periodic combined reference signal configuration 1700. For aperiodic report settings 1716, the measurement report may be sent on the PUSCH and may or may not be multiplexed with uplink data. For periodic report settings 1716, the measurement report may be sent on the PUCCH (e.g., a short PUCCH or a long PUCCH). For semi-persistent report settings 1716, the measurement report may be sent on the PUCCH or the PUSCH. For example, semi-persistent measurement reports sent on the PUCCH may be activated or deactivated using a medium access control (MAC) control element (MAC-CE). Semi-persistent measurement reports sent on the PUSCH may be triggered using downlink control information (DCI). The report settings 1716 may further include a respective priority and other suitable parameters.

FIGS. 17C and 17D illustrate examples of measurements reports 1708a and 1708b, respectively, generated based on the combined reference signal configuration 1700 shown in FIG. 17A and the single report setting 1716 shown in FIG. 17B for the combined reference signal configuration according to some aspects. As shown in FIGS. 17B and 17C, the measurement reports 1708a and 1708b each include a plurality of reference signal resource IDs (e.g., CRIs) 1710, each identifying a respective beam (e.g., one of beams 1706a-1706f), and a respective beam measurement 1712 for each reference signal resource ID.

In the example shown in FIG. 17C, the measurement report 1708a includes a respective absolute value of the beam measurement 1712 for each network entity transmit beam 1710 (e.g., beams 1706a-1706f) received by the UE 1702. For example, the measurement report 1708a may include a first beam measurement (Meas 1-1) for the first beam 1706a (CRI 1-1) received by the UE 1702 in the first reference signal configuration 1714a of the combined reference signal configuration 1700, a second beam measurement (Meas 1-2) for the second beam 1706b (CRI 1-2) received by the UE 1702 in the first reference signal configuration 1714a of the combined reference signal configuration 1700, and a third beam measurement (Meas 1-3) for the third beam 1706c (CRI 1-3) received by the UE 1702 in the first reference signal configuration 1714a of the combined reference signal configuration 1700. Here, the first, second, and third beams 1706a-1706c are the same beam transmitted on different resources. In addition, the measurement report 1708a may include a fourth beam measurement (Meas 2-1) for the fourth beam 1706d (CRI 2-1) received by the UE 1702 in the second reference signal configuration 1714b of the combined reference signal configuration 1700, a fifth beam measurement (Meas 2-2) for the fifth beam 1706e (CRI 2-2) received by the UE 1702 in the second reference signal configuration 1714b of the combined reference signal configuration, and a sixth beam measurement (Meas 2-3) for the sixth beam 1706f (CRI 2-3) received by the UE 1702 in the second reference signal configuration 1714b of the combined reference signal configuration 1700. Here, the third, fourth, and fifth beams 1706d-1706f are different beams transmitted on different resources.

In the example shown in FIG. 17D, the measurement report 1708b includes a respective absolute value of the beam measurement for each network entity transmit beam 1710 (e.g., beams 1706d-1706f) received by the UE 1702 in the second reference signal configuration 1714b of the combined reference signal configuration 1700. Thus, in this example, the measurement report 1708b may not include the beam measurements associated with the first reference signal configuration 1714a.

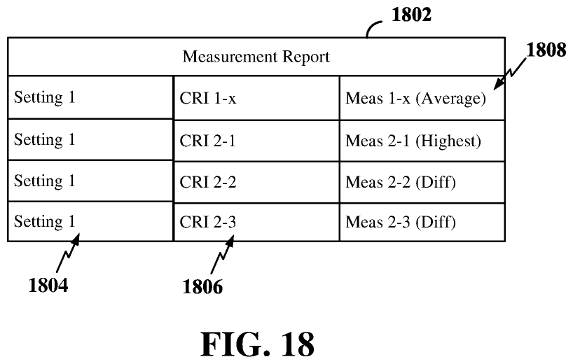

FIG. 18 is a diagram illustrating another example of a measurement report 1802 generated based on the combined reference signal configuration 1700 shown in FIG. 17A and the single report setting 1716 shown in FIG. 17B for the combined reference signal configuration according to some aspects. In the example shown in FIG. 18, the measurement report 1802 includes a report setting indicator 1804 identifying the report setting 1716 associated with the measurement report 1802, a plurality of reference signal resource IDs (e.g., CRIs) 1806, each identifying a respective beam (e.g., one of beams 1706a-1706f), and a respective beam measurement 1808 for each reference signal resource ID.

In addition, in the example shown in FIG. 18, the measurement report 1802 includes an average or highest (e.g., maximum) beam measurement 1808 for the network entity transmit beams 1806 associated with the first reference signal configuration 1712a of the combined reference signal configuration. Thus, the measurement report 1802 may include an average or highest beam measurement (e.g., Meas 1-x (Average/Highest) of the reference signal resources (e.g., CRI 1-x) for the same network entity transmit beam (e.g., beams 1706a-1706c) sent with repetition. In addition, the measurement report 1802 may include an absolute value of a highest (e.g., maximum) beam measurement 1808 for one of the network entity transmit beams 1806 associated with the second reference signal configuration 1712b of the combined reference signal configuration and respective differential beam measurements with respect to the maximum beam measurement for the remaining network entity transmit beams 1710 associated with the second reference signal configuration 1714b. Thus, the measurement report 1802 may include the highest beam measurement (Meas 2-1 (Highest)) for one of the beams (e.g., beam 1706d indexed by CRI 2-1) and respective differential beam measurements (Meas 2-2 (Diff) and Meas 2-3 (Diff)) for the remaining beams (e.g., beam 1706e indexed by CRI 2-2 and beam 1706f indexed by CRI 2-3) in the second reference signal configuration 1714b.

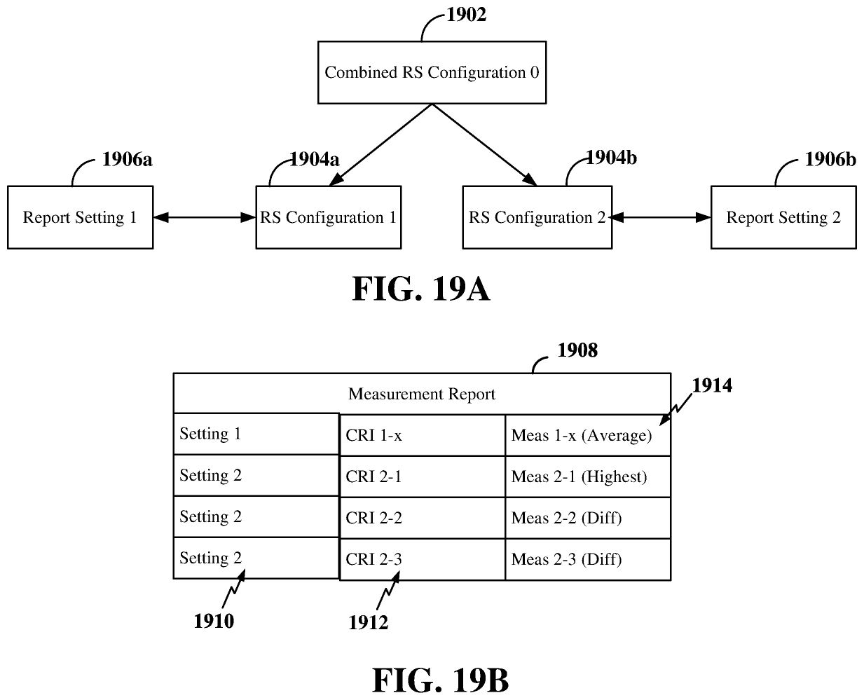

FIG. 19A illustrates an example of a combined reference signal configuration 1902 (e.g., Combined RS Configuration 0) linked with multiple report settings 1906a and 1906b (Report Setting 1 and Report Setting 2) according to some aspects. The combined reference signal configuration 1900 corresponds to the combined reference signal configuration shown in FIG. 17A and includes the reference signal configurations 1904a and 1904b (RS Configuration 1 and RS Configuration 2) corresponding to the reference signal configurations 1714a and 1714b shown in FIG. 17A. In the example shown in FIG. 19A, each reference signal configuration 1904a and 1904b is linked to a respective report setting 1906a and 1906b. Each report setting 1906a and 1906b includes a reportQuantity that indicates, for example, the specific L1 parameters (e.g., L1-RSRP, L1-SINR) to include in a combined measurement report for both report settings 1906a and 1906b.

FIG. 19B is a diagram illustrating another example of a measurement report 1908 generated based on the combined reference signal configuration 1902 and the multiple report settings 1906a and 1906b shown in FIG. 19A for the combined reference signal configuration according to some aspects. In the example shown in FIG. 19B, the measurement report 1908 includes a plurality of reference signal resource IDs (e.g., CRIs) 1912, each identifying a respective beam (e.g., one of beams 1706a-1706f), and a respective beam measurement 1914 for each reference signal resource ID. In addition, the measurement report 1908 includes a report setting indicator 1910 (Report Setting 1 or Report Setting 2) identifying the report setting 1906a or 1906b associated with each of the beam measurements 1914.

In addition, in the example shown in FIG. 19B, the measurement report 1908 includes an average or highest beam measurement (e.g., Meas 1-x (Average) of the reference signal resources (e.g., CRI 1-x) for the same network entity transmit beam (e.g., beams 1706a-1706c) sent with repetition in the first reference signal configuration 1904a (corresponding to reference signal configuration 1714a shown in FIG. 17A). In addition, the measurement report 1908 includes an absolute value of a highest (e.g., maximum) beam measurement (Meas 2-1 (Highest)) for one of the beams (e.g., beam 1706d indexed by CRI 2-1) and respective differential beam measurements (Meas 2-2 (Diff) and Meas 2-3 (Diff)) for the remaining beams (e.g., beam 1706e indexed by CRI 2-2 and beam 1706f indexed by CRI 2-3) in the second reference signal configuration 1904b (corresponding to reference signal configuration 1714b shown in FIG. 17A).

In some examples, the report setting 1906b linked to the second reference signal configuration 1904b may group the reference signals (CSI-RSs) within the second reference signal configuration 1904b into a reference signal group to facilitate reporting of the highest beam measurement and differential beam measurements within the reference signal group. In other examples, the reference signal group may include reference signals across report settings 1906a and 1906b. For example, the reference signals for a combined reference signal configuration 1902 may be grouped into one or more reference signal groups based on a network entity associated with each the reference signals and/or a QCL source (e.g., SSB beam) associated with each the reference signals.

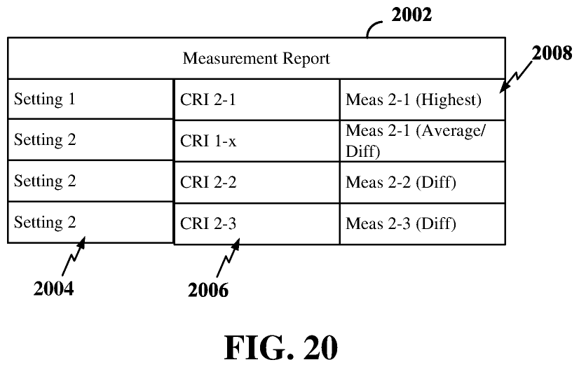

FIG. 20 is a diagram illustrating another example of a measurement report 2002 generated based on the combined reference signal configuration 1902 and the multiple report settings 1906a and 1906b shown in FIG. 19A for the combined reference signal configuration according to some aspects. In the example shown in FIG. 20, the measurement report 2002 includes a plurality of reference signal resource IDs (e.g., CRIs) 2006, each identifying a respective beam (e.g., one of beams 1706a-1706f), and a respective beam measurement 2008 for each reference signal resource ID. In addition, the measurement report 2002 includes a report setting indicator 2004 (Report Setting 1 or Report Setting 2) identifying the report setting 1906a or 1906b associated with each of the beam measurements 2008.

In addition, in the example shown in FIG. 20, the beam measurements are reported according to a reference signal group formed across the report settings 1906a and 1906b. For example, the measurement report 2002 may include an absolute value of a highest (e.g., maximum) beam measurement (Meas 2-1 (Highest)) for one of the beams (e.g., beam 1706d indexed by CRI 2-1) in the reference signal group and respective differential beam measurements (e.g., Meas 2-2 (Diff) and Meas 2-3 (Diff)) for the remaining beams in the reference signal group (e.g., beam 1706e indexed by CRI 2-2 and beam 1706f indexed by CRI 2-3). In addition, for the beam measurements associated with the first reference signal configuration 1904a (corresponding to reference signal configuration 1714a), the measurement report 2002 can include a differential beam measurement 2008 (e.g., Meas 2-1 (Average/Diff)) based on an average or highest (e.g., maximum) beam measurement for the network entity transmit beams associated with the first reference signal configuration 1904a of the combined reference signal configuration (e.g., beam 1706e indexed by CRI 2-2 and beam 1706f indexed by CRI 2-3).

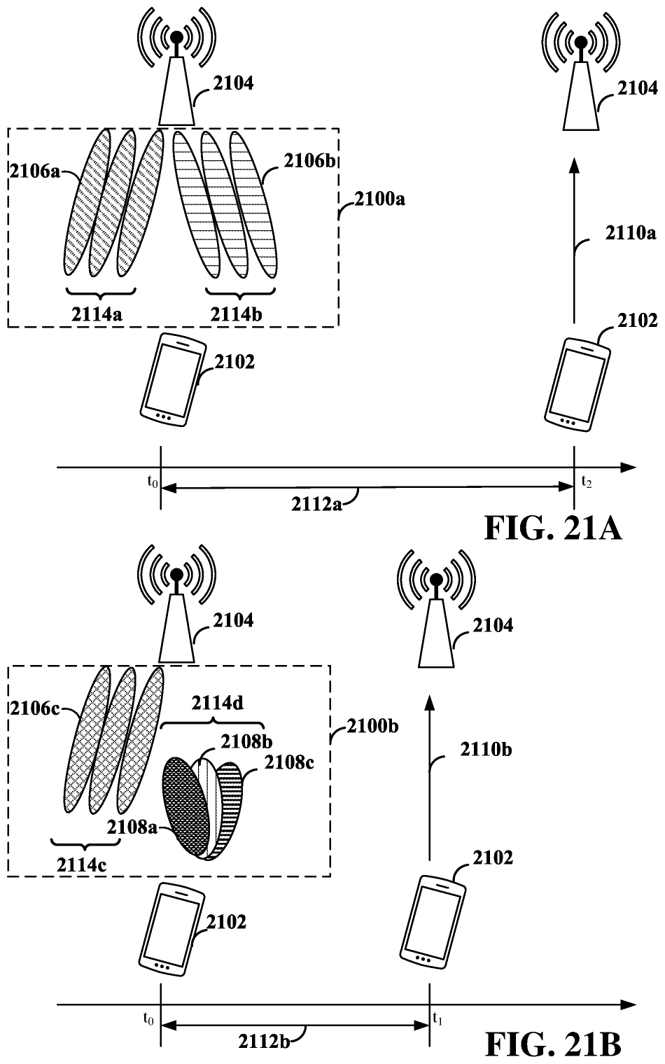

FIGS. 21A and 21B are diagrams illustrating examples of measurement report timing for a combined reference signal configuration 2100a or 2100b between a UE 2102 and a network entity 2104 according to some aspects. The UE 2102 may correspond to any of the UEs or scheduled entities shown in FIGS. 1, 3, 5, 7A, 7B, 9, 12A, 12B, and/or 13-17A. In addition, the network entity 2104 may correspond, for example, to any of the base stations (e.g., gNBs) or other scheduling entities shown in any of FIGS. 1, 3, 5, 7A, 7B, 9, 12A, 12B, and/or 13-17A. The network entity 2104 may be implemented as an aggregated base station or a disaggregated base station. In a disaggregated base station architecture, the network entity 2104 may include one or more of a central unit (CU), a distributed unit (DU), or a radio unit (RU).

In the example shown in FIG. 21A, the combined reference signal configuration 2100a includes a first reference signal configuration 2114a associated with a particular beam ID with repetition (e.g., beam 2106a) and a second reference signal configuration 2114b associated with another beam ID with repetition (e.g., beam 2106b). In addition, the first and second reference signal configurations 2114a and 2114b are associated with the same communication direction (e.g., downlink) In the example shown in FIG. 21B, the combined reference signal configuration 2100b includes a third reference signal configuration 2114c associated with a particular beam ID with repetition (e.g., beam 2106c) and a fourth reference signal configuration 2114d associated with a plurality of beam IDs without repetition (e.g., beams 2108a, 2108b, and 2108c). In addition, the third and fourth reference signal configuration 2114c and 2114d are each associated with a different communication direction. For example, the third reference signal configuration 2114c configures downlink reference signals (e.g., CSI-RSs), whereas the fourth reference signal configuration 2114d configures uplink reference signals (e.g., SRSs).

Each combined reference signal configuration 2100a and 2100b may be associated with one or more report settings, and the UE 2102 may be configured to generate and transmit a respective measurement report 2110a and 2110b in accordance with the one or more corresponding report settings. In various aspects, there may be a respective delay 2112a and 2112b between the communication of reference signals between the UE 2102 and the network entity 2104 according to the combined reference signal configuration 2100a and 2100b and the transmission of the corresponding measurement report 2110a and 2110b from the UE 2102 to the network entity 2104. The delay 2112a and 2112b may be based on the communication direction (e.g., downlink or uplink) of a last communicated reference signal in the corresponding combined reference signal configuration 2100a and 2100b.

For example, if the last communicated reference signal is a downlink reference signal, as shown in FIG. 21A, the delay 2112a may be based on the beam report timing (e.g., the time between the last reference signal received on the downlink and the measurement report sent on the uplink). As another example, if the last communicated reference signal is an uplink reference signal, as shown in FIG. 21B, the delay 2112b may be less than in the example shown in FIG. 21A since the UE does not need to switch from downlink to uplink (e.g., there is no downlink/uplink switching time to be accommodated). Thus, in the example shown in FIGS. 21A and 21B, if the last communicated reference signal in each of the combined reference signal configurations 2100a and 2100b is communicated at a time to, the UE 2102 can transmit the measurement report 2110a corresponding to the report setting associated with the first combined reference signal configuration 2100a at a time t₂, whereas the UE can transmit the measurement report 2110b corresponding to the report setting associated with second combined reference signal configuration 2100b at a time t₁, which is earlier than time t₂. Thus, the delay 2112b is less than the delay 2112a.

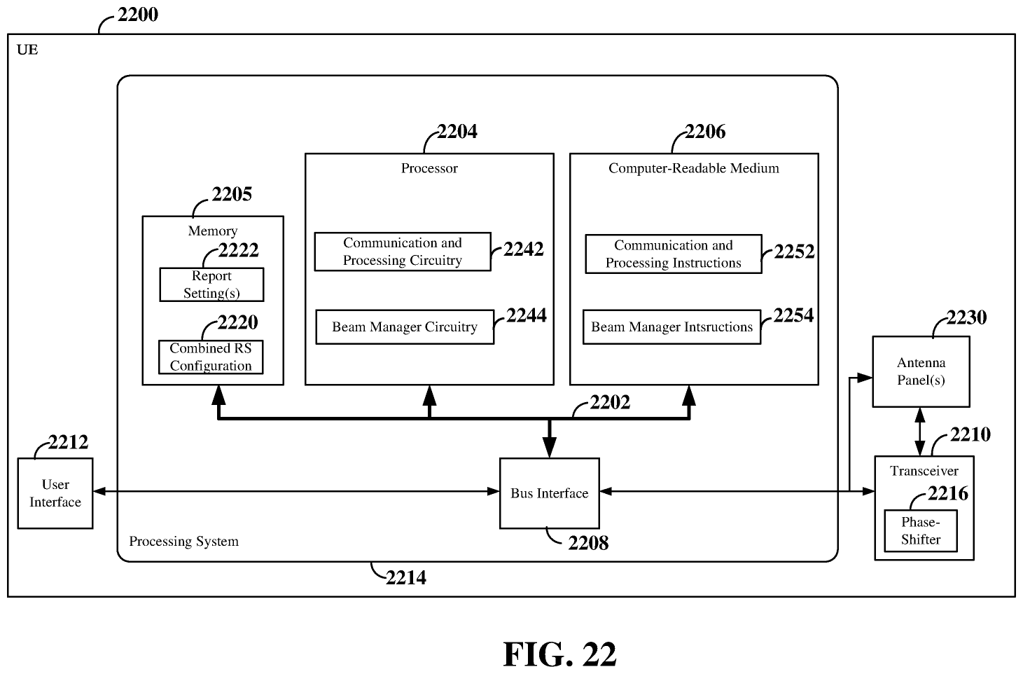

FIG. 22 is a block diagram illustrating an example of a hardware implementation for a UE 2200 employing a processing system 2214. For example, the UE 2200 may correspond to a UE, a sidelink device (e.g., a V2X device or D2D device) or other scheduled entity, as shown and described above in reference to FIGS. 1, 3, 5, 7A, 7B, 9, 12A, 12B, 13-17A, and/or 21.

The UE 2200 may be implemented with a processing system 2214 that includes one or more processors 2204. Examples of processors 2204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 2200 may be configured to perform any one or more of the functions described herein. That is, the processor 2204, as utilized in the UE 2200, may be used to implement any one or more of the processes and procedures described below.

In this example, the processing system 2214 may be implemented with a bus architecture, represented generally by the bus 2202. The bus 2202 may include any number of interconnecting buses and bridges depending on the specific application of the processing system 2214 and the overall design constraints. The bus 2202 links together various circuits including one or more processors (represented generally by the processor 2204), a memory 2205, and computer-readable media (represented generally by the computer-readable medium 2206). The bus 2202 may also link various other circuits such as timing sources, peripherals, voltage regulators, and power management circuits, which are well known in the art, and therefore, will not be described any further.

A bus interface 2208 provides an interface between the bus 2202 and a transceiver 2210 and one or more antenna panels 2230 (e.g., one or more antenna arrays). The transceiver 2210 provides a means for communicating with various other apparatus over a transmission medium (e.g., air interface). In some examples, the transceiver 2210 may include a phase-shifter 2216 for digital and/or analog beamforming via the one or more antenna panel(s) 2230. Depending upon the nature of the apparatus, a user interface 2212 (e.g., keypad, display, touch screen, speaker, microphone, control knobs, etc.) may also be provided. Of course, such a user interface 2212 is optional, and may be omitted in some examples.

The processor 2204 is responsible for managing the bus 2202 and general processing, including the execution of software stored on the computer-readable medium 2206. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 2204, causes the processing system 2214 to perform the various functions described below for any particular apparatus. The computer-readable medium 2206 and the memory 2205 may also be used for storing data that is manipulated by the processor 2204 when executing software. For example, the memory 2205 may store one or more of a combined reference signal (RS) configuration 2220 and/or one or more report settings 2222, which may be used by the processor 2204 in generating and processing reference signals and measurement reports.

The computer-readable medium 2206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 2206 may reside in the processing system 2214, external to the processing system 2214, or distributed across multiple entities including the processing system 2214. The computer-readable medium 2206 may be embodied in a computer program product. By way of example, a computer program product may include a computer-readable medium in packaging materials. In some examples, the computer-readable medium 2206 may be part of the memory 2205. Those skilled in the art will recognize how best to implement the described functionality presented throughout this disclosure depending on the particular application and the overall design constraints imposed on the overall system.

In some aspects of the disclosure, the processor 2204 may include circuitry configured for various functions. For example, the processor 2204 may include communication and processing circuitry 2242, configured to communicate with a RAN entity (e.g., a base station, such as a gNB) via a cellular (e.g., Uu) interface and one or more other wireless communication devices via a sidelink (e.g., PC5) interface. In some examples, the communication and processing circuitry 2242 may include one or more hardware components that provide the physical structure that performs processes related to wireless communication (e.g., signal reception and/or signal transmission) and signal processing (e.g., processing a received signal and/or processing a signal for transmission).

In some examples, the communication and processing circuitry 2242 may be configured to receive and process downlink beamformed signals at a mmWave frequency or a sub-6 GHz frequency via the transceiver 2210 and the antenna panel(s) 2230 (e.g., using the phase-shifter 2216). In addition, the communication and processing circuitry 2242 may be configured to generate and transmit uplink beamformed signals at a mmWave frequency or a sub-6 GHz frequency via the transceiver 2210 and antenna panel(s) 2230 (e.g., using the phase-shifter 2216).

In some implementations where the communication involves receiving information, the communication and processing circuitry 2242 may obtain information from a component of the UE 2200 (e.g., from the transceiver 2210 that receives the information via radio frequency signaling or some other type of signaling suitable for the applicable communication medium), process (e.g., decode) the information, and output the processed information. For example, the communication and processing circuitry 2242 may output the information to another component of the processor 2204, to the memory 2205, or to the bus interface 2208. In some examples, the communication and processing circuitry 2242 may receive one or more of signals, messages, other information, or any combination thereof. In some examples, the communication and processing circuitry 2242 may receive information via one or more channels. In some examples, the communication and processing circuitry 2242 may include functionality for a means for receiving. In some examples, the communication and processing circuitry 2242 may include functionality for a means for processing, including a means for demodulating, a means for decoding, etc.

In some implementations where the communication involves sending (e.g., transmitting) information, the communication and processing circuitry 2242 may obtain information (e.g., from another component of the processor 2204, the memory 2205, or the bus interface 2208), process (e.g., modulate, encode, etc.) the information, and output the processed information. For example, the communication and processing circuitry 2242 may output the information to the transceiver 2210 (e.g., that transmits the information via radio frequency signaling or some other type of signaling suitable for the applicable communication medium). In some examples, the communication and processing circuitry 2242 may send one or more of signals, messages, other information, or any combination thereof. In some examples, the communication and processing circuitry 2242 may send information via one or more channels. In some examples, the communication and processing circuitry 2242 may include functionality for a means for sending (e.g., a means for transmitting). In some examples, the communication and processing circuitry 2242 may include functionality for a means for generating, including a means for modulating, a means for encoding, etc.

In some examples, the communication and processing circuitry 2242 may be configured to receive a combined reference signal configuration 2220 including two or more reference signal configurations. Each reference signal configuration of the combined reference signal configuration 2220 may be associated with one or more beam identifiers (IDs) in a respective communication direction (e.g., uplink, downlink, sidelink Tx, or sidelink Rx). The communication and processing circuitry 2242 may further be configured to communicate reference signals (e.g., receive CSI-RSs, transmit SRSs, transmit/receive sidelink CSI-RSs and/or sidelink SRSs) associated with the two or more reference signal configurations based on the combined reference signal configuration. In some examples, the communication and processing circuitry 2242 may further be configured to transmit a request for the combined reference signal configuration.

In some examples, the communication and processing circuitry 2242 may further be configured to receive control information triggering the combined reference signal configuration. In some examples, the communication and processing circuitry 2242 may further be configured to receive at least one report setting associated with the combined reference signal configuration. In addition, the communication and processing circuitry 2242 may be configured to transmit a measurement report having a format based on the at least one report setting. The measurement report may include beam measurements, each corresponding to one of a plurality of beams utilized for communication of the reference signals. The communication and processing circuitry 2242 may further be configured to execute communication and processing instructions (software) 2252 stored in the computer-readable medium 2206 to implement one or more of the functions described herein.

The processor 2204 may further include beam manager circuitry 2244, configured to utilize the combined reference signal configuration 2220 to enable communication of reference signals for a beam refinement procedure on the Uu link or a sidelink. In addition, the beam manager circuitry 2244 may further be configured to utilize one or more report settings 2222 associated with the combined reference signal configuration 2220 to obtain beam measurements and to generate a measurement report including the beam measurements for transmission by the communication and processing circuitry 2242. The measurement report may be a Uu measurement report or a sidelink measurement report. In some examples, the beam manager circuitry 2244 may correspond to any of the beam manager(s) of UEs shown in FIGS. 1, 2, 4, 5, and/or 7.

In some examples, each reference signal configuration of the two or more reference signal configurations in the combined reference signal configuration 2220 may indicate at least one of a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction. For example, the first communication direction may be a downlink direction and the second communication direction may be an uplink direction. As another example, the first and second communication directions may be sidelink communication directions. In some examples, the combined reference signal configuration is one of a periodic configuration, a semi-persistent configuration, or an aperiodic configuration.

In some examples, the combined reference signal configuration includes one or more common parameters linked between the two or more reference signal configurations. In some examples, the one or more common parameters are linked between different communication directions of the two or more reference signal configurations. In some examples, the one or more common parameters are linked between a same communication direction of the two or more reference signal configurations. In some examples, the one or more common parameters include a same bandwidth, a same spatial relation, or a same quasi co-location (QCL) relationship.

In some examples, the two or more reference signal configurations include a first reference signal configuration associated with a first beam ID and a first repetition pattern and a second reference signal configuration associated with a second beam ID and a second repetition pattern. In addition, the first reference signal configuration and the second reference signal configuration may be associated with a same communication direction. In some examples, a combination of the first reference signal configuration and the second reference signal configuration in the combined reference signal configuration produces a third reference signal configuration associated with the first beam ID and the second beam ID without repetition. In some examples, the combined reference signal configuration indicates an order of repetitions of the first repetition pattern and the second repetition pattern. In some examples, the order of repetitions indicates that the first repetition pattern and the second repetition pattern are interleaved in time.

In some examples, the two or more reference signal configurations include a first reference signal configuration without repetition and a second reference signal configuration with repetition. In this example, the first reference signal configuration and the second reference signal configuration may be in a same direction and the combined reference signal configuration indicates a time gap between the first reference signal configuration and the second reference signal configuration. In some examples, the beam manager circuitry 2244 may further be configured to receive a first reference signal associated with the first reference signal configuration at a first antenna panel 2230 (e.g., using the phase-shifter 2216) on the UE, enable a second antenna panel 2230 on the UE during the time gap, and receive a second reference signal associated with the second reference signal configuration at the first antenna panel and the second antenna panel 2230 (e.g., using the phase-shifter 2216).

In some examples, the two or more reference signal configurations include a first reference signal configuration in a first communication direction and a second reference signal configuration in a second communication direction different than the first communication direction, and the combined reference signal configuration 2220 indicates a time gap between the first reference signal configuration and the second reference signal configuration.

In examples in which the communication and processing circuitry 2242 receives control information triggering the combined reference signal configuration 2220, the beam manager circuitry 2244 may further be configured to operate together with the communication and processing circuitry 2242 to communicate the reference signals after a delay from the control information. The delay may be based on an initial communication direction of a first reference signal associated with the combined reference signal configuration.

In some examples, the beam manager circuitry 2244 may generate the measurement report including the beam measurements based on the report setting(s) 2222 associated with the combined reference signal configuration 2220. In some examples, the beam measurements may include absolute values. In some examples, the beam measurements included in the measurement report (e.g., based on the report setting(s) 2222) may include at least one of first beam measurements associated with a first reference signal configuration without repetition or second beam measurements associated with a second reference signal configuration with repetition. In examples in which there is more than one report setting 2222 associated with the combined reference signal configuration 2220, the beam manager circuitry 2244 may further be configured to divide the beam measurements into the more than one report setting 2222 and to include a report setting indicator for each of the beam measurements in the measurement report.

In some examples, the combined reference signal configuration includes a plurality of reference signal resources on which the reference signals are communicated. In this example, the beam measurements can include a respective beam measurement for each of the plurality of reference signal resources. As another example, the beam measurements can include an average beam measurement for a set of reference signal resources of the plurality of reference signal resources associated with a same beam of the plurality of beams. As another example, the beam measurements can include a maximum (or highest) beam measurement for the set of reference signal resources.

In some examples, the reference signals are grouped into one or more reference signal groups. In this example, the beam measurements include an absolute value for a maximum beam measurement in each of the one or more groups and respective differential values for remaining beam measurements in each of the one or more groups. In some examples, the reference signals are grouped into the one or more reference signal groups based on a network entity or a QCL source (e.g., SSB beam) associated with each of the reference signals.

In some examples, the beam manager circuitry 2244 may be configured to operate together with the communication and processing circuitry 2242 to transmit a request for the combined reference signal configuration. In some examples, the beam manager circuitry 2244 may be configured to transmit the measurement report at a time based on the communication direction of a last communicated reference signal of the reference signals. The beam manager circuitry 2244 may further be configured to execute beam manager instructions (software) 2254 stored in the computer-readable medium 2206 to implement one or more of the functions described herein.

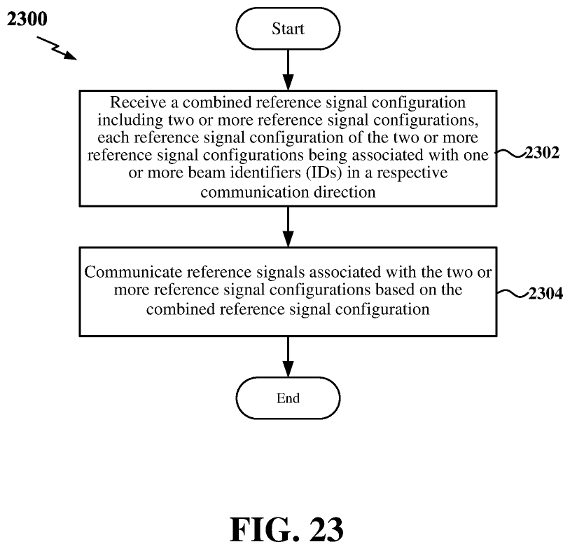

FIG. 23 is a flow chart of an exemplary process 2300 for implementing a combined reference signal configuration at a UE according to some aspects. As described below, some or all illustrated features may be omitted in a particular implementation within the scope of the present disclosure, and some illustrated features may not be required for implementation of all examples. In some examples, the method may be performed by the UE 2200, as described above and illustrated in FIG. 22, by a processor or processing system, or by any suitable means for carrying out the described functions.

At block 2302, the UE may receive a combined reference signal configuration including two or more reference signal configurations, where each reference signal configuration of the two or more reference signal configurations is associated with one or more beam identifiers (IDs) in a respective communication direction. In some examples, the UE may transmit a request for the combined reference signal configuration. For example, the communication and processing circuitry 2242, together with the beam manager circuitry 2244, transceiver 2210 and antenna array(s) 2230, shown and described above in connection with FIG. 22 may provide a means to receive the combined reference signal configuration.

In some examples, each reference signal configuration of the two or more reference signal configurations in the combined reference signal configuration may indicate at least one of a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction. For example, the first communication direction may be a downlink direction and the second communication direction may be an uplink direction. As another example, the first and second communication directions may be sidelink communication directions. In some examples, the combined reference signal configuration is one of a periodic configuration, a semi-persistent configuration, or an aperiodic configuration.

In some examples, the combined reference signal configuration includes one or more common parameters linked between the two or more reference signal configurations. In some examples, the one or more common parameters are linked between different communication directions of the two or more reference signal configurations. In some examples, the one or more common parameters are linked between a same communication direction of the two or more reference signal configurations. In some examples, the one or more common parameters include a same bandwidth, a same spatial relation, or a same quasi co-location (QCL) relationship.

In some examples, the two or more reference signal configurations include a first reference signal configuration associated with a first beam ID and a first repetition pattern and a second reference signal configuration associated with a second beam ID and a second repetition pattern. In addition, the first reference signal configuration and the second reference signal configuration may be associated with a same communication direction. In some examples, a combination of the first reference signal configuration and the second reference signal configuration in the combined reference signal configuration produces a third reference signal configuration associated with the first beam ID and the second beam ID without repetition. In some examples, the combined reference signal configuration indicates an order of repetitions of the first repetition pattern and the second repetition pattern. In some examples, the order of repetitions indicates that the first repetition pattern and the second repetition pattern are interleaved in time.

In some examples, the two or more reference signal configurations include a first reference signal configuration in a first communication direction and a second reference signal configuration in a second communication direction different than the first communication direction, and the combined reference signal configuration indicates a time gap between the first reference signal configuration and the second reference signal configuration.

At 2304, the UE may communicate reference signals associated with the two or more reference signal configurations based on the combined reference signal configuration. For example, the communication and processing circuitry 2242, together with the beam manager circuitry 2244, transceiver 2210 and antenna array(s) 2230 (e.g., using the phase-shifter 2216), shown and described above in connection with FIG. 22 may provide a means to communicate the reference signals.

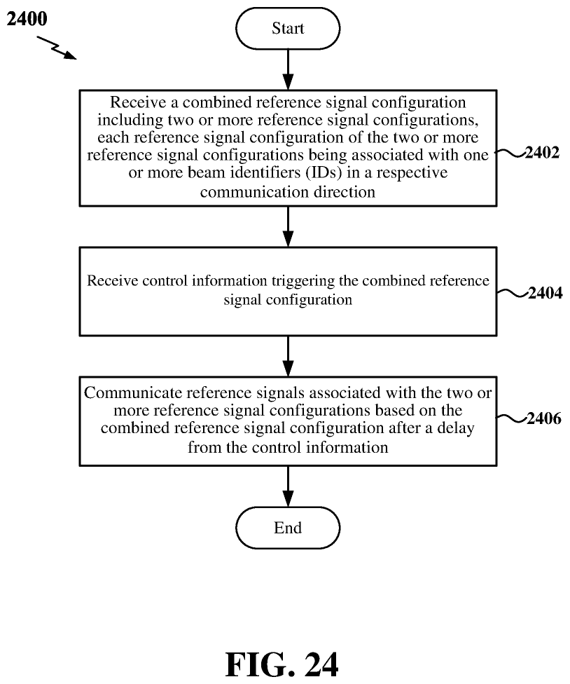

FIG. 24 is a flow chart of another exemplary process 2400 for implementing a combined reference signal configuration at a UE according to some aspects. As described below, some or all illustrated features may be omitted in a particular implementation within the scope of the present disclosure, and some illustrated features may not be required for implementation of all examples. In some examples, the method may be performed by the UE 2200, as described above and illustrated in FIG. 22, by a processor or processing system, or by any suitable means for carrying out the described functions.

At block 2402, the UE may receive a combined reference signal configuration including two or more reference signal configurations, where each reference signal configuration of the two or more reference signal configurations is associated with one or more beam identifiers (IDs) in a respective communication direction. For example, the communication and processing circuitry 2242, together with the beam manager circuitry 2244, transceiver 2210 and antenna array(s) 2230, shown and described above in connection with FIG. 22 may provide a means to receive the combined reference signal configuration.

At block 2404, the UE may receive control information triggering the combined reference signal configuration. For example, the communication and processing circuitry 2242, together with the beam manager circuitry 2244, transceiver 2210 and antenna array(s) 2230, shown and described above in connection with FIG. 22 may provide a means to receive the control information.

At block 2406, the UE may communicate the reference signals associated with the two or more reference signal configurations based on the combined reference signal configuration after a delay from the control information. The delay may be based on an initial communication direction of a first reference signal associated with the combined reference signal configuration. For example, the communication and processing circuitry 2242, together with the beam manager circuitry 2244, transceiver 2210 and antenna array(s) 2230 (e.g., using the phase-shifter), shown and described above in connection with FIG. 22 may provide a means to communicate the reference signals.

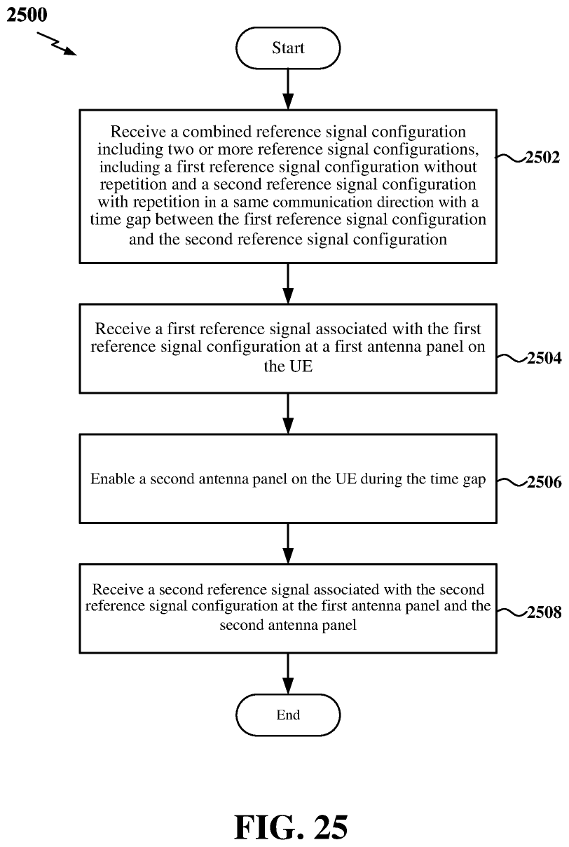

FIG. 25 is a flow chart of another exemplary process 2500 for implementing a combined reference signal configuration at a UE according to some aspects. As described below, some or all illustrated features may be omitted in a particular implementation within the scope of the present disclosure, and some illustrated features may not be required for implementation of all examples. In some examples, the method may be performed by the UE 2200, as described above and illustrated in FIG. 22, by a processor or processing system, or by any suitable means for carrying out the described functions.

At block 2502, the UE may receive a combined reference signal configuration including two or more reference signal configurations, where each reference signal configuration of the two or more reference signal configurations is associated with one or more beam identifiers (IDs) in a respective communication direction. The two or more reference signal configurations include a first reference signal configuration without repetition and a second reference signal configuration with repetition. In this example, the first reference signal configuration and the second reference signal configuration are in a same communication direction (e.g., downlink) and the combined reference signal configuration indicates a time gap between the first reference signal configuration and the second reference signal configuration. In some examples, the UE may transmit a request for the combined reference signal configuration. For example, the communication and processing circuitry 2242, together with the beam manager circuitry 2244, transceiver 2210 and antenna array(s) 2230, shown and described above in connection with FIG. 22 may provide a means to receive the combined reference signal configuration.

At block 2504, the UE may receive a first reference signal associated with the first reference signal configuration at a first antenna panel on the UE. For example, the communication and processing circuitry 2442, together with the beam manager circuitry 2444, the transceiver 2410, and the antenna panel(s) 2330 (e.g., using the phase-shifter 2216) may provide the means to receive the first reference signal.

At block 2506, the UE may enable a second antenna panel on the UE during the time gap. For example, the beam manager circuitry 2444, together with the antenna panel(s) may provide a means to enable a second antenna panel.

At block 2508, the UE may receive a second reference signal associated with the second reference signal configuration at the first antenna panel and the second antenna panel. For example, the communication and processing circuitry 2442, together with the beam manager circuitry 2444, the transceiver 2410, and the antenna panel(s) 2330 (e.g., using the phase-shifter 2216) may provide the means to receive the second reference signal.

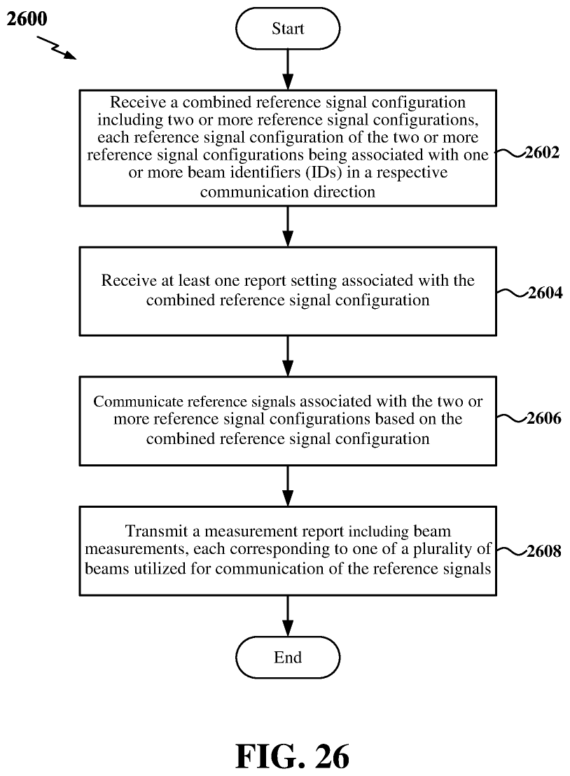

FIG. 26 is a flow chart of another exemplary process 2600 for implementing a combined reference signal configuration at a UE according to some aspects. As described below, some or all illustrated features may be omitted in a particular implementation within the scope of the present disclosure, and some illustrated features may not be required for implementation of all examples. In some examples, the method may be performed by the UE 2200, as described above and illustrated in FIG. 22, by a processor or processing system, or by any suitable means for carrying out the described functions.

At block 2602, the UE may receive a combined reference signal configuration including two or more reference signal configurations, where each reference signal configuration of the two or more reference signal configurations is associated with one or more beam identifiers (IDs) in a respective communication direction. In some examples, the UE may transmit a request for the combined reference signal configuration. For example, the communication and processing circuitry 2242, together with the beam manager circuitry 2244, transceiver 2210 and antenna array(s) 2230, shown and described above in connection with FIG. 22 may provide a means to receive the combined reference signal configuration.

At block 2604, the UE may receive at least one report setting associated with the combined reference signal configuration. In some examples, the UE may receive a single report setting for the combined reference signal configuration. In other examples, the UE may receive a respective report setting for each of the reference signal configurations of the combined reference signal configuration. For example, the communication and processing circuitry 2242, together with the beam manager circuitry 2244, transceiver 2210 and antenna array(s) 2230, shown and described above in connection with FIG. 22 may provide a means to receive the at least one report setting.

At block 2606, the UE may communicate reference signals associated with the two or more reference signal configurations based on the combined reference signal configuration. For example, the communication and processing circuitry 2242, together with the beam manager circuitry 2244, transceiver 2210 and antenna array(s) 2230 (e.g., using the phase-shifter 2216), shown and described above in connection with FIG. 22 may provide a means to communicate the reference signals.

At block 2608, the UE may transmit a measurement report including beam measurements, each corresponding to one of a plurality of beams utilized for communication of the reference signals. The measurement report includes a format based on the at least one report setting. In some examples, the UE may transmit the measurement report at a time based on the communication direction of a last communicated reference signal of the reference signals. For example, the communication and processing circuitry 2242, together with the beam manager circuitry 2244, transceiver 2210 and antenna array(s) 2230, shown and described above in connection with FIG. 22 may provide a means to transmit the measurement report.

In some examples, the beam measurements may include absolute values. In some examples, the beam measurements included in the measurement report (e.g., based on the report setting(s)) may include at least one of first beam measurements associated with a first reference signal configuration without repetition or second beam measurements associated with a second reference signal configuration with repetition. In examples in which there is more than one report setting associated with the combined reference signal configuration, the UE may further divide the beam measurements into the more than one report setting and include a report setting indicator for each of the beam measurements in the measurement report.

In some examples, the combined reference signal configuration includes a plurality of reference signal resources on which the reference signals are communicated. In this example, the beam measurements can include a respective beam measurement for each of the plurality of reference signal resources. As another example, the beam measurements can include an average beam measurement for a set of reference signal resources of the plurality of reference signal resources associated with a same beam of the plurality of beams. As another example, the beam measurements can include a maximum (or highest) beam measurement for the set of reference signal resources.

In some examples, the reference signals are grouped into one or more reference signal groups. In this example, the beam measurements include an absolute value for a maximum beam measurement in each of the one or more groups and respective differential values for remaining beam measurements in each of the one or more groups. In some examples, the reference signals are grouped into the one or more reference signal groups based on a network entity or a QCL source (e.g., SSB beam) associated with each of the reference signals.

In one configuration, the UE 2200 includes means for receiving a combined reference signal configuration including two or more reference signal configurations, each reference signal configuration of the two or more reference signal configurations being associated with one or more beam identifiers (IDs) in a respective communication direction. In addition, the UE 2200 includes means for communicating reference signals associated with the two or more reference signal configurations based on the combined reference signal configuration. In one aspect, the aforementioned means may be the processor 2204 shown in FIG. 22 configured to perform the functions recited by the aforementioned means. In another aspect, the aforementioned means may be a circuit or any apparatus configured to perform the functions recited by the aforementioned means.

Of course, in the above examples, the circuitry included in the processor 2204 is merely provided as an example, and other means for carrying out the described functions may be included within various aspects of the present disclosure, including but not limited to the instructions stored in the computer-readable storage medium 2206, or any other suitable apparatus or means described in any one of the FIGS. 1, 2, 4, 5, 7A, 7B, 9, 12A, 12B, 13-17A, 21, and/or 22 and utilizing, for example, the processes and/or algorithms described herein in relation to FIGS. 23-26.

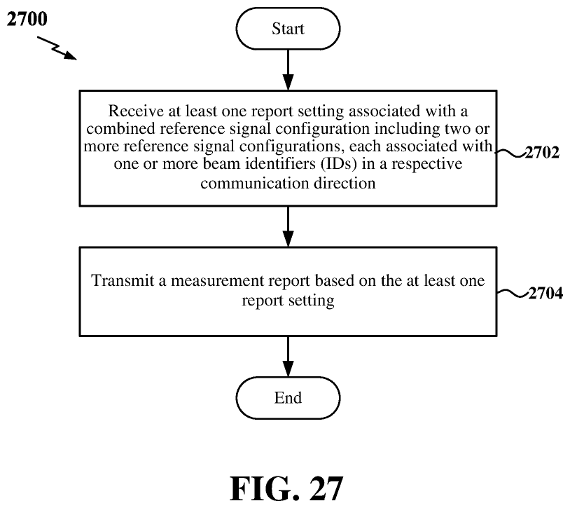

FIG. 27 is a flow chart of an exemplary process 2700 for generating and transmitting a measurement report based on a combined reference signal configuration according to some aspects. As described below, some or all illustrated features may be omitted in a particular implementation within the scope of the present disclosure, and some illustrated features may not be required for implementation of all examples. In some examples, the method may be performed by the UE 2200, as described above and illustrated in FIG. 22, by a processor or processing system, or by any suitable means for carrying out the described functions.

At block 2702, the UE may receive at least one report setting associated with a combined reference signal configuration including two or more reference signal configurations. Each reference signal configuration of the two or more reference signal configurations is associated with one or more beam identifiers (IDs) in a respective communication direction. For example, the communication and processing circuitry 2242, together with the beam manager circuitry 2244, transceiver 2210 and antenna array(s) 2230, shown and described above in connection with FIG. 22 may provide a means to receive the at least one report setting.

At block 2704, the UE may transmit a measurement report based on the at least one report setting. The measurement report includes beam measurements, each of the beam measurements corresponding to one of a plurality of beams utilized for communication of reference signals based on the combined reference signal configuration. For example, the communication and processing circuitry 2242, together with the beam manager circuitry 2244, transceiver 2210 and antenna array(s) 2230, shown and described above in connection with FIG. 22 may provide a means to transmit the measurement report.

In one configuration, the UE 2200 includes means for receiving at least one report setting associated with a combined reference signal configuration including two or more reference signal configurations, each reference signal configuration of the two or more reference signal configurations being associated with one or more beam identifiers (IDs) in a respective communication direction. In addition, the UE 2200 includes means for transmitting a measurement report based on the at least one report setting, the measurement report including beam measurements, each of the beam measurements corresponding to one of a plurality of beams utilized for communication of reference signals based on the combined reference signal configuration. In one aspect, the aforementioned means may be the processor 2204 shown in FIG. 22 configured to perform the functions recited by the aforementioned means. In another aspect, the aforementioned means may be a circuit or any apparatus configured to perform the functions recited by the aforementioned means.

Of course, in the above examples, the circuitry included in the processor 2204 is merely provided as an example, and other means for carrying out the described functions may be included within various aspects of the present disclosure, including but not limited to the instructions stored in the computer-readable storage medium 2206, or any other suitable apparatus or means described in any one of the FIGS. 1, 2, 4, 5, 7A, 7B, 9, 12A, 12B, 13-17A, 21, and/or 22, and utilizing, for example, the processes and/or algorithms described herein in relation to FIG. 27.

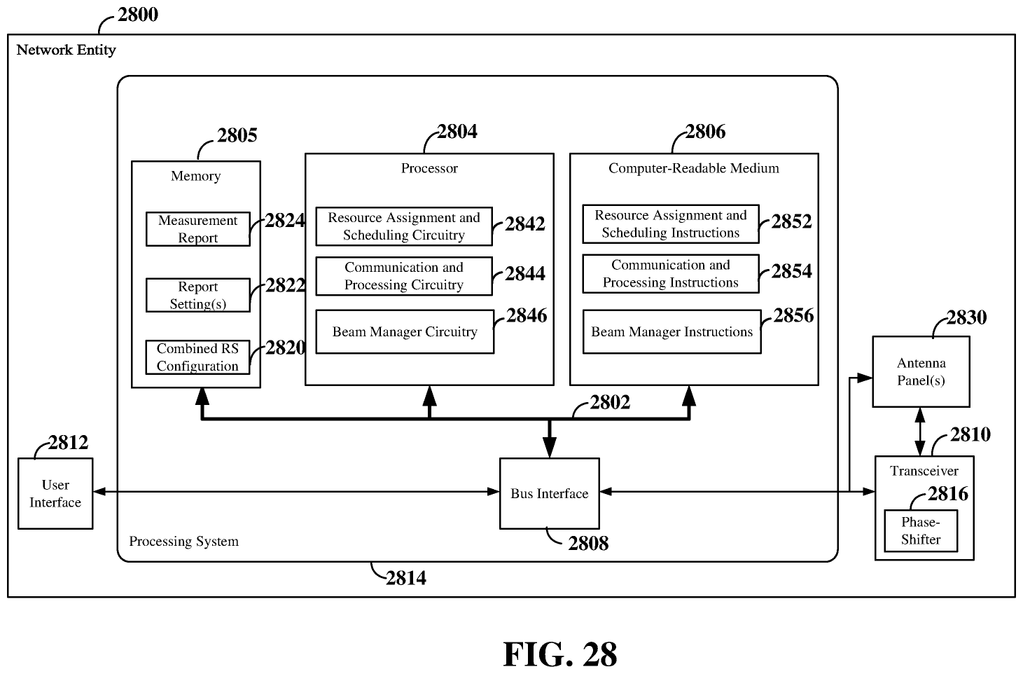

FIG. 28 is a block diagram illustrating an example of a hardware implementation for an exemplary network entity 2800 employing a processing system 2814. For example, the network entity 2800 may correspond to any of the base stations (e.g., gNBs) or other scheduling entities illustrated in any one or more of FIGS. 1, 3, 5, 7A, 7B, 9, 12A, 12B, 13-17A, and/or 21. The network entity 2800 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

In accordance with various aspects of the disclosure, an element, or any portion of an element, or any combination of elements may be implemented with a processing system 2814 that includes one or more processors 2804. The processing system 2814 may be substantially the same as the processing system 1128 illustrated in FIG. 11, including a bus interface 2808, a bus 2802, memory 2805, a processor 2804, and a computer-readable medium 2806. In some examples, the memory 2805 may store one or more of a combined reference signal (RS) configuration 2820, one or more report setting(s) 2822, and/or a measurement report 2824 for use by the processor 2804 in managing one or more beam refinement procedures.

Furthermore, the network entity 2800 may include an optional user interface 2812 and a transceiver 2810 substantially similar to those described above in FIG. 22. In some examples, the transceiver 2810 may include a phase-shifter 2816 for digital and/or analog beamforming via one or more antenna array(s) 2830. The processor 2804, as utilized in a network entity 2800, may be used to implement any one or more of the processes described below.

In some aspects of the disclosure, the processor 2804 may include circuitry configured for various functions. For example, the processor 2804 may include resource assignment and scheduling circuitry 2842, configured to generate, schedule, and modify a resource assignment or grant of time—frequency resources (e.g., a set of one or more resource elements). For example, the resource assignment and scheduling circuitry 2842 may schedule time—frequency resources within a plurality of time division duplex (TDD) and/or frequency division duplex (FDD) subframes, slots, and/or mini-slots to carry user data traffic and/or control information to and/or from multiple UEs.

In some examples, the resource assignment and scheduling circuitry 2842 may be configured to schedule resources for the transmission of a combined reference signal configuration including two or more reference signal configurations. In addition, the resource assignment and scheduling circuitry 2842 may be configured to schedule resources for the transmission of at least one report setting linked with the combined reference signal configuration. Furthermore, the resource assignment and scheduling circuitry 2842 may be configured to schedule resources for the transmission of one or more reference signals in accordance with the combined reference signal configuration. In some examples, the resource assignment and scheduling circuitry 2842 may further be configured to schedule resources for the transmission of a measurement report (e.g., an L1 measurement report) including a plurality of beam measurements in accordance with the at least one report setting. The resource assignment and scheduling circuitry 2842 may further be configured to execute resource assignment and scheduling instructions (software) 2852 stored in the computer-readable medium 2806 to implement one or more of the functions described herein.

The processor 2804 may further include communication and processing circuitry 2844, configured to communicate with a UE for beam refinement. In some examples, the communication and processing circuitry 2844 may include one or more hardware components that provide the physical structure that performs processes related to wireless communication (e.g., signal reception and/or signal transmission) and signal processing (e.g., processing a received signal and/or processing a signal for transmission).

In some examples, the communication and processing circuitry 2844 may be configured to receive and process uplink beamformed signals at a mmWave frequency or a sub-6 GHz frequency via the transceiver 2810 and the antenna panel(s) 2830 (e.g., using the phase-shifter 2816). In addition, the communication and processing circuitry 2844 may be configured to generate and transmit downlink beamformed signals at a mmWave frequency or a sub-6 GHz frequency via the transceiver 2810 and antenna panel(s) 2830 (e.g., using the phase-shifter 2816).

The communication and processing circuitry 2844 may further be configured to transmit a combined reference signal configuration including two or more reference signal configurations to the UE. Each reference signal configuration of the two or more reference signal configurations is associated with one or more beam identifiers (IDs) in a respective communication direction (e.g., uplink or downlink) In addition, the communication and processing circuitry 2844 may be configured to communicate reference signals (e.g., transmit CSI-RSs or receive SRSs) associated with the two or more reference signal configurations based on the combined reference signal configuration. In some examples, the communication and processing circuitry 2844 may further be configured to receive a request for the combined reference signal configuration.

In some examples, the communication and processing circuitry 2844 may further be configured to transmit control information triggering the combined reference signal configuration. In some examples, the communication and processing circuitry 2844 may further be configured to transmit at least one report setting associated with the combined reference signal configuration. In addition, the communication and processing circuitry 2844 may be configured to receive a measurement report having a format based on the at least one report setting. The measurement report may include beam measurements, each corresponding to one of a plurality of beams utilized for communication of the reference signals. The communication and processing circuitry 2844 may further be configured to execute communication and processing instructions (software) 2854 stored in the computer-readable medium 2806 to implement one or more of the functions described herein.

The processor 2804 may further include beam manager circuitry 2846, configured to manage one or more beam refinement procedures. The beam manager circuitry 2846 may correspond, for example, to any of the beam managers of network entities shown in any one or more of FIGS. 1, 2, 4, 5, and/or 7. The beam manager circuitry 2846 may be configured to generate the combined reference signal configuration 2820 for the UE including the two or more reference signal configurations for transmission to the UE via the communication and processing circuitry 2844, the transceiver 2810, and the antenna panel(s) 2830. In addition, the beam manager circuitry 2846 may be configured to generate the report setting(s) 2822 for the UE associated with the combined reference signal configuration 2820 for transmission to the UE via the communication and processing circuitry 2844, the transceiver 2810, and the antenna panel(s) 2830.

In some examples, each reference signal configuration of the two or more reference signal configurations in the combined reference signal configuration 2820 may indicate at least one of a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction. For example, the first communication direction may be a downlink direction and the second communication direction may be an uplink direction. In some examples, the combined reference signal configuration is one of a periodic configuration, a semi-persistent configuration, or an aperiodic configuration.

In some examples, the combined reference signal configuration includes one or more common parameters linked between the two or more reference signal configurations. In some examples, the one or more common parameters are linked between different communication directions of the two or more reference signal configurations. In some examples, the one or more common parameters are linked between a same communication direction of the two or more reference signal configurations. In some examples, the one or more common parameters include a same bandwidth, a same spatial relation, or a same quasi co-location (QCL) relationship.

In some examples, the two or more reference signal configurations include a first reference signal configuration associated with a first beam ID and a first repetition pattern and a second reference signal configuration associated with a second beam ID and a second repetition pattern. In addition, the first reference signal configuration and the second reference signal configuration may be associated with a same communication direction. In some examples, a combination of the first reference signal configuration and the second reference signal configuration in the combined reference signal configuration produces a third reference signal configuration associated with the first beam ID and the second beam ID without repetition. In some examples, the combined reference signal configuration indicates an order of repetitions of the first repetition pattern and the second repetition pattern. In some examples, the order of repetitions indicates that the first repetition pattern and the second repetition pattern are interleaved in time.

In some examples, the two or more reference signal configurations include a first reference signal configuration without repetition and a second reference signal configuration with repetition. In this example, the first reference signal configuration and the second reference signal configuration may be in a same direction and the combined reference signal configuration indicates a time gap between the first reference signal configuration and the second reference signal configuration. In some examples, the two or more reference signal configurations include a first reference signal configuration in a first communication direction and a second reference signal configuration in a second communication direction different than the first communication direction, and the combined reference signal configuration 2820 indicates a time gap between the first reference signal configuration and the second reference signal configuration.

In examples in which the communication and processing circuitry 2844 transmits control information triggering the combined reference signal configuration 2820, the beam manager circuitry 2846 may further be configured to operate together with the communication and processing circuitry 2844 to communicate the reference signals after a delay from the control information. The delay may be based on an initial communication direction of a first reference signal associated with the combined reference signal configuration.

In some examples, the beam manager circuitry 2846 may receive the measurement report 2824 including the beam measurements based on the report setting(s) 2822 associated with the combined reference signal configuration 2820. In some examples, the beam measurements may include absolute values. In some examples, the beam measurements included in the measurement report (e.g., based on the report setting(s) 2822) may include at least one of first beam measurements associated with a first reference signal configuration without repetition or second beam measurements associated with a second reference signal configuration with repetition. In examples in which there is more than one report setting 2822 associated with the combined reference signal configuration 2820, the measurement report may include a report setting indicator for each of the beam measurements in the measurement report.

In some examples, the combined reference signal configuration includes a plurality of reference signal resources on which the reference signals are communicated. In this example, the beam measurements can include a respective beam measurement for each of the plurality of reference signal resources. As another example, the beam measurements can include an average beam measurement for a set of reference signal resources of the plurality of reference signal resources associated with a same beam of the plurality of beams. As another example, the beam measurements can include a maximum (or highest) beam measurement for the set of reference signal resources.

In some examples, the reference signals are grouped into one or more reference signal groups. In this example, the beam measurements include an absolute value for a maximum beam measurement in each of the one or more groups and respective differential values for remaining beam measurements in each of the one or more groups. In some examples, the reference signals are grouped into the one or more reference signal groups based on a network entity or a QCL source (e.g., SSB beam) associated with each of the reference signals.

In some examples, the beam manager circuitry 2846 may be configured to operate together with the communication and processing circuitry 2844 to receive a request for the combined reference signal configuration. In some examples, the beam manager circuitry 2846 may be configured to receive the measurement report at a time based on the communication direction of a last communicated reference signal of the reference signals. The beam manager circuitry 2846 may further be configured to execute beam manager instructions (software) 2856 stored in the computer-readable medium 2806 to implement one or more of the functions described herein

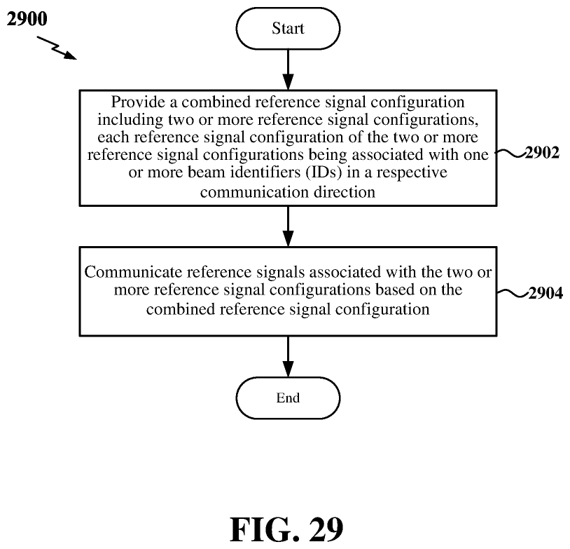

FIG. 29 is a flow chart of an exemplary method for implementing a combined reference signal configuration at a network entity according to some aspects. As described below, some or all illustrated features may be omitted in a particular implementation within the scope of the present disclosure, and some illustrated features may not be required for implementation of all examples. In some examples, the method may be performed by the network entity 2800, as described above and illustrated in FIG. 28, by a processor or processing system, or by any suitable means for carrying out the described functions.

At 2902, the network entity may provide a combined reference signal configuration including two or more reference signal configurations, each reference signal configuration of the two or more reference signal configurations being associated with one or more beam identifiers (IDs) in a respective communication direction. In some examples, the UE may transmit a request for the combined reference signal configuration. For example, the communication and processing circuitry 2844, together with the beam manager circuitry 2846, transceiver 2810 and antenna array(s) 2830, shown and described above in connection with FIG. 28 may provide a means to provide the combined reference signal configuration.

In some examples, each reference signal configuration of the two or more reference signal configurations in the combined reference signal configuration may indicate at least one of a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction. For example, the first communication direction may be a downlink direction and the second communication direction may be an uplink direction. As another example, the first and second communication directions may be sidelink communication directions. In some examples, the combined reference signal configuration is one of a periodic configuration, a semi-persistent configuration, or an aperiodic configuration.

In some examples, the combined reference signal configuration includes one or more common parameters linked between the two or more reference signal configurations. In some examples, the one or more common parameters are linked between different communication directions of the two or more reference signal configurations. In some examples, the one or more common parameters are linked between a same communication direction of the two or more reference signal configurations. In some examples, the one or more common parameters include a same bandwidth, a same spatial relation, or a same quasi co-location (QCL) relationship.

In some examples, the two or more reference signal configurations include a first reference signal configuration associated with a first beam ID and a first repetition pattern and a second reference signal configuration associated with a second beam ID and a second repetition pattern. In addition, the first reference signal configuration and the second reference signal configuration may be associated with a same communication direction. In some examples, a combination of the first reference signal configuration and the second reference signal configuration in the combined reference signal configuration produces a third reference signal configuration associated with the first beam ID and the second beam ID without repetition. In some examples, the combined reference signal configuration indicates an order of repetitions of the first repetition pattern and the second repetition pattern. In some examples, the order of repetitions indicates that the first repetition pattern and the second repetition pattern are interleaved in time.

In some examples, the two or more reference signal configurations include a first reference signal configuration in a first communication direction and a second reference signal configuration in a second communication direction different than the first communication direction, and the combined reference signal configuration indicates a time gap between the first reference signal configuration and the second reference signal configuration.

At 2904, the network entity may communicate reference signals associated with the two or more reference signal configurations based on the combined reference signal configuration. For example, the communication and processing circuitry 2844, together with the beam manager circuitry 2846, transceiver 2810 and antenna array(s) 2830 (e.g., using the phase-shifter 2816), shown and described above in connection with FIG. 28 may provide a means to communicate the reference signals.

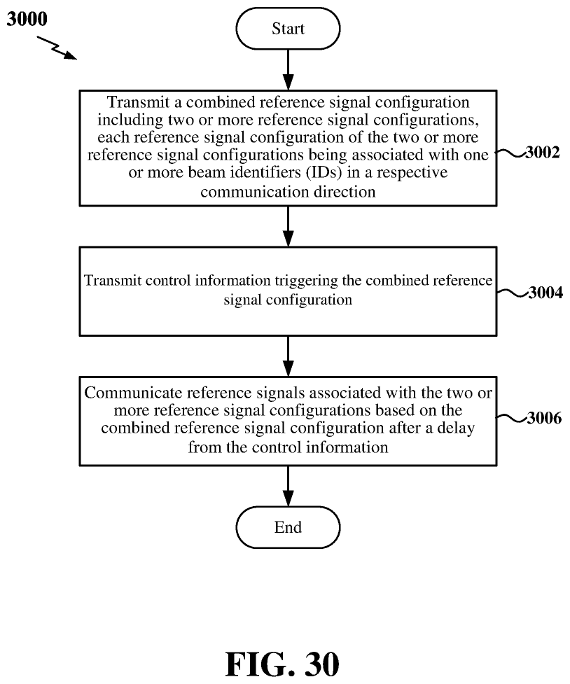

FIG. 30 is a flow chart of another exemplary process 3000 for implementing a combined reference signal configuration at a network entity according to some aspects. As described below, some or all illustrated features may be omitted in a particular implementation within the scope of the present disclosure, and some illustrated features may not be required for implementation of all examples. In some examples, the method may be performed by the network entity 2800, as described above and illustrated in FIG. 28, by a processor or processing system, or by any suitable means for carrying out the described functions.

At block 3002, the network entity may transmit a combined reference signal configuration including two or more reference signal configurations, where each reference signal configuration of the two or more reference signal configurations is associated with one or more beam identifiers (IDs) in a respective communication direction. For example, the communication and processing circuitry 2844, together with the beam manager circuitry 2846, transceiver 2810 and antenna array(s) 2830, shown and described above in connection with FIG. 28 may provide a means to transmit the combined reference signal configuration.

At block 3004, the network entity may transmit control information triggering the combined reference signal configuration. For example, the communication and processing circuitry 2844, together with the beam manager circuitry 2846, transceiver 2810 and antenna array(s) 2830, shown and described above in connection with FIG. 28 may provide a means to transmit the control information.

At block 3006, the network entity may communicate the reference signals associated with the two or more reference signal configurations based on the combined reference signal configuration after a delay from the control information. The delay may be based on an initial communication direction of a first reference signal associated with the combined reference signal configuration. For example, the communication and processing circuitry 2844, together with the beam manager circuitry 2846, transceiver 2810 and antenna array(s) 2830 (e.g., using the phase-shifter), shown and described above in connection with FIG. 28 may provide a means to communicate the reference signals.

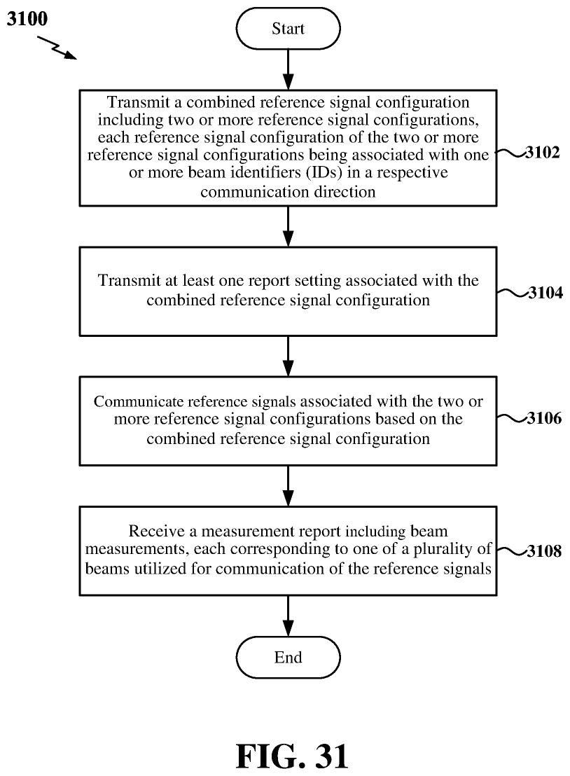

FIG. 31 is a flow chart of another exemplary process 3100 for implementing a combined reference signal configuration at a network entity according to some aspects. As described below, some or all illustrated features may be omitted in a particular implementation within the scope of the present disclosure, and some illustrated features may not be required for implementation of all examples. In some examples, the method may be performed by the network entity 2800, as described above and illustrated in FIG. 28, by a processor or processing system, or by any suitable means for carrying out the described functions.

At block 3102, the network entity may transmit a combined reference signal configuration including two or more reference signal configurations, where each reference signal configuration of the two or more reference signal configurations is associated with one or more beam identifiers (IDs) in a respective communication direction. In some examples, the network entity may receive a request for the combined reference signal configuration. For example, the communication and processing circuitry 2844, together with the beam manager circuitry 2846, transceiver 2810 and antenna array(s) 2830, shown and described above in connection with FIG. 28 may provide a means to receive the combined reference signal configuration.

At block 3104, the network entity may transmit at least one report setting associated with the combined reference signal configuration. In some examples, the network entity may transmit a single report setting for the combined reference signal configuration. In other examples, the network entity may transmit a respective report setting for each of the reference signal configurations of the combined reference signal configuration. For example, the communication and processing circuitry 2844, together with the beam manager circuitry 2846, transceiver 2810 and antenna array(s) 2830, shown and described above in connection with FIG. 28 may provide a means to transmit the at least one report setting.

At block 3106, the network entity may communicate reference signals associated with the two or more reference signal configurations based on the combined reference signal configuration. For example, the communication and processing circuitry 2844, together with the beam manager circuitry 2846, transceiver 2810 and antenna array(s) 2830 (e.g., using the phase-shifter 2816), shown and described above in connection with FIG. 28 may provide a means to communicate the reference signals.

At block 3108, the network entity may receive a measurement report including beam measurements, each corresponding to one of a plurality of beams utilized for communication of the reference signals. The measurement report includes a format based on the at least one report setting. In some examples, the network entity may receive the measurement report at a time based on the communication direction of a last communicated reference signal of the reference signals. For example, the communication and processing circuitry 2844, together with the beam manager circuitry 2846, transceiver 2810 and antenna array(s) 2830, shown and described above in connection with FIG. 28 may provide a means to receive the measurement report.

In some examples, the beam measurements may include absolute values. In some examples, the beam measurements included in the measurement report (e.g., based on the report setting(s)) may include at least one of first beam measurements associated with a first reference signal configuration without repetition or second beam measurements associated with a second reference signal configuration with repetition. In examples in which there is more than report setting associated with the combined reference signal configuration, the beam measurements may be divided into the more than one report setting and the measurement report may include a report setting indicator for each of the beam measurements.

In some examples, the combined reference signal configuration includes a plurality of reference signal resources on which the reference signals are communicated. In this example, the beam measurements can include a respective beam measurement for each of the plurality of reference signal resources. As another example, the beam measurements can include an average beam measurement for a set of reference signal resources of the plurality of reference signal resources associated with a same beam of the plurality of beams. As another example, the beam measurements can include a maximum (or highest) beam measurement for the set of reference signal resources.

In some examples, the reference signals are grouped into one or more reference signal groups. In this example, the beam measurements include an absolute value for a maximum beam measurement in each of the one or more groups and respective differential values for remaining beam measurements in each of the one or more groups. In some examples, the reference signals are grouped into the one or more reference signal groups based on a network entity or a QCL source (e.g., SSB beam) associated with each of the reference signals.

In one configuration, the network entity 2800 includes means for transmitting a combined reference signal configuration including two or more reference signal configurations, each reference signal configuration of the two or more reference signal configurations being associated with one or more beam identifiers (IDs) in a respective communication direction. In addition, the network entity 2800 includes means for communicating reference signals associated with the two or more reference signal configurations based on the combined reference signal configuration. In one aspect, the aforementioned means may be the processor 2804 shown in FIG. 28 configured to perform the functions recited by the aforementioned means. In another aspect, the aforementioned means may be a circuit or any apparatus configured to perform the functions recited by the aforementioned means.

Of course, in the above examples, the circuitry included in the processor 2804 is merely provided as an example, and other means for carrying out the described functions may be included within various aspects of the present disclosure, including but not limited to the instructions stored in the computer-readable storage medium 2806, or any other suitable apparatus or means described in any one of the FIGS. 1, 2, 4, 5, 7A, 7B, 9, 12A, 12B, 13-17A, 21, and/or 28 and utilizing, for example, the processes and/or algorithms described herein in relation to FIGS. 29-31.

In 5G NR networks, a base station may be an aggregated base station, in which the radio protocol stack is logically integrated within a single RAN entity, or a disaggregated base station (e.g., a disaggregated RAN entity), in which the radio protocol stack is logically split between a central unit (CU), one or more distributed units (DUs), and one or more radio units (RUs). In some examples, the RU may be co-located with the DU. The CU may host, for example, the radio resource control (RRC), service data adaptation protocol (SDAP), and packet data convergence protocol (PDCP) layers that control the operation of one or more DUs. The DU may host, for example, the radio link control (RLC) and medium access control (MAC) layers. The RU may host, for example, the physical (PHY) layer. The CU may be implemented within an edge node, which may be referred to as a donor node, while the one or more DUs and RUs may be co-located with the CU and/or distributed throughout multiple nodes that may be physically separated from one another.

In some examples, the network entity 2800 shown and described above in connection with FIG. 28 may be a disaggregated base station. For example, the network entity 2800 shown in FIG. 28 may include the CU and optionally one or more DUs/RUs of the disaggregated base station. Other DUs/RUs associated with the network entity 2800 may be distributed throughout the network. In some examples, the DUs/RUs may correspond to TRPs associated with the network entity. In some examples, the CU and/or DU/RU of the disaggregated base station (e.g., within the network entity 2800) may generate and provide a combined reference signal configuration and one or more report settings associated with the combined reference signal configuration to a UE and receive a measurement report from a UE based on the one or more report settings.

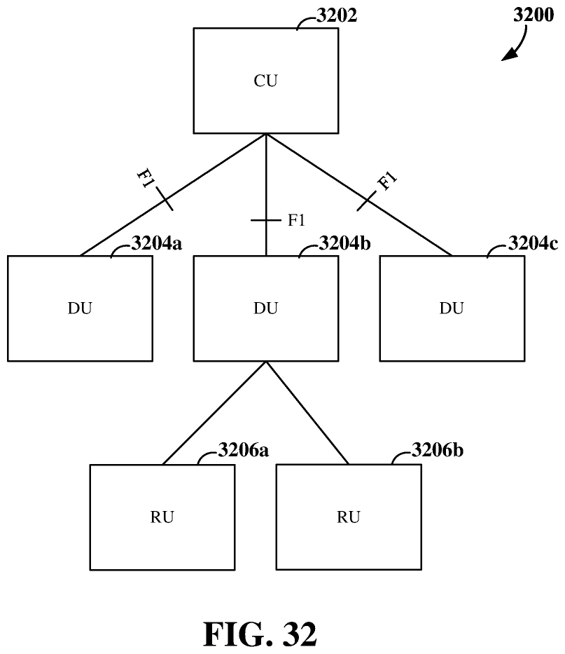

FIG. 32 is a diagram providing a high-level illustration of one example of a configuration of a disaggregated base station 3200 according to some aspects. The disaggregated base station 3200 includes a CU 3202, one or more DUs (three of which, 3204a, 3204b, 3204c, are shown for convenience), and one or more RUs (two of which 3206a and 3206b are shown for convenience). Each DU 3204a, 3204b, and 3204c supports the MAC and RLC layers of the radio protocol stack. Each RU 3206a and 3206b supports the PHY layer of the radio protocol stack. The CU 3202 supports the higher layers, such as the PDCP and RRC layers. One of the DUs (e.g., DU 3204a) may be co-located with the CU 3202, while the other DUs 3204b and 3204c may be distributed throughout a network. In addition, one of the RUs (e.g., RU 3206a) may be co-located with the corresponding DU 3204b, while the other RUs (e.g., RU 3206b) may be distributed throughout a network. The CU 3202 and DUs 3204a, 3204b, and 3204c are logically connected via the F1 interface, which utilizes the F1 Application Protocol (F1-AP) for communication of information between the CU 3202 and each of the DUs 3204a, 3204b, and 3204c and for establishing generic tunneling protocol (GTP) tunnels between the DU and CU for each radio bearer.

The following provides an overview of examples of the present disclosure.

Example 1: A method for wireless communication at a user equipment (UE), the method comprising: receiving a combined reference signal configuration including two or more reference signal configurations, each reference signal configuration of the two or more reference signal configurations being associated with one or more beam identifiers (IDs) in a respective communication direction; and communicating reference signals associated with the two or more reference signal configurations based on the combined reference signal configuration.

Example 2: The method of example 1, wherein each reference signal configuration of the two or more reference signal configurations indicates one of: a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction.

Example 3: The method of example 2, wherein the first communication direction comprises a downlink direction and the second communication direction comprises an uplink direction.

Example 4: The method of example 2, wherein the first communication direction and the second communication direction are sidelink communication directions.

Example 5: The method of any of examples 1 through 4, wherein the combined reference signal configuration is one of a periodic configuration, a semi-persistent configuration, or an aperiodic configuration.

Example 6: The method of any of examples 1 through 5, wherein the combined reference signal configuration comprises one or more common parameters linked between the two or more reference signal configurations.

Example 7: The method of example 6, wherein the one or more common parameters are linked between different communication directions of the two or more reference signal configurations.

Example 8: The method of example 6, wherein the one or more common parameters are linked between a same communication direction of the two or more reference signal configurations.

Example 9: The method of example 6, wherein the one or more common parameters comprise a same bandwidth, a same spatial relation, or a same quasi co-location (QCL) relationship.

Example 10: The method of any of examples 1 through 9, further comprising: transmitting a request for the combined reference signal configuration.

Example 11: The method of any of examples 1 through 10, wherein: the two or more reference signal configurations comprise a first reference signal configuration associated with a first beam ID and a first repetition pattern and a second reference signal configuration associated with a second beam ID and a second repetition pattern, and the first reference signal configuration and the second reference signal configuration are associated with a same communication direction.

Example 12: The method of example 11, wherein a combination of the first reference signal configuration and the second reference signal configuration in the combined reference signal configuration produces a third reference signal configuration associated with the first beam ID and the second beam ID without repetition.

Example 13: The method of example 11 or 12, wherein the combined reference signal configuration indicates an order of repetitions of the first repetition pattern and the second repetition pattern.

Example 14: The method of example 13, wherein the order of repetitions indicates that the first repetition pattern and the second repetition pattern are interleaved in time.

Example 15: The method of any of examples 1 through 10, wherein: the two or more reference signal configurations comprise a first reference signal configuration without repetition and a second reference signal configuration with repetition, the first reference signal configuration and the second reference signal configuration are in a same communication direction, and the combined reference signal configuration indicates a time gap between the first reference signal configuration and the second reference signal configuration.

Example 16: The method of example 15, further comprising: receiving a first reference signal associated with the first reference signal configuration at a first antenna panel on the UE; enabling a second antenna panel on the UE during the time gap; and receiving a second reference signal associated with the second reference signal configuration at the first antenna panel and the second antenna panel.

Example 17: The method of any of examples 1 through 10, wherein: the two or more reference signal configurations comprise a first reference signal configuration in a first communication direction and a second reference signal configuration in a second communication direction different than the first communication direction, and the combined reference signal configuration indicates a time gap between the first reference signal configuration and the second reference signal configuration.

Example 18: The method of any of examples 1 through 10, wherein the communicating the reference signals comprises: receiving control information triggering the combined reference signal configuration; and communicating the reference signals after a delay from the control information, wherein the delay is based on an initial communication direction of a first reference signal associated with the combined reference signal configuration.

Example 19: The method of any of examples 1 through 10, further comprising: receiving at least one report setting associated with the combined reference signal configuration; and transmitting a measurement report comprising beam measurements, each corresponding to one of a plurality of beams utilized for communication of the reference signals, wherein the measurement report comprises a format based on the at least one report setting.

Example 20: The method of example 19, wherein the at least one report setting comprises more than one report setting for the combined reference signal configuration, and further comprising: dividing the beam measurements into the more than one report setting; and including a report setting indicator for each of the beam measurements in the measurement report.

Example 21: The method of example 19 or 20, wherein the beam measurements comprise at least one of first beam measurements associated with a first reference signal configuration without repetition or second beam measurements associated with a second reference signal configuration with repetition.

Example 22: The method of any of examples 19 through 21, wherein: the combined reference signal configuration comprises a plurality of reference signal resources on which the reference signals are communicated, and the beam measurements comprise a respective beam measurement for each of the plurality of reference signal resources.

Example 23: The method of any of examples 19 through 21, wherein: the combined reference signal configuration comprises a plurality of reference signal resources on which the reference signals are communicated, and the beam measurements comprise an average beam measurement for a set of reference signal resources of the plurality of reference signal resources, the set of reference signal resources being associated with a same beam of the plurality of beams.

Example 24: The method of any of examples 19 through 21, wherein: the combined reference signal configuration comprises a plurality of reference signal resources on which the reference signals are communicated, and the beam measurements comprise a maximum beam measurement for a set of reference signal resources of the plurality of reference signal resources, the set of reference signal resources being associated with a same beam of the plurality of beams.

Example 25: The method of any of examples 19 through 21, wherein each of the beam measurements comprises a respective absolute value.

Example 26: The method of any of examples 19 through 21, wherein: the reference signals are grouped into one or more reference signal groups, and the beam measurements comprise an absolute value for a maximum beam measurement in each of the one or more groups and respective differential values for remaining beam measurements in each of the one or more groups.

Example 27: The method of example 26, wherein the reference signals are grouped into the one or more reference signal groups based on a network entity or a quasi co-location (QCL) source associated with each of the reference signals.

Example 28: The method of any of examples 19 through 27, wherein the transmitting the measurement report comprises: transmitting the measurement report at a time based on the communication direction of a last communicated reference signal of the reference signals.

Example 29: A method for wireless communication at a user equipment (UE), comprising: receiving at least one report setting associated with a combined reference signal configuration including two or more reference signal configurations, each reference signal configuration of the two or more reference signal configurations being associated with one or more beam identifiers (IDs) in a respective communication direction; and transmitting a measurement report based on the at least one report setting, the measurement report comprising beam measurements, each of the beam measurements corresponding to one of a plurality of beams utilized for communication of reference signals based on the combined reference signal configuration.

Example 30: A UE comprising a memory, and a processor coupled to the memory, the processor being configured to perform a method of any one of examples 1 through 28 or 29.

Example 31: A UE comprising means for performing a method of any one of examples 1 through 28 or 29.

Example 32: A non-transitory computer-readable medium having stored therein instructions executable by one or more processors of a user equipment (UE) to perform a method of any of examples 1 through 28 or 29.

Example 33: A method for wireless communication at a network entity, comprising: providing a combined reference signal configuration including two or more reference signal configurations, each reference signal configuration of the two or more reference signal configurations being associated with one or more beam identifiers (IDs) in a respective communication direction; and communicating reference signals associated with the two or more reference signal configurations based on the combined reference signal configuration.

Example 34: The method of example 33, wherein each reference signal configuration of the two or more reference signal configurations indicates one of: a first repetition pattern of a first beam ID in a first communication direction, a second repetition pattern of a second beam ID in a second communication direction different than the first communication direction, a first plurality of beam IDs without repetition in the first communication direction, or a second plurality of beam IDs without repetition in the second communication direction.

Example 35: The method of example 33 or 34, wherein the combined reference signal configuration comprises one or more common parameters linked between the two or more reference signal configurations.

Example 36: The method of any of examples 33 through 35, further comprising: receiving a request for the combined reference signal configuration.

Example 37: The method of any of examples 33 through 36, wherein: the two or more reference signal configurations comprise a first reference signal configuration associated with a first beam ID and a first repetition pattern and a second reference signal configuration associated with a second beam ID and a second repetition pattern, and the first reference signal configuration and the second reference signal configuration are associated with a same communication direction.

Example 38: The method of example 37, wherein a combination of the first reference signal configuration and the second reference signal configuration in the combined reference signal configuration produces a third reference signal configuration associated with the first beam ID and the second beam ID without repetition.

Example 39: The method of example 37 or 38, wherein the combined reference signal configuration indicates an order of repetitions of the first repetition pattern and the second repetition pattern.

Example 40: The method of example 39, wherein the order of repetitions indicates that the first repetition pattern and the second repetition pattern are interleaved in time.

Example 41: The method of any of examples 33 through 36, wherein: the two or more reference signal configurations comprise a first reference signal configuration without repetition and a second reference signal configuration with repetition, the first reference signal configuration and the second reference signal configuration are in a same communication direction, and the combined reference signal configuration indicates a time gap between the first reference signal configuration and the second reference signal configuration.

Example 42: The method of any of examples 33 through 36, wherein: the two or more reference signal configurations comprise a first reference signal configuration in a first communication direction and a second reference signal configuration in a second communication direction different than the first communication direction, and the combined reference signal configuration indicates a time gap between the first reference signal configuration and the second reference signal configuration.

Example 43: The method of any of examples 33 through 36, wherein the communicating the reference signals comprises: receiving control information triggering the combined reference signal configuration; and communicating the reference signals after a delay from the control information, wherein the delay is based on an initial communication direction of a first reference signal associated with the combined reference signal configuration.

Example 44: The method of any of examples 33 through 36, further comprising: providing at least one report setting associated with the combined reference signal configuration; and obtaining a measurement report comprising beam measurements, each corresponding to one of a plurality of beams utilized for communication of the reference signals, wherein the measurement report comprises a format based on the at least one report setting.

Example 45: The method of example 44, wherein the beam measurements comprise at least one of first beam measurements associated with a first reference signal configuration without repetition or second beam measurements associated with a second reference signal configuration with repetition.

Example 46: The method of example 44 or 45, wherein: the combined reference signal configuration comprises a plurality of reference signal resources on which the reference signals are communicated, and the beam measurements comprise a respective beam measurement for each of the plurality of reference signal resources.

Example 47: The method of examples 44 or 45, wherein: the combined reference signal configuration comprises a plurality of reference signal resources on which the reference signals are communicated, and the beam measurements comprise an average beam measurement for a set of reference signal resources of the plurality of reference signal resources, the set of reference signal resources being associated with a same beam of the plurality of beams.

Example 48: The method of example 44 or 45, wherein: the combined reference signal configuration comprises a plurality of reference signal resources on which the reference signals are communicated, and the beam measurements comprise a maximum beam measurement for a set of reference signal resources of the plurality of reference signal resources, the set of reference signal resources being associated with a same beam of the plurality of beams.

Example 49: The method of example 44 or 45, wherein each of the beam measurements comprises a respective absolute value.

Example 50: The method of example 44 or 45, wherein: the reference signals are grouped into one or more reference signal groups, and the beam measurements comprise an absolute value for a maximum beam measurement in each of the one or more groups and respective differential values for remaining beam measurements in each of the one or more groups.

Example 51: A network entity comprising a memory, and a processor coupled to the memory, the processor being configured to perform a method of any one of examples 33 through 50.

Example 52: A network entity comprising means for performing a method of any one of examples 33 through 50.

Example 53: A non-transitory computer-readable medium having stored therein instructions executable by one or more processors of a network entity to perform a method of any of examples 33 through 50.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-32 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, 7, 9, 10, 12-17A, 21, 22, 28 and/or 32 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) configured for wireless communication, comprising:
a memory; and
a processor coupled to the memory, the processor configured to:
receive a combined reference signal configuration including two or more reference signal configurations, each reference signal configuration of the two or more reference signal configurations being associated with one or more beam identifiers (IDs) in a respective communication direction; and
communicate reference signals associated with the two or more reference signal configurations based on the combined reference signal configuration.

2. The UE of claim 1, wherein each reference signal configuration of the two or more reference signal configurations indicates one of:
a first repetition pattern of a first beam ID in a first communication direction,
a second repetition pattern of a second beam ID in a second communication direction different than the first communication direction,
a first plurality of beam IDs without repetition in the first communication direction, or
a second plurality of beam IDs without repetition in the second communication direction.

3. The UE of claim 2, wherein:
the first communication direction comprises a downlink direction and the second communication direction comprises an uplink direction, or
the first communication direction and the second communication direction are sidelink communication directions.

4. The UE of claim 1, wherein the combined reference signal configuration is one of a periodic configuration, a semi-persistent configuration, or an aperiodic configuration.

5. The UE of claim 1, wherein the combined reference signal configuration comprises one or more common parameters linked between the two or more reference signal configurations, the common parameter comprising a same bandwidth, a same spatial relation, or a same quasi co-location (QCL) relationship.

6. The UE of claim 5, wherein the one or more common parameters are linked between different communication directions of the two or more reference signal configurations or between a same communication direction of the two or more reference signal configurations.

7. The UE of claim 1, wherein the processor is further configured to:
transmit a request for the combined reference signal configuration.

8. The UE of claim 1, wherein:
the two or more reference signal configurations comprise a first reference signal configuration associated with a first beam ID and a first repetition pattern and a second reference signal configuration associated with a second beam ID and a second repetition pattern, and
the first reference signal configuration and the second reference signal configuration are associated with a same communication direction.

9. The UE of claim 8, wherein a combination of the first reference signal configuration and the second reference signal configuration in the combined reference signal configuration produces a third reference signal configuration associated with the first beam ID and the second beam ID without repetition.

10. The UE of claim 8, wherein the combined reference signal configuration indicates an order of repetitions of the first repetition pattern and the second repetition pattern.

11. The UE of claim 10, wherein the order of repetitions indicates that the first repetition pattern and the second repetition pattern are interleaved in time.

12. The UE of claim 1, wherein:
the two or more reference signal configurations comprise a first reference signal configuration without repetition and a second reference signal configuration with repetition,
the first reference signal configuration and the second reference signal configuration are in a same communication direction, and
the combined reference signal configuration indicates a time gap between the first reference signal configuration and the second reference signal configuration.

13. The UE of claim 1, wherein:
the two or more reference signal configurations comprise a first reference signal configuration in a first communication direction and a second reference signal configuration in a second communication direction different than the first communication direction, and
the combined reference signal configuration indicates a time gap between the first reference signal configuration and the second reference signal configuration.

14. The UE of claim 1, further comprising:
a transceiver, wherein the processor is further configured to:
receive control information triggering the combined reference signal configuration via the transceiver; and
communicate the reference signals after a delay from the control information via the transceiver, wherein the delay is based on an initial communication direction of a first reference signal associated with the combined reference signal configuration.

15. The UE of claim 1, wherein the processor is further configured to:
receive at least one report setting associated with the combined reference signal configuration; and
transmit a measurement report comprising beam measurements, each corresponding to one of a plurality of beams utilized for communication of the reference signals, wherein the measurement report comprises a format based on the at least one report setting.

16. The UE of claim 15, wherein the at least one report setting comprises more than one report setting for the combined reference signal configuration, and wherein the processor is further configured to:
divide the beam measurements into the more than one report setting; and
include a report setting indicator for each of the beam measurements in the measurement report.

17. The UE of claim 15, wherein the beam measurements comprise at least one of first beam measurements associated with a first reference signal configuration without repetition or second beam measurements associated with a second reference signal configuration with repetition.

18. The UE of claim 15, wherein:
the combined reference signal configuration comprises a plurality of reference signal resources on which the reference signals are communicated, and
the beam measurements comprise an average beam measurement or a maximum beam measurement for a set of reference signal resources of the plurality of reference signal resources, the set of reference signal resources being associated with a same beam of the plurality of beams.

19. The UE of claim 15, wherein:
the reference signals are grouped into one or more reference signal groups,
the beam measurements comprise an absolute value for a maximum beam measurement in each of the one or more groups and respective differential values for remaining beam measurements in each of the one or more groups, and
the reference signals are grouped into the one or more reference signal groups based on a network entity or a quasi co-location (QCL) source associated with each of the reference signals.

20. The UE of claim 15, wherein the processor is further configured to:
transmit the measurement report at a time based on the communication direction of a last communicated reference signal of the reference signals.

21. A method for wireless communication at a user equipment (UE), the method comprising:
receiving a combined reference signal configuration including two or more reference signal configurations, each reference signal configuration of the two or more reference signal configurations being associated with one or more beam identifiers (IDs) in a respective communication direction; and
communicating reference signals associated with the two or more reference signal configurations based on the combined reference signal configuration.

22. The method of claim 21, wherein each reference signal configuration of the two or more reference signal configurations indicates one of:
a first repetition pattern of a first beam ID in a first communication direction,
a second repetition pattern of a second beam ID in a second communication direction different than the first communication direction,
a first plurality of beam IDs without repetition in the first communication direction, or
a second plurality of beam IDs without repetition in the second communication direction.

23. The method of claim 21, wherein the combined reference signal configuration comprises one or more common parameters linked between the two or more reference signal configurations.

24. The method of claim 21, wherein:
the two or more reference signal configurations comprise a first reference signal configuration associated with a first beam ID and a first repetition pattern and a second reference signal configuration associated with a second beam ID and a second repetition pattern,
the first reference signal configuration and the second reference signal configuration are associated with a same communication direction, and
a combination of the first reference signal configuration and the second reference signal configuration in the combined reference signal configuration produces a third reference signal configuration associated with the first beam ID and the second beam ID without repetition.

25. The method of claim 24, wherein the combined reference signal configuration indicates an order of repetitions of the first repetition pattern and the second repetition pattern.

26. The method of claim 21, wherein:
the two or more reference signal configurations comprise a first reference signal configuration without repetition and a second reference signal configuration with repetition,
the first reference signal configuration and the second reference signal configuration are in a same communication direction, and
the combined reference signal configuration indicates a time gap between the first reference signal configuration and the second reference signal configuration.

27. The method of claim 21, further comprising:
receiving at least one report setting associated with the combined reference signal configuration; and
transmitting a measurement report comprising beam measurements, each corresponding to one of a plurality of beams utilized for communication of the reference signals, wherein the measurement report comprises a format based on the at least one report setting.

28. A network entity configured for wireless communication, comprising:
a memory; and
a processor coupled to the processor, the processor configured to:
provide a combined reference signal configuration including two or more reference signal configurations, each reference signal configuration of the two or more reference signal configurations being associated with one or more beam identifiers (IDs) in a respective communication direction; and
communicate reference signals associated with the two or more reference signal configurations based on the combined reference signal configuration.

29. The network entity of claim 28, wherein each reference signal configuration of the two or more reference signal configurations indicates one of:
a first repetition pattern of a first beam ID in a first communication direction,
a second repetition pattern of a second beam ID in a second communication direction different than the first communication direction,
a first plurality of beam IDs without repetition in the first communication direction, or
a second plurality of beam IDs without repetition in the second communication direction.

30. A method for wireless communication at a network entity, comprising:
providing a combined reference signal configuration including two or more reference signal configurations, each reference signal configuration of the two or more reference signal configurations being associated with one or more beam identifiers (IDs) in a respective communication direction; and
communicating reference signals associated with the two or more reference signal configurations based on the combined reference signal configuration.
